(19) United States
(12) Patent Application Publication
(10) Pub. No.: US 2026/0278990 A1
(43) Pub. Date: Sep. 17, 2026

(54) OCCLUSION DETECTION FOR AUTONOMOUS AND SEMI-AUTONOMOUS SYSTEMS AND APPLICATIONS

(71) Applicant: NVIDIA Corporation, Santa Clara, CA (US)

(72) Inventors: Jungseock Joo, Los Altos, CA (US); Sangmin Oh, San Jose, CA (US); Yongqing Liang, San Jose, CA (US); Hyoungseok Kim, Seoul (KR); Bala Siva Sashank Jujjavarapu, Sunnyvale, CA (US); Vadim Butakov, Fremont, CA (US); Bingqing Zu, Fremont, CA (US); Yunfei Niu, Shandong (CN); Vyacheslav Samokhvalov, Forch (CH)

(21) Appl. No.: 19/342,254

(22) Filed: Sep. 26, 2025

Related U.S. Application Data
(60) Provisional application No. 63/772,266, filed on Mar. 14, 2025.

(30) Foreign Application Priority Data
Sep. 4, 2025 (CN) 2025112626122

(51) Int. Cl. G06V 10/26; G01C 21/00; G06V 10/80; G06V 10/82; G06V 20/58

(52) U.S. Cl. CPC G06V 10/26; G01C 21/3811; G01C 21/3841; G06V 10/806; G06V 10/82; G06V 20/58

(57) ABSTRACT

In various examples, occlusion detection using occupancy maps for autonomous and/or semi-autonomous systems and applications is described herein. Systems and methods are disclosed that generate a two-dimensional (2D) occupancy map—such as a 2D occupancy grid—of an environment and then use ray tracing with regard to the 2D occupancy map to identify one or more occluded areas of the environment. In some examples, the 2D occupancy map may be generated using 3D occupancy detections which are determined using the fused image data and RADAR data. Additionally, the occluded area(s) of the environment may be identified by connecting points associated with the ray tracing to generate a polygon (and/or any other shape) indicating an area of the environment that is not occluded. In some examples, the systems and methods may generate a map—such as an occlusion map—indicating the occluded area(s) of the environment.

### CROSS-REFERENCE TO RELATED APPLICATIONS

This application claims the benefit of U.S. Provisional Application No. 63/772,266, filed on Mar. 14, 2025, and Chinese Patent Application No. 2025112626122, filed Sep. 4, 2025. Each of which are hereby incorporated by reference in their entirety.

### BACKGROUND

Machines—such as autonomous vehicles, semi-autonomous vehicles, and robots—need to detect objects located within surrounding environments in order to safely navigate. As such, the machines may use perception models that are trained to determine information related to objects, such as locations of the objects, classifications of the objects, and/or additional perception information. However, most existing perception models are trained on pre-defined object classifications—such as vehicle or person—for performing object detection. As such, since there are numerous types of objects located within surrounding environments, these perception models may be unable to detect specific classifications of objects that are important for vehicle safety. Additionally, each of these perception models is trained using a single modality of sensor data—such as image data, RADAR data, or LiDAR data—where the outputs of separate perception models may then be combined to make final object detections. However, in many circumstances, it may be challenging to combine the different outputs from the separate perception models to perform accurate object detection.

In addition to detecting objects within surrounding environments, vehicles may also need to detect areas of the environments that are occluded by objects—such as static objects—where other objects that are not visible to the vehicles may be located. For instance, if a dynamic object is occluded from a field of view of a vehicle, it may still be important for the vehicle to determine that the object is potentially located within the occluded area of the environment for safely navigating. As such, some conventional techniques for detecting occluded areas of environments use image data representing the surrounding environments. However, using image data alone may provide less reliable results based on insufficient distance measurements. As such, other conventional techniques may further fuse LiDAR data with the image data to detect occluded areas of environments. However, many vehicles are unable to perform these conventional techniques based on the lack of LiDAR sensors. Additionally, even when vehicles include LiDAR sensors, processing the LiDAR data may require a large amount of computing resources and/or time to perform, which may be inadequate for many real-time applications.

### SUMMARY

Embodiments of the present disclosure relate to multi-modal fusion networks for occupancy and occlusion detection in autonomous and/or semi-autonomous systems and applications. Systems and methods are disclosed that use a multi-modal fusion network to perform object detection based at least on image data obtained using one or more image sensors along with RADAR data obtained using one or more RADAR sensors of a machine. For instance, the image data may be processed to generate one or more first features, such as one or more first Bird's Eye View (BEV) feature maps, and the RADAR data may be processed to generate one or more second features, such as one or more second BEV feature maps. The first feature(s) may then be combined (e.g., fused, etc.) with the second feature(s) to generate one or more fused features, such as one or more fused BEV feature maps. Additionally, the fused feature(s) may be processed using one or more neural networks to determine information associated with objects located within an environment. As described herein, the information may include three-dimensional (3D) occupancy detections—such as by using voxels associated with the environment—and/or classifications associated with the 3D occupancy detections.

In contrast to conventional systems, the systems and methods of the present disclosure, in some embodiments, use the multi-modal fusion network that performs object detection by performing early fusion with respect to the image data and the RADAR data. As such, the systems and methods of the present disclosure may not need to perform post-processing on outputs from different perception models, which may increase the accuracy as compared to the conventional systems. Additionally, in contrast to the conventional systems, the systems and methods of the present disclosure, in some embodiments, may train the multi-modal fusion network to determine whether 3D portions of the environment—such as voxels—are occupied or unoccupied for performing object detection. As such, the systems and methods of the present disclosure may be able to detect various classifications of objects for object detection, rather than specific classifications for which perception models are trained as with the conventional systems.

Embodiments of the present disclosure also relate to occlusion detection using occupancy maps for autonomous and/or semi-autonomous systems and applications. Systems and methods are disclosed that generate an occupancy map—such as a two-dimensional (2D) occupancy grid and/or a 3D occupancy map—of an environment and then use ray tracing with regard to the occupancy map to identify one or more occluded areas of the environment. In some examples, the occupancy map may be generated using 3D data—such as the 3D occlusion detections (e.g., the voxels) associated with the environment—which are determined using the fused image data and RADAR data. Additionally, the occluded area(s) of the environment may be identified based at least on projecting rays within the occupancy map using the ray tracing and determining whether points (e.g., areas) of the occupancy map are occluded, using one or more techniques described herein. In some examples, the systems and methods may generate a map—such as an occlusion map and/or an occlusion grid—indicating the occluded area(s) of the environment.

In contrast to conventional systems, the systems and methods of the present disclosure, in some embodiments, may use the 3D occlusion detections determined using the fused image data and RADAR data to determine the occluded area(s). As such, the systems and methods of the present disclosure may provide better results as compared to conventional systems that only use image data for occlusion detection and/or may utilize fewer computing resources and/or time as compared to the conventional systems that use LiDAR data for occlusion detection. Additionally, in contrast to the conventional systems, the systems and methods of the present disclosure, in some embodiments, use the ray tracing to accurately determine points located within the environment that are occupied by objects and then use the locations of the points to determine the occluded area(s) of the environment. As described herein, using such techniques to determine the occluded area(s) may be more accurate as compared to the conventional systems.

### BRIEF DESCRIPTION OF THE DRAWINGS

The present systems and methods for multi-modal fusion networks for occupancy and occlusion detection using occupancy maps for autonomous and/or semi-autonomous systems and applications are described in detail below with reference to the attached drawing figures, wherein:

FIGS. 1A-1B illustrate example architectures associated with multi-modal fusion networks that are configured to perform object detection, in accordance with some embodiments of the present disclosure;

FIG. 2 illustrates an example of a machine navigating within an environment while using sensors to obtain sensor data, in accordance with some embodiments of the present disclosure;

FIG. 3 illustrates an example of an output indicating occupancy information associated with an environment at least partially surrounding a machine, in accordance with some embodiments of the present disclosure;

FIG. 4 illustrates an example data flow diagram for a process of training a multi-modal fusion network to process image data and RADAR data when performing object detection, in accordance with some embodiments of the present disclosure;

FIG. 5 illustrates an example of converting a navigational surface to include a planar surface when generating ground truth data, in accordance with some embodiments of the present disclosure;

FIG. 6 illustrates an example data flow diagram for a process of performing occlusion detection using occupancy data, in accordance with some embodiments of the present disclosure;

FIG. 7 illustrates an example of generating a 2D occupancy map indicating occupancy information associated with an environment, in accordance with some embodiments of the present disclosure;

FIG. 8A illustrates an example of using ray tracing to identify points within a 2D occupancy map that are associated with closest occupancies with respect to a machine, in accordance with some embodiments of the present disclosure;

FIG. 8B-8C illustrate examples of using ray tracing to determine whether points within a 2D occupancy map are occupied, in accordance with some embodiments of the present disclosure;

FIG. 8D illustrates an example of using ray tracing to determine whether points within a 3D occupancy map are occluded, in accordance with some embodiments of the present disclosure;

FIGS. 9A-9B illustrate example outputs that represent one or more occluded areas of an environment, in accordance with some embodiments of the present disclosure;

FIG. 10 illustrates a flow diagram showing a method for a multi-modal fusion network processing image data and RADAR data to determine occupancy information associated with an environment, in accordance with some embodiments of the present disclosure;

FIG. 11 illustrates a flow diagram showing a method for fusing image data with RADAR data to perform object detection, in accordance with some embodiments of the present disclosure;

FIG. 12 illustrates a flow diagram showing a method for performing occlusion detection using an occupancy map associated with an environment, in accordance with some embodiments of the present disclosure;

FIG. 13 illustrates a flow diagram showing a method for using ray tracing to perform occlusion detection with respect to an environment, in accordance with some embodiments of the present disclosure;

FIG. 14 illustrates a flow diagram showing a method 1400 for using ray tracing on an occlusion map to perform occlusion detection, in accordance with some embodiments of the present disclosure;

FIG. 15A is an example of sensor locations having corresponding fields of view or sensory fields for example autonomous or semi-autonomous machines, in accordance with at least some embodiments of the present disclosure;

FIG. 15B is an illustration of an example of component and sensor locations on an autonomous or semi-autonomous vehicle, in accordance with at least some embodiments of the present disclosure;

FIG. 15C is a block diagram of an example system architecture for an autonomous or semi-autonomous vehicle, robot, and/or other machine type, in accordance with at least some embodiments of the present disclosure;

FIG. 15D is a block diagram of an example architecture of a computing system—such as a system-on-a-chip (SoC)—in accordance with at least some embodiments of the present disclosure;

FIG. 15E is a system diagram for communication between cloud-based server(s) and an example autonomous or semi-autonomous vehicle, robot, and/or other machine type, in accordance with at least some embodiments of the present disclosure;

FIG. 16 is a system diagram illustrating a three computer ecosystem, including a computing system for generating or creating artificial intelligence (AI)—such as AI training and validation data, a computing system for training artificial intelligence, and a computing system deploying the AI at the edge, in accordance with at least some embodiments of the present disclosure;

FIG. 17 is a block diagram of an example computing system for generative artificial intelligence (AI), in accordance with at least some embodiments of the present disclosure; and

FIG. 18 is a block diagram of an example computing device, in accordance with at least some embodiments of the present disclosure.

### DETAILED DESCRIPTION

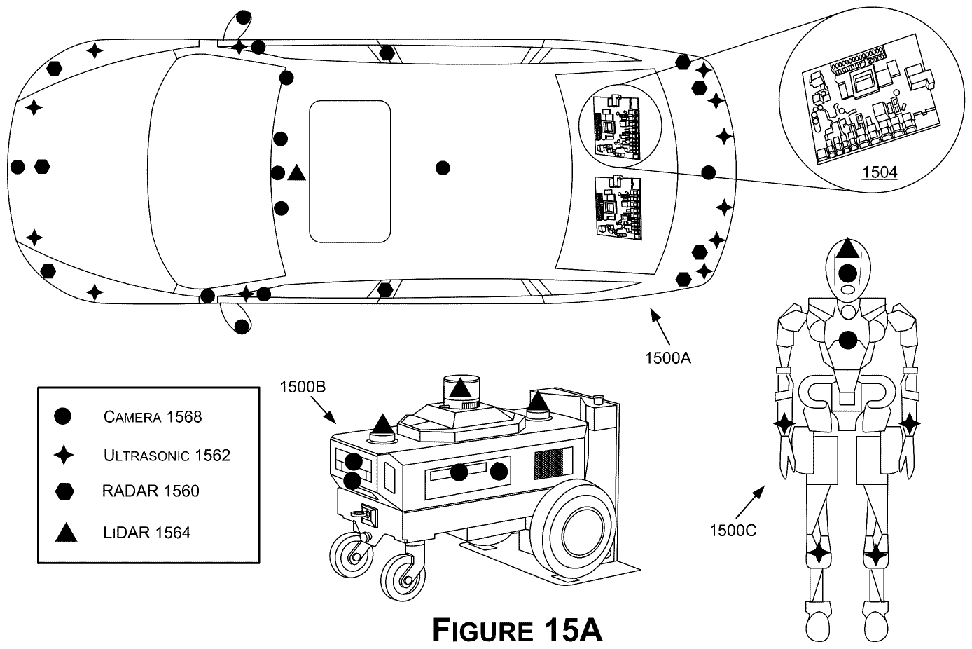

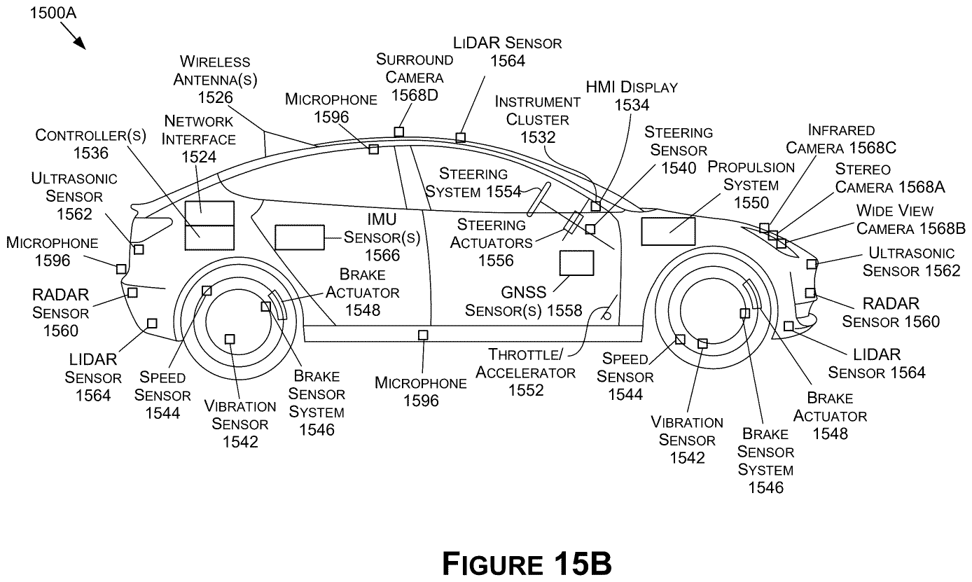

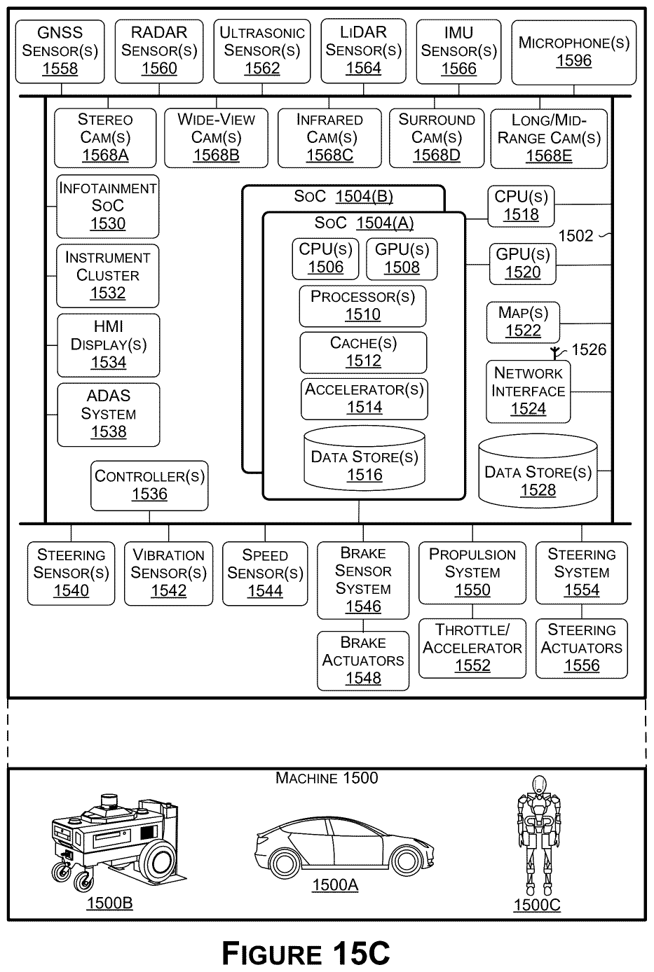

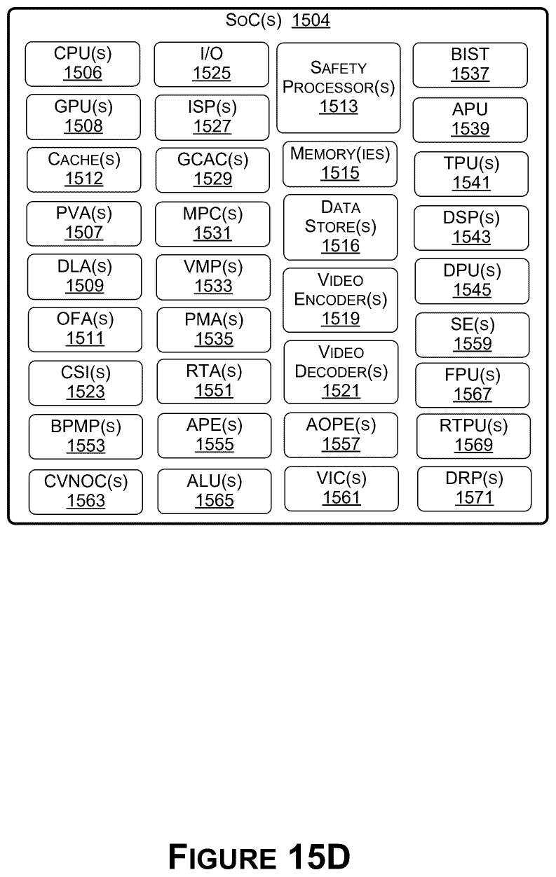

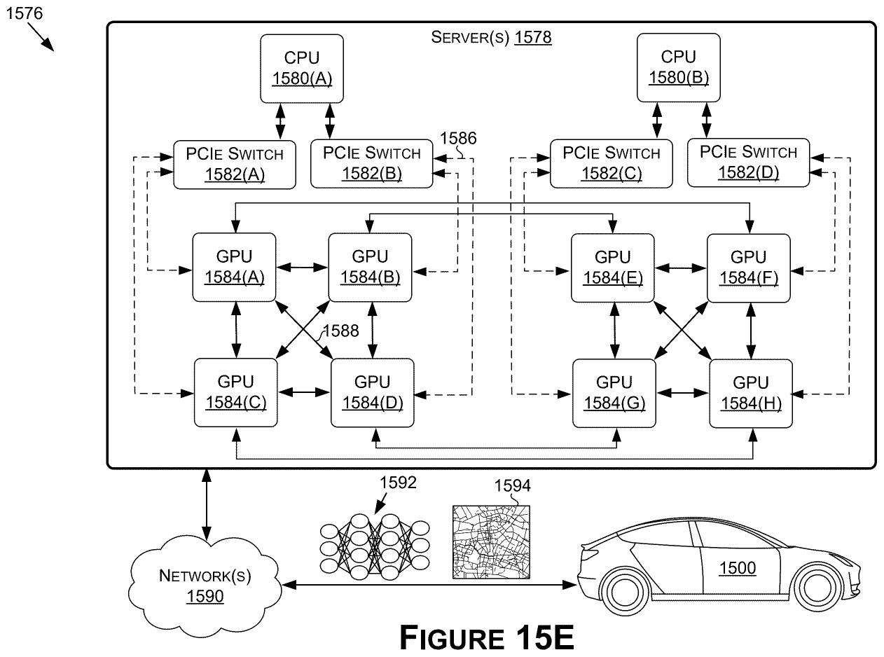

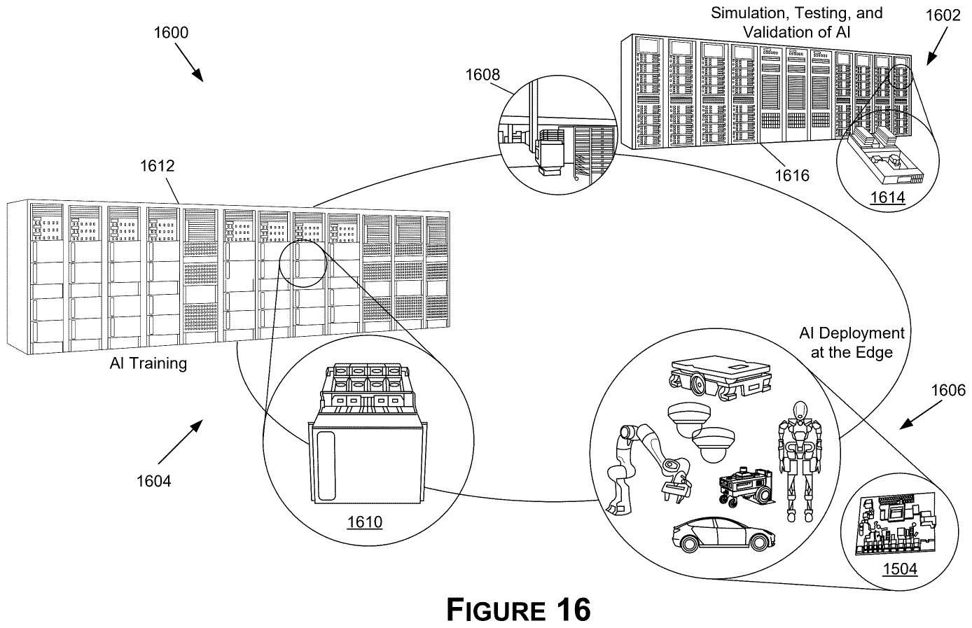

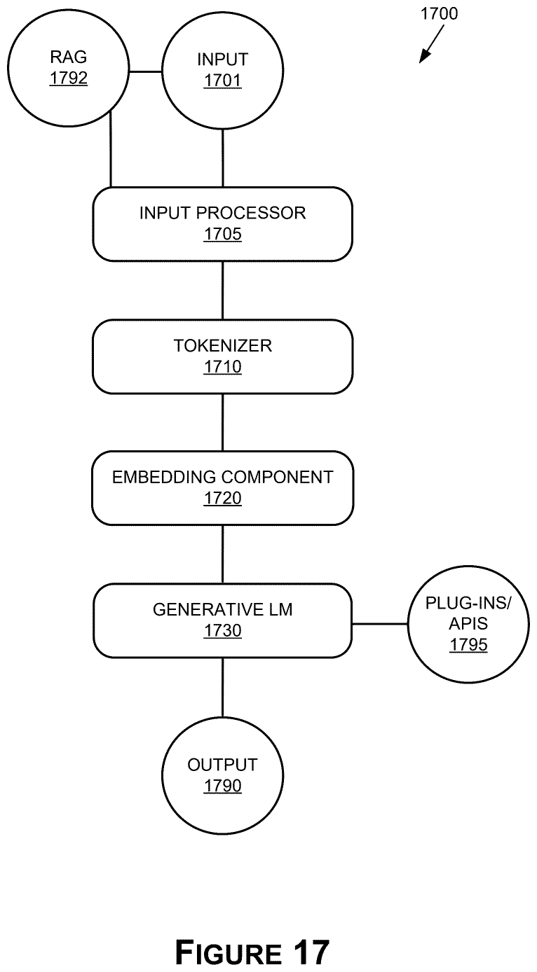

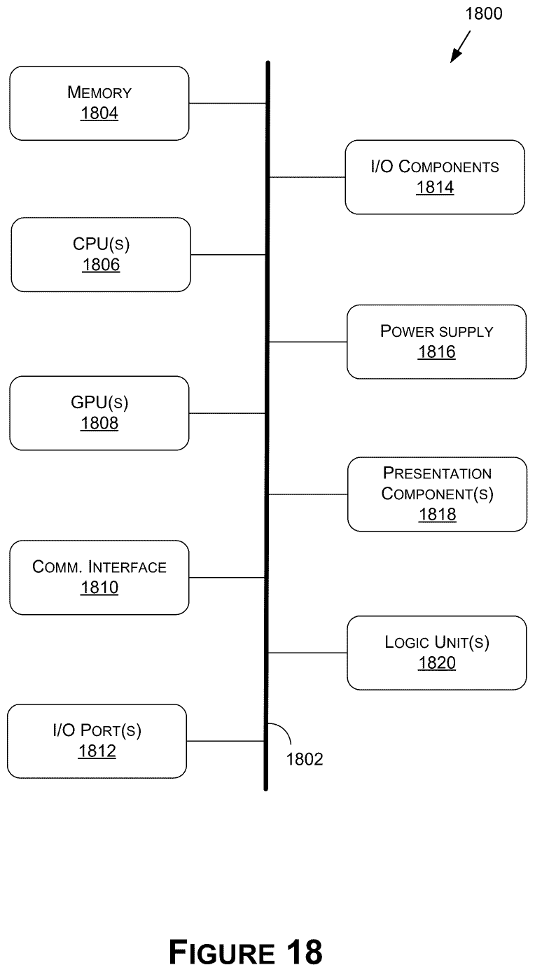

Systems and methods are disclosed related to multi-modal fusion networks for occupancy and occlusion detection using occupancy maps for autonomous and/or semi-autonomous systems and applications. Although the present disclosure may be described with respect to an example autonomous or semi-autonomous vehicle, robot, and/or other machine type 1500 (alternatively referred to herein as “vehicle 1500,” “ego-vehicle 1500,” “machine 1500,” “ego-machine 1500,” “robot 1500,” and/or “ego-robot 1500,” an example of which is described with respect to FIGS. 15A-15E), this is not intended to be limiting. For example, the systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms (e.g., autonomous mobile robots (AMRs), humanoid robots, robotic arms and/or end-effectors), warehouse vehicles, off-road vehicles, vehicles coupled to one or more trailers, flying vessels, watercraft, shuttles (e.g., robotaxis), emergency response vehicles, motorcycles, electric or motorized bicycles, aircraft, construction vehicles, underwater craft (e.g., piloted or unpiloted submarines), drones, and/or other vehicle, robot, or machine types. In addition, although the present disclosure may be described with respect to machine perception for object detection, this is not intended to be limiting, and the systems and methods described herein may be used in augmented reality (AR), virtual reality (VR), mixed reality (MR), robotics, security and surveillance (e.g., smart cities), autonomous or semi-autonomous machine applications, industrial manufacturing, simulation, and/or any other technology spaces where machine perception for object detection may be used. In some embodiments, the systems, methods, and/or processes described herein may be executed using similar components, features, and/or functionality to those of example machine 1500 of FIGS. 15A-15E, example computing ecosystem 1600 of FIG. 16, example generative language model system 1700 of FIG. 17, and/or example computing device 1800 of FIG. 18.

For instance, a system(s) may receive sensor data obtained using one or more sensors of a machine. As described herein, the sensor data may include, but is not limited to, image data obtained using one or more image sensors, RADAR data obtained using one or more RADAR sensors, LiDAR data obtained using one or more LiDAR sensors, ultrasonic data obtained using one or more ultrasonic sensors, and/or any other type of sensor data. The system(s) may then process at least a portion of the sensor data—such as the image data and the RADAR data—using a multi-modal fusion network that is configured to perform one or more tasks associated with object detection. For instance, the output data may represent occupancy information for a 3D space associated with the environment, classification information associated with the 3D space, and/or any other type of object detection information. As described herein, in some examples, the occupancy information may indicate whether voxels (and/or other types of 3D representations) located within the environment are occupied while the classification information may indicate sematic classification labels associated with objects that occupy the voxels.

For more details, the multi-modal fusion network may include at least one or more encoders that are configured to process the image data to generate one or more image features. As described herein, the image feature(s) may include one or more BEV feature maps associated with the environment at least partially surrounding the machine. For example, the encoder(s) may include at least one or more image encoders that process the image data to generate 2D features associated with one or more images represented by the image data and a BEV encoder (e.g., a BEV transformer) that projects the 2D feature(s) to a BEV space in order to generate the BEV feature map(s). Additionally, the multi-modal fusion network may include one or more RADAR encoders that process the RADAR data to generate one or more RADAR features. As described herein, the RADAR feature(s) may include one or more BEV feature maps associated with the environment at least partially surrounding the machine. In some examples, the multi-modal fusion network may then perform one or more processes to align the RADAR feature(s) with respect to the image feature(s) and/or align the image feature(s) with respect to the RADAR feature(s). For example, the multi-modal fusion network may process the RADAR feature(s) in order to cause the RADAR feature(s) to include the same resolution and/or channel alignment as the image feature(s).

The multi-modal fusion network may then fuse, combine, add, and/or concatenate the image feature(s) with the RADAR feature(s) (e.g., after the alignment) to generate one or more combined features. Additionally, the multi-modal fusion network may process the combined feature(s) using one or more layers—such as layers associated with a BEV trunk, a Feature Pyramid Network (FPN), and/or the like—to generate one or more fused BEV features. As described herein, in some examples, the fused BEV feature(s) may include one or more BEV feature maps associated with the environment at least partially surrounding the machine. For example, the fused BEV feature(s) may include multiple BEV feature map layers that are associated with different resolutions and/or different semantic values.

The multi-modal fusion network may then process the fused BEV feature(s) using one or more output layers that are configured to generate the output data representing the information associated with object detection. As described herein, the output layer(s) may be associated with one or more heads of the multi-modal fusion network. For example, the output layer(s) may be associated with at least an occupancy head that is configured to determine the occupancy information associated with the object detection and a classification head that is configured to determine the classification information associated with the object detection. In some examples, one or more of the output layers may be configured to perform 2D convolution with height unfolding to generate output data.

For instance, and as described herein, the occupancy information may indicate whether voxels associated with the environment are occupied, unoccupied, and/or in any other state (e.g., occluded). Additionally, the voxels may be associated with a given area of environment. For example, the voxels may be associated with a first distance (e.g., 80 meters) associated with a forward direction from the machine, a second distance (e.g., 28 meters) associated with side directions from the machine, and/or a third distance (e.g., 28 meters) associated with a backward direction from the machine. Additionally, the voxels may be associated with a given distance off the surface of the environment, such as 2 meters (and/or any other distance). Furthermore, individual voxels may be associated with a given area of the environment, such as by including cube shapes (and/or any other 3D shapes) with given distances for sides (e.g., 20 centimeters, etc.). As such, the output layer(s) may be configured to perform the height unfolding to determine the occupancy information and/or the classification information for the various layers of the voxels positioned above the surface of the environment.

As described herein, the multi-modal fusion network may be trained to perform one of the processes described herein. For instance, the system(s) (and/or one or more other systems) may generate ground truth data for training the multi-modal fusion network. In some examples, the system(s) may generate the ground truth data using a specific type of sensor data, such as LiDAR data representing the environment. For example, the system(s) may process the LiDAR data to determine occupancy information for one or more 3D spaces associated with one or more environments and/or classification information associated with the 3D space(s). Additionally, the system(s) may obtain training input data associated with the ground truth data. For example, the training input data may include at least image data and RADAR data representing the same environment(s) as the LiDAR data. Using the training input data and the ground truth data, the system(s) may then train the multi-modal fusion network.

For example, the multi-modal fusion network may process instances of the training input data, using one or more of the processes described herein, to generate output data representing predicted occupancy information and/or predicted classification information associated with an environment. The system(s) may then analyze the output data with respect to the ground truth data to determine one or more losses. For example, the system(s) may determine the loss(es) based at least on differences between the predicted occupancy information and the ground truth occupancy information and/or differences between the predicted classification information and the ground truth classification information. The system(s) may then update one or more parameters, weights, and/or biases of the multi-modal fusion network based at least on the loss(es).

In some examples, the system(s) may perform one or more tasks using the output data from the multi-modal fusion network, such as occlusion detection with regard to an environment. For instance, the system(s) may use the occupancy information associated with the 3D space to generate an occupancy map associated with the environment. In some examples, the occupancy map may include a 2D occupancy grid indicating whether 2D areas of the environment are occupied, unoccupied, and/or in any other state. For example, to determine whether a 2D area of the environment is occupied, the system(s) may identify voxels from the occupancy information that are associated with the 2D area, such as the voxels that are associated with the same surface area (e.g., voxels that are stacked vertically above the surface of the environment). In some examples, the system(s) may then determine that the 2D area is occupied when at least one of the voxels is indicated as being occupied or determine that the 2D area is unoccupied when all of the voxels are indicated as being unoccupied. However, in some examples, the system(s) may use a threshold distance to determine whether the 2D area is occupied. For example, the system(s) may determine that the 2D area is occupied when at least one of the voxels that is at least the threshold distance above the surface is indicated as being occupied or determine that the 2D area is unoccupied when all of the voxels that are at least the threshold distance above the surface are indicated as being unoccupied. The system(s) may then perform similar processes for one or more (e.g., each) of the 2D areas.

Additionally, or alternatively, in some examples, the occupancy map may include a 3D occupancy map indicating whether 3D areas of the environment—such as voxels located within the environment—are occupied, unoccupied, and/or in any other state. For example, the system(s) may use the occupancy information indicating whether the voxels located within the environment are occupied to generate the 3D occupancy map.

The system(s) may then use one or more light transport simulation algorithms or techniques—such as one or more ray tracing or path tracing techniques—to project rays starting at a location associated with the machine as represented by the occupancy map and outward in multiple directions. In some examples, the ray tracing may use a specific horizontal angle for projecting the rays, such as 0.5 degrees (and/or any other angle), and/or a specific vertical angle for projecting the rays, such as 0.5 degrees (and/or any other angle). For example, the angle(s) may be set such that the rays are able to travel through all of the 2D areas of the 2D occupancy grid and/or all of the 3D areas of the 3D occupancy map based on the implementation that is described herein. The system(s) may then use one or more techniques to analyze the rays in order to determine whether occlusion information associated with the information.

For instance, in some examples, the system(s) may follow the rays to determine points within the occupancy map for which the rays initially contact occupied areas of the occupancy map. In other words, the system(s) may identify locations within the environment for which the rays would initially contact objects located within the environment. Additionally, the system(s) may generate a polygon (and/or any other shape) by connecting at least a portion of the points and use the polygon to identify the occluded area(s) of the environment. For example, the system(s) may generate an occlusion map that includes at least the polygon. The system(s) may then determine that a region of the occlusion map that is within the polygon may represent a visible area of the environment that is not occluded. This is because that area of the environment may be visible to sensors of the machine. Additionally, the system(s) may determine that one or more regions of the occlusion map that are outside of the polygon may represent the occluded area(s) of the environment. This is because the occluded area(s) of the environment may be blocked from the sensors by one or more objects, such as one or more static objects and/or one or more dynamic objects. In some examples, the occlusion map may be separate from the occupancy map. However, in other examples, the system(s) may use the occupancy map to generate the occlusion map, such as by adding the polygon to the occupancy map.

Additionally, or alternatively, in some examples, the system(s) may determine a point that is associated with an area of the occupancy map for testing, where the point may be referred to as a “test point” and the area may be referred to as a “test area.” The system(s) may then project a test ray from the location associated with the machine to test point to determine a test segment that includes the first length of the test ray. Additionally, the system(s) may use the test ray to identify one or more other rays that are projected from the location associated with the machine and end at one or more points for which the ray(s) initially contact one or more objects located within the environment. For example, the system(s) may identify the other ray(s) as including one or more azimuths that are within a threshold angle to the azimuth associated with the test ray. The system(s) may then use the other ray(s) to determine one or more occupancy segments that include one or more second lengths associated with the other ray(s). Additionally, the system(s) may use the first length of the test segment and the second length(s) of the occupancy segment(s) to determine whether the test area of the occupancy map is occluded.

For a first example, such as when only a single other ray is identified, the system(s) may determine that the test area is occluded based at least on the first length of the test segment being equal to or greater than the second length of the occupancy segment or determine that the test area is not occluded based at least on the first length of the test segment being less than the second length of the occupancy segment. For a second example, such as when multiple other rays are identified, the system(s) may determine that the test area is occluded based at least on the first length of the test segment being equal to or greater than a majority of the second lengths of the occupancy segments or determine that the test area is not occluded based at least on the first length of the test segment being less than a majority of the second lengths of the occupancy segments. In some examples, the system(s) may then perform these processes for one or more other areas of the occupancy map. Additionally, the system(s) may generate the occlusion map that indicates one or more areas of the environment that are occluded and/or one or more areas of the environment that are not occluded.

As described herein, in some examples, the system(s) may cause the machine to perform one or more planning, control, and/or navigation operations based at least the output data from the multi-modal fusion network and/or the occupancy map. For a first example, the system(s) may use the output data to determine information associated with one or more objects located within the environment, such as one or more locations of the object(s), one or more classifications of the object(s), and/or any other information. The system(s) may then use the object information to cause the machine to navigate such that the machine at least avoids collision with the object(s). For a second example, the system(s) may use the occlusion map to identify the occluded area(s) of the environment. The system(s) may then cause the machine to perform one or more operations when approaching an occluded area. For example, the system(s) may cause the machine to reduce the velocity and/or stop when approaching an occluded area, such as by assuming that one or more objects are located with the occluded area. Additionally, the system(s) may cause the machine to navigate accordingly after processing additional sensor data that represents the occluded area to determine whether one or more dynamic objects are actually located within the occluded area.

In some embodiments, the systems and methods described herein may be performed within a simulation environment (e.g., NVIDIA's DriveSIM, ISAAC Sim, ISAAC Gym, ISAAC Lab, etc.) using simulated data (e.g., simulated environmental data and simulated sensor data of simulated sensors of a virtual or simulated vehicle, robot, or machine within the simulated environment). For example, simulated input data (e.g., map data, perception data, ego-motion data, tactile data, and/or any other data described herein) may be used to perform object detection, occlusion detection, obstruction detection, etc., and this information may be used to perform operations associated with the virtual machine within the simulation environment. These simulated operations may be used to test performance of the underlying algorithms, systems, and/or processes prior to deploying them in the real-world. In some instances, the simulation may be used to generate synthetic training data—e.g., sensor data and/or ground truth representations of environments from within the simulation. The synthetic training data (in addition to or alternatively from real-world data) may then be used or processed to analyze a performance of and/or train the model(s).

In any example, such as where a simulation environment is used for testing, validation, training, etc., the simulation environment and/or associated training data may be rendered or otherwise generated using one or more light transport simulation algorithms-such as one or more ray-tracing and/or path-tracing algorithms. Where light transport simulation is used, the simulation system may employ one or more dedicated ray-tracing hardware accelerators and/or processors (e.g., NVIDIA's RTX, or another real-time ray-tracing GPU, such as those that include one or more ray tracing (RT) cores) optimized for performing real-time or near real-time light transport simulation operations in conjunction with one or more other processors of the system (e.g., GPUs, CPUs, accelerators, etc.). In some embodiments, the simulation environment and/or one or more objects, features, or components thereof may be generated or managed within a three-dimensional (3D) content collaboration platform (e.g., NVIDIA's OMNIVERSE) that may be optimized or suitable for industrial digitalization, generative physical artificial intelligence, and/or other use cases, applications, and/or services. For example, the content collaboration platform or system may include a system for using or developing universal scene descriptor (USD) (e.g., OpenUSD) data for managing objects, features, scenes, etc. within a simulated environment, digital environment, etc. The platform may include real physics simulation (e.g., using NVIDIA's PhysX software developer kit (SDK)), in order to simulate real physics and physical interactions with simulations hosted by the platform. The platform may integrate OpenUSD along with ray tracing/path tracing/light transport simulation (e.g., NVIDIA's RTX rendering technologies) into software tools and simulation workflows for building, training, deploying, and/or testing AI systems-such as systems for testing, validating, training (e.g., machine learning models, neural networks, etc.), and/or other tasks related to automobiles, robots, other machine types, and/or other systems and applications. In some examples, the simulation environment may include a digital twin of a real environment, such as a digital twin of a specific stretch of roadway, a warehouse, a data center, an airport, a geographic area, a marine area, and/or any other real environment where autonomous or semi-autonomous vehicles or machines may operate.

In some embodiments, teleoperation or remote control of a vehicle, robot, and/or other machine may be performed using a remote control or teleoperation system. For example, the systems and methods described herein may be used to determine information associated with object detection, occlusion detection, and/or obstruction detection that may be included in a visualization or mapping of an environment to aid a remote operator in controlling—or providing waypoints or other indications of control or navigation—an autonomous or semi-autonomous machine through an environment. As such, the remote operator may use the visual, audible, textual, and/or other clues or indicators generated using the systems and methods described herein to aid in navigating the vehicle, robot, machine, etc. through a real-world environment using the teleoperation system.

In some embodiments, the system and methods described herein may be deployed in a robotics application. For example, a robot or robotic system may include one or more onboard processors (e.g., CPUs, GPUs, hardware-based deep learning accelerators (DLAs), deep learning accelerator clusters (XNNs), neural processing units (NPUs), neural network accelerators (NNAs), hardware-based programmable vision accelerators (PVAs)—which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models). The robotic system may use these processors to execute one or more machine learning models (e.g., language models, vision language models (VLMs), large language models (LLMs), vision-language-action (VLA) models, multi-modal language models (MMLMs), etc.) that allow it to perform complex tasks autonomously or semi-autonomously, such as interacting with and/or manipulating static and/or dynamic objects, or navigating environments using sensors such as cameras, LiDAR, RADAR, ultrasonic sensors, and more. The system may use sensor fusion techniques to combine data from multiple sensors (e.g., cameras, infrared, LiDAR, RADAR, accelerometers) to create a comprehensive model of the robot's surroundings. This data may be processed locally on the robot or sent to remote servers for more computationally intensive tasks, such as 3D mapping or SLAM (Simultaneous Localization and Mapping). In one or more embodiments, data from individual robots (e.g., sensor data, task status, or environmental conditions) may be uploaded to the cloud, where centralized AI models can analyze and distribute optimized commands to an entire fleet. In some embodiments, the machine learning model(s) (e.g., language models, VLMs, VLAs, LLMs, MMLMs, diffusion models, NeRF models, DNNs, etc.) described herein may be used to allow the robot to perceive and reason about the environment and/or communicate with one or more other robots and/or persons in an environment. In some embodiments, the robot may communicate (e.g., using one or more network interface cards (NICs) and/or data processing units (DPUs)) with one or more locally hosted servers/computing devices and/or with one or more remotely located servers/computing devices (e.g., in one or more data centers).

In some embodiments, the system and methods described herein may be deployed in an in-vehicle infotainment (IVI) system or in-cabin experience (IX) application. For example, the infotainment system within a vehicle (e.g., cars, trucks, drones, construction equipment, robots, semi-autonomous vehicles, or autonomous vehicles) may include one or more onboard processors (e.g., CPUs, GPUs, hardware-based deep learning accelerators (DLAs), deep learning accelerator cluster (XNNs), neural processing units (NPUs), neural network accelerators (NNAs), hardware-based programmable vision accelerators (PVAs)—which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models), and memory and/or storage (e.g., for storing entertainment content, navigation data, and user preferences). The system may use these processors to execute one or more machine learning models (e.g., language models) to enable features such as voice control, personalized media recommendations, dynamic navigation, and real-time communication with other services through network connectivity. The in-vehicle infotainment system may also use natural language processing (NLP) models to enable voice-based interaction. The one or more machine learning models may be stored locally or accessed through one or more APIs that connect to cloud services, enabling the system to process requests in real time or near real-time.

In some examples, the machine learning model(s) (e.g., deep neural networks, language models, LLMs, VLMs, multi-modal language models, vision-language-action (VLA) models, perception models, tracking models, fusion models, transformer models, diffusion models, encoder-only models, decoder-only models, encoder-decoder models, neural rendering field (NERF) models, etc.) described herein may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or a model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs—such as REST APIs. As such, and in some embodiments, the machine learning model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring). The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

Although examples may be described herein with respect to using machine learning models, such as neural networks, this is not intended to be limiting. For example, and without limitation, any of the various machine learning models and/or neural networks described herein may include any type of machine learning model, such as a machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoder neural networks, artificial neural networks (ANNs), convolutional neural networks (CNNs), recurrent neural networks (RNNs), perceptrons, Long/Short Term Memory (LSTM) networks, multi-layer perceptron (MLP) networks, deep stacking networks (DSNs), generative pre-training (GPT) models or networks, feed forward networks, radial basis function ANNs, self-organizing maps (SOMs), Kohonen maps, Hopfield networks, Boltzmann machine, deep belief neural networks, deconvolutional neural networks, generative adversarial networks (GANs), liquid state machines, modular neural networks, liquid state machines, sequence-to-sequence models, networks using transformer architectures, state space models (SSMs) (e.g., networks using Mamba architectures (e.g., Mamba-1, Mamba 2, etc.), networks using selective state space models, networks using structured state space sequence models, etc.), diffusion models (e.g., diffusion probabilistic models, score-based generative models, etc.), neural radiance field (NeRF) models, Gaussian splat models, Kolmogorov-Arnold networks (KANs), models with encoder-only architectures, models with decoder-only architectures, models with encoder-decoder architectures, generative machine learning models, language models, large language models (LLMs), vision language models (VLMs), multi-modal language models (MMLMs), large action models (LAMs), vision-language-action (VLA) models, etc.), and/or other types of machine learning models.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, watercraft, shuttles (e.g., robotaxis), emergency response vehicles, motorcycles, electric or motorized bicycles, aircraft, construction vehicles, underwater craft (e.g., piloted or unpiloted submarines), drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets (e.g., NVIDIA's Omniverse), cloud computing, and/or any other suitable applications.

Disclosed embodiments may be comprised in a variety of different systems such as automotive systems (e.g., a control system for an autonomous or semi-autonomous machine, a perception system for an autonomous or semi-autonomous machine, etc.), systems implemented using a robot, aerial systems, medial systems, boating systems, smart area monitoring systems, systems for performing deep learning operations, systems for performing simulation operations, systems for performing digital twin operations, systems implemented using an edge device, systems implementing language models—such as large language models (LLMs), vision language models (VLMs), vision-language-action (VLA) models, and/or multi-modal language models, systems using or deploying one or more inference microservices, systems that incorporate deploy one or more machine learning models in a service or microservice along with an OS-level virtualization package (e.g., a container), systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for performing generative AI operations, systems implemented at least partially using cloud computing resources, and/or other types of systems.

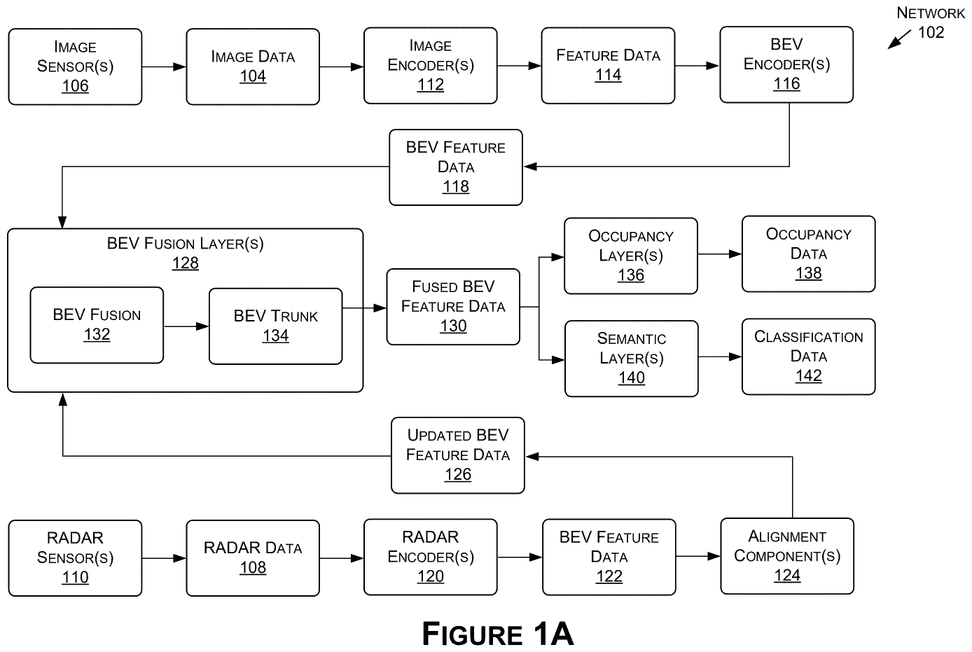

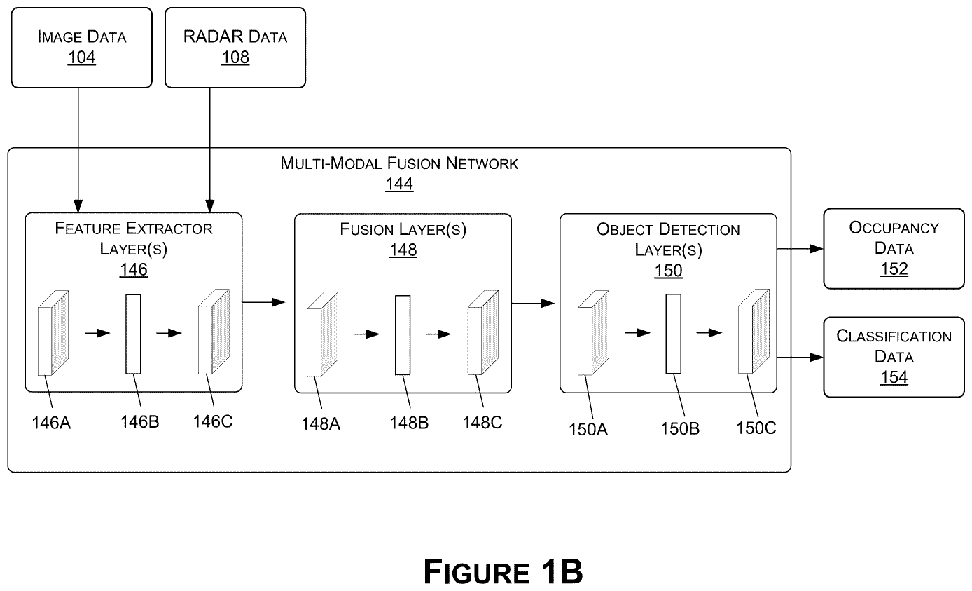

With reference to FIG. 1A, FIG. 1A illustrates a first example architecture associated with a multi-modal fusion network 102 that is configured to perform object detection, in accordance with some embodiments of the present disclosure. It should be understood that this and other arrangements described herein are set forth only as examples. Other arrangements, components, features, and elements (e.g., machines, interfaces, functions, orders, groupings of functions, etc.) may be used in addition to or instead of those shown, and some elements may be omitted altogether. Further, many of the arrangements, components, features, elements, etc. described herein are functional entities that may be implemented as discrete or distributed components or in conjunction with other components, and in any suitable combination and location (e.g., on a local device, vehicle, or machine at the edge, on-premises—such as locally hosted servers, remotely located—such as in one or more computing or server devices in one or more data centers in the cloud, and/or at other locations). Various functions described herein as being performed by entities may be carried out by hardware, firmware, and/or software. For instance, various functions may be carried out using one or more processors (e.g., central processing units (CPU(s)), graphics processing units (GPU(s)), microprocessors, microcontrollers, embedded processors, digital signal processors (DSPs), image signal processors (ISPs), physics processing units (PPUs), field-programmable gate arrays (FPGAs), accelerator(s) (e.g., deep learning accelerators (DLAs), deep learning accelerator cluster (XNNs), neural network accelerators (NNAs), and/or neural processing units (NPUs), programmable vision accelerators (PVAs), optical flow accelerators (OFAs), etc.), application specific integrated circuits (ASICs), data processing units (DPUs), quantum processors, etc.) executing instructions stored in memory. In some embodiments, the systems, methods, and processes described herein may be executed using similar components, features, and/or functionality to those of example machine 1500 of FIGS. 15A-15E, example computing ecosystem 1600 of FIG. 16, example generative language model system 1700 of FIG. 17, and/or example computing device 1800 of FIG. 18.

For instance, the multi-modal fusion network 102 may receive image data 104 obtained using one or more image sensors 106 of a machine (e.g., a machine 1400) navigating within an environment and RADAR data 108 obtained using one or more RADAR sensors 110 of the machine. As described herein, in some examples, the image sensor(s) 106 may obtain the image data 104 at a similar framerate as the RADAR sensor(s) 110 obtains the RADAR data 108 while, in other examples, the image sensor(s) 106 may obtain the image data 104 at a different framerate as the RADAR sensor(s) 110 obtains the RADAR data 108. Additionally, in some examples, multiple image sensors 108 may be located at various locations on the machine and/or may include various orientations with respect to one another such that the image data 104 represents the environment at least partially surrounding the machine. Furthermore, the image data 104 and/or the RADAR data 108 may represent objects at least partially surrounding the machine, such as static objects (e.g., traffic lights, traffic signs, road markings, lane markings, curbs, structures, etc.) and/or dynamic objects (e.g., vehicles, pedestrians, animals, etc.).

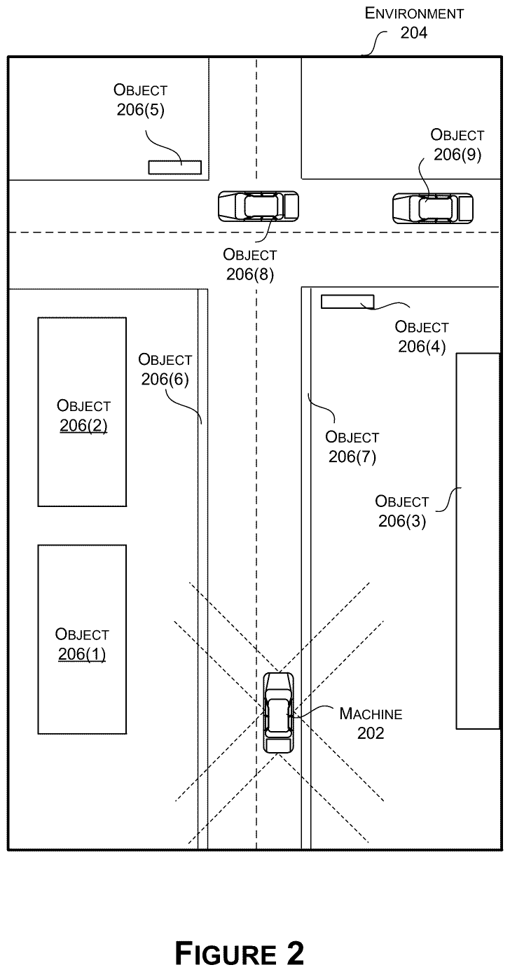

For instance, FIG. 2 illustrates an example of a machine 202 navigating within an environment 204 while using sensors to obtain sensor data, in accordance with some embodiments of the present disclosure. In the example of FIG. 2, the machine 202 may use one or more image sensors to obtain image data representing the environment 204 at least partially surrounding the machine 202 and/or one or more RADAR sensors to obtain RADAR data representing the environment 204 at least partially surrounding the machine 202, which may be illustrated by the dashed lines protruding from the machine 202. Additionally, the sensor data may represent objects 206(1)-(9) (also referred to singularly as “object 206” or in plural as “objects 206”) located within the environment 204 and at least partially surrounding the machine 202. As shown, the objects 206(1)-(7) may include static objects, such as by the objects 206(1)-(3) including structures, the objects 206(4)-(5) including traffic signs, and the objects 206(6)-(7) including curbs, while the objects 206(8)-(9) include dynamic objects, such as vehicles.

Referring back to the example of FIG. 1A, the multi-modal fusion network 102 may include one or more image encoders 112 that are configured to process the image data 104 and generate feature data 114 representing one or more image features associated with one or more images that are represented by the image data 104. As described herein, in some examples, the image feature(s) may include one or more 2D features associated with the image(s), such as instances of 2D features extracted from the image(s). For example, the image feature(s) may include one or more feature maps associated with the image(s) represented by the image data 104. Additionally, as described herein, an image encoder 112 may include any type of encoder, such as a shared ResNET-50 encoder, a Convolutional Autoencoder, a Variational Autoencoder, a Denoising Autoencoder, a Sparse Autoencoder, and/or any other type of encoder that is configured to perform one or more of the processes described herein.

The multi-modal fusion network 102 may then include one or more BEV encoders 116 that are configured to process the feature data 114 and generate BEV feature data 118 representing one or more BEV image features associated with the image data 104. For example, the BEV image feature(s) may include one or more BEV feature maps representing the environment at least partially surrounding the environment as represented by the image data 104. Additionally, the BEV encoder(s) 116 may use any technique to generate the BEV image feature(s), such as by projecting the 2D feature(s) associated with the image(s) to a BEV space. As described herein, a BEV encoder 116 may include any type of encoder that is configured to perform one or more of the processes described herein, such as a BEV transformer.

As further shown by the example of FIG. 1A, the multi-modal fusion network 102 may include one or more RADAR encoders 120 that are configured to process the RADAR data 108 and generate BEV feature data 122 representing one or more BEV RADAR features associated with the RADAR data 108. For example, the BEV RADAR feature(s) may include one or more BEV feature maps representing the environment at least partially surrounding the machine as represented by the RADAR data 108. The multi-modal fusion network 102 may then include one or more alignment components 124 that are configured to process the BEV RADAR feature(s) represented by the BEV feature data 122 in order to align the BEV RADAR feature(s) with the respect to the BEV image feature(s) represented by the BEV feature data 118. For example, the alignment component(s) 124 may convert the BEV RADAR feature(s) to include a same resolution and/or a same channel alignment as the BEV image feature(s), where the updated BEV RADAR feature(s) may be represented by updated BEV feature data 126.

The multi-modal fusion network 102 may then include one or more BEV fusion layers 128 that are configured to fuse the BEV image feature(s) with the BEV RADAR feature(s) in order to generate one or more fused BEV features, which are represented by fused BEV feature data 130. For instance, in some examples, the BEV fusion layer(s) 128 may initially perform BEV fusion 132 to fuse the BEV image feature(s) with the BEV RADAR feature(s). The BEV fusion layer(s) 128 may then include a BEV trunk 134 that is configured to process the BEV image feature(s) fused with the BEV RADAR feature(s) and output the fused BEV feature(s). As described herein, in some examples, the BEV trunk 134 may include a FPN that is configured to generate one or more fused BEV feature maps (e.g., the fused BEV feature(s)), where an individual fused BEV feature map is associated with a respective resolution and/or semantic value. For example, the FPN may generate multiple fused BEV feature map layers, where the BEV feature map layers decrease in resolution going up through the layers while also increasing in semantic value.

The multi-modal fusion network 102 may then include one or more output layers, such as one or more heads, that are configured to process the fused BEV feature data 130 and generate one or more outputs. For instance, and as shown, the multi-modal fusion network 102 may include at least one or more occupancy layers 136 that are configured to process the fused BEV feature data 130 and generate occupancy data 138 representing occupancy information associated with the environment at least partially surrounding the machine. As described herein, in some examples, the occupancy information may indicate whether voxels associated with a 3D space located within the environment are occupied, unoccupied, and/or in any other state (e.g., obstructed). Additionally, the 3D space may include a first distance (e.g., 80 meters) associated with a forward direction from the machine, a second distance associated with side directions from the machine, and/or a third distance associated with a backward direction from the machine. Furthermore, the voxels may be associated with a given distance off the surface of the environment, such as 2 meters (and/or any other distance). Moreover, individual voxels may be associated with a given area of the environment, such as by including cube shapes (and/or any other 3D shapes) with given dimensions for the sides (e.g., 20 centimeters, etc.).

The multi-modal fusion network 102 may further include one or more semantic layers 140 that are configured to process the fused BEV feature data 130 and generate classification data 142 representing classification information associated with the 3D space. As described herein, in some examples, the classification information may include classification labels for the voxels, where a classification label indicates a type of object located at an area of the environment associated with a respective voxel. Additionally, a classification may include a general label, such as vehicle, pedestrian, structure, traffic feature, and/or the like, or a classification may include a specific label, such as traffic sign, traffic light, road marking, lane marking, crosswalk, and/or the like for traffic features. As such, in some examples, the multi-modal fusion network 102 may process the image data 104 and the RADAR data 108 to generate outputs indicating whether individual voxels located within the environment are occupied by an object along with a respective classification label for the individual voxels.

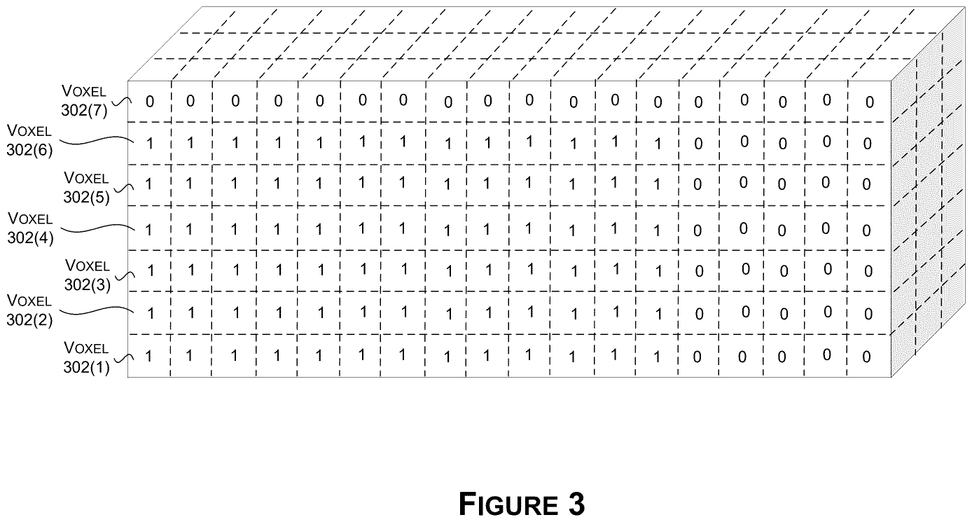

For instance, FIG. 3 illustrates an example of an output indicating occupancy information associated with the environment 204 at least partially surrounding the machine 202, in accordance with some embodiments of the present disclosure. As shown, the output may represent voxels 302(1)-(7) (also referred to singularly as “voxel 302” or in plural as “voxels 302”), although only one column is labeled for clarity reasons, that are associated with the environment 204. Additionally, the output may indicate whether the voxels 302 are occupied by an object, which may be indicated using a first value of 1 (and/or any other value), or whether the voxels 302 are unoccupied, which may be indicated using a second value of 0 (and/or any other value). For instance, the example of FIG. 3 may represent an area of the environment 204 that to a left of the machine 202 such that the voxels 302 represent the objects 206(1)-(2).

In some examples, the output may further indicate classification labels for the voxels 302. For example, if the occupied voxels 302 are associated with the objects 206(1)-(2), then the classification labels may indicate that the occupied voxels 302 are structures and/or types of the structures.

Referring back to the example of FIG. 1A, this process may continue to repeat as the machine continues to generate new image data 104 using the image sensor(s) 106 and new RADAR data 108 using the RADAR sensor(s) 110. For instance, the multi-modal fusion network 102 may continue to process the new image data 104 and the new RADAR data 108 to generate new occupancy data 138 representing occupancy information associated with the environment and new classification data 142 representing classification information associated with the environment. For example, the multi-modal fusion network 102 may be configured to generate new occupancy data 138 and/or new classification data 142 every millisecond, ten milliseconds, one hundred milliseconds, and/or using any other time interval.

Next, FIG. 1B illustrates a second example architecture associated with a multi-modal fusion network 144 that is configured to perform object detection, in accordance with some embodiments of the present disclosure. As shown, the image data 104 and the RADAR data 108 may be applied to the multi-modal fusion network 144. In some examples, before applying the image data 104 (and/or the RADAR data 108), a sensor data pre-processor may use the image data 104 representative of one or more images (or other data representations) and load the image data 104 into memory in the form of a multi-dimensional array/matrix (alternatively referred to as tensor, or more specifically an input tensor, in some examples). The array size may be computed and/or represented as W×H×C, where W stands for the image width in pixels, H stands for the height in pixels, and C stands for the number of color channels. Without loss of generality, other types and orderings of input image components are also possible. Additionally, the batch size B may be used as a dimension (e.g., an additional fourth dimension) when batching is used. Batching may be used for training and/or for inference. Thus, the input tensor may represent an array of dimensions W×H×C×B. Any ordering of the dimensions may be possible, which may depend on the particular hardware and software used to implement the sensor data pre-processor. This ordering may be chosen to maximize training and/or inference performance of the multi-modal fusion network 144.

The image data 104 and the RADAR data 108 may be input into one or more feature extractor layers 146 of the multi-modal fusion network 144. The feature extractor layer(s) 146 may include any number of layers 146, such as the layers 146A-146C. One or more of the layers 146 may include an input layer. The input layer may hold values associated with the image data 104 and/or the RADAR data 108. For example, when the image data 104 is an image(s), the input layer may hold values representative of the raw pixel values of the image(s) as a volume (e.g., a width, W, a height, H, and color channels, C (e.g., RGB), such as 32.times.32.times.3), and/or a batch size, B (e.g., where batching is used).

One or more layers 146 may include convolutional layers. The convolutional layers may compute the output of neurons that are connected to local regions in an input layer (e.g., the input layer), each neuron computing a dot product between their weights and a small region they are connected to in the input volume. A result of a convolutional layer may be another volume, with one of the dimensions based on the number of filters applied (e.g., the width, the height, and the number of filters.

One or more of the layers 146 may include a rectified linear unit (ReLU) layer. The ReLU layer(s) may apply an elementwise activation function, such as the max (0, x), thresholding at zero, for example. The resulting volume of a ReLU layer may be the same as the volume of the input of the ReLU layer.

One or more of the layers 146 may include a pooling layer. The pooling layer may perform a down-sampling operation along the spatial dimensions (e.g., the height and the width), which may result in a smaller volume than the input of the pooling layer (e.g., 16.times.16.times.12 from the 32.times.32.times.12 input volume). In some examples, the multi-modal fusion network 144 may not include any pooling layers. In such examples, other types of convolution layers may be used in place of pooling layers. In some examples, the feature extractor layer(s) 146 may include alternating convolutional layers and pooling layers.

One or more of the layers 146 may include a fully connected layer. Each neuron in the fully connected layer(s) may be connected to each of the neurons in the previous volume. The fully connected layer may compute class scores, and the resulting volume may be 1.times.1.times.number of classes. In some examples, the feature extractor layer(s) 146 may include a fully connected layer, while in other examples, the fully connected layer of the multi-modal fusion network 144 may be the fully connected layer separate from the feature extractor layer(s) 146. In some examples, no fully connected layers may be used by the feature extractor layer(s) 146 and/or the multi-modal fusion network 144 as a whole, in an effort to increase processing times and reduce computing resource requirements. In such examples, where no fully connected layers are used, the multi-modal fusion network 144 may be referred to as a fully convolutional network.

One or more of the layers 146 may, in some examples, include deconvolutional layer(s). However, the use of the term deconvolutional may be misleading and is not intended to be limiting. For example, the deconvolutional layer(s) may alternatively be referred to as transposed convolutional layers or fractionally strided convolutional layers. The deconvolutional layer(s) may be used to perform up-sampling on the output of a prior layer. For example, the deconvolutional layer(s) may be used to up-sample to a spatial resolution that is equal to the spatial resolution of the input images (e.g., the image data 104) to the multi-modal fusion network 144, or used to up-sample to the input spatial resolution of a next layer.

Although input layers, convolutional layers, pooling layers, ReLU layers, deconvolutional layers, and fully connected layers are discussed herein with respect to the feature extractor layer(s) 146, this is not intended to be limiting. For example, additional or alternative layers 146 may be used in the feature extractor layer(s) 146, such as normalization layers, SoftMax layers, and/or other layer types.

The output of the feature extractor layer(s) 146 may be feature maps and/or vectors that are generated using one or more of the feature maps. As described herein, each of the feature maps may include a same resolution or one or more of the feature maps may include a resolution that differs from one or more of the other feature maps. In some examples, the vectors are generated using all of the feature maps. In other examples, the vectors are generated using less than all of the feature maps.

The feature maps may be input into one or more fusion layers 148 of the multi-modal fusion network 144, where the fusion layer(s) 148 includes any number of layers 148A-148C. As described herein, the fusion layer(s) 148 may be configured to fuse the feature map(s) associated with the image data 104 with the feature map(s) associated with the RADAR data 108 in order to generate one or more fused feature maps and/or one or more vectors that are generated using the fused feature map(s). Additionally, the fusion layer(s) 148 may include any type of layers, such as one or more of the layers described above with regard to the feature extractor layer(s) 146.

The fused feature map(s) may be an input into one or more object detection layers 150 of the multi-modal fusion network 144. The object detection layer(s) 150 may include any number of layers 150, such as the layers 150A-150C. The object detection layer(s) 150 may use one or more of the layer types described herein with respect to the feature extractor layer(s) 146 (and/or any other type of layers). As described herein, the object detection layer(s) 150 may not include any fully connected layers, in some examples, to reduce processing speeds and decrease computing resource requirements. In such examples, the object detection layer(s) 150 may be referred to as fully convolutional layers.

Different orders and numbers of the layers 146, 148, and 150 of the multi-modal fusion network 144 may be used, depending on the embodiment. For example, where two or more cameras or other sensor types are used to generate inputs, there may be a different order and number of layers 146, 148, and 150 for one or more of the sensors. As another example, different ordering and numbering of layers may be used depending on the type of sensor used to generate the sensor data, or the type of the sensor data (e.g., RGB, YUV, etc.). As such, the order and number of layers 146, 148, and 150 of the multi-modal fusion network 144 is not limited to any one architecture.

In addition, some of the layers 146, 148, and 150 may include parameters (e.g., weights and/or biases)—such as the feature extractor layer(s) 146, the fusion layer(s) 148, and/or the object detection layer(s) 150—while others may not, such as the ReLU layers and pooling layers, for example. In some examples, the parameters may be learned by the multi-modal fusion network 144 during training. Further, some of the layers 146, 148, and 150 may include additional hyper-parameters (e.g., learning rate, stride, epochs, kernel size, number of filters, type of pooling for pooling layers, etc.)—such as the convolutional layer(s), the deconvolutional layer(s), and the pooling layer(s)—while other layers may not, such as the ReLU layer(s). Various activation functions may be used, including but not limited to, ReLU, leaky ReLU, sigmoid, hyperbolic tangent (tan h), exponential linear unit (ELU), etc. The parameters, hyper-parameters, and/or activation functions are not to be limited and may differ depending on the embodiment.

In any example, an output of the multi-modal fusion network 144 may include occupancy data 152 and/or classification data 154. In some examples, the occupancy data 152 may represent occupancy information similar to the occupancy data 138 and/or the classification data 154 may represent classification information similar to the classification data 142.

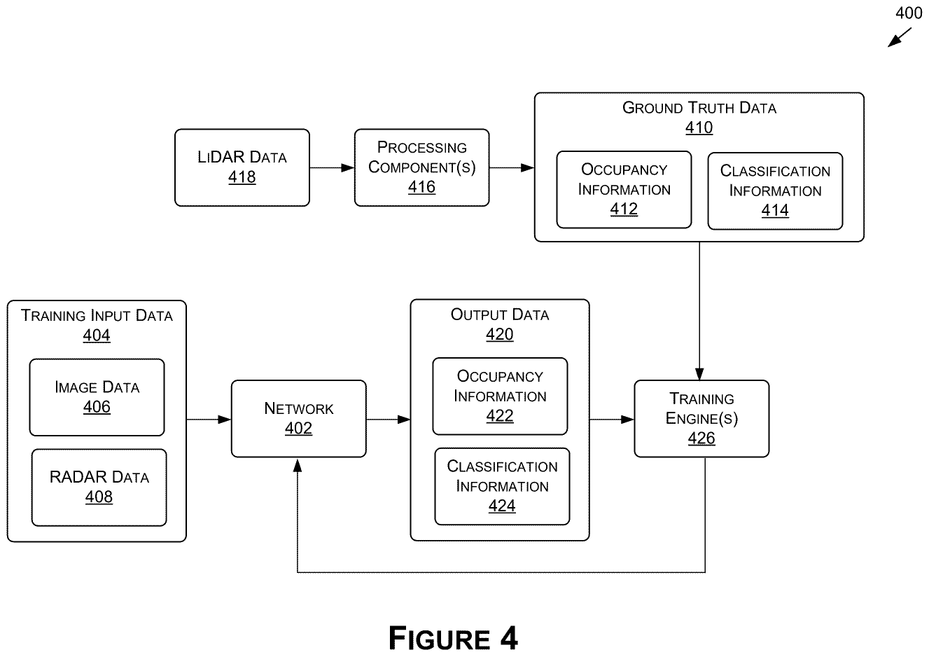

FIG. 4 illustrates an example data flow diagram for a process 400 of training a multi-modal fusion network 402 to process image data and RADAR data when performing object detection, in accordance with some embodiments of the present disclosure. As shown, the multi-modal fusion network 402, which may include and/or represent the multi-modal fusion network 102 and/or the multi-modal fusion network 144, may be trained using training input data 404. As shown, the training input data 404 may include image data 406 and/or RADAR data 408 representing one or more environments. For example, the training input data 404 may be captured using one or more machines that are navigating within the environment(s). As described herein, the training input data 404 may be real produced, synthetically produced, and/or using any combination thereof.

As shown, the multi-modal fusion network 402 may be trained using the training input data 404 along with corresponding ground truth data 410. In some examples, the ground truth data 410 may represent at least occupancy information 412 associated with the environment(s) and/or classification information 414 associated with the environment(s), which is described in more detail herein. For example, and for an instance of the training input data 404, the ground truth data 410 may represent the occupancy information 412 that indicates whether voxels located within a 3D space associated with an environment are occupied and/or the classification information 414 indicating classification labels associated with the voxels. As described herein, the ground truth data 410 may be real produced, synthetically produced, human labeled, machine labeled, and/or any combination thereof.

For instance, and as illustrated by the example of FIG. 4, at least a portion of the ground truth data 410 may be generated based at least on one or more processing components 416 processing LiDAR data 418 that is associated with the training input data 404. For example, the machine(s) that obtained the image data 406 and the RADAR data 408 representing the environment(s) may have also used one or more LiDAR sensors to obtain the LiDAR data 418 representing the environment(s). This way, the LiDAR data 418 represents one or more similar portions of the environment(s) as compared to the training input data 404 such that the LiDAR data 418 may be used to generate at least the portion of the ground truth data 410.

For instance, a processing component 416 may include, but is not limited to, a machine learning model, a neural network, a classifier, a module, a processor, an algorithm, an application, and/or any other type of processing component that is configured to perform one or more of the operations described herein. In some examples, to generate ground truth data 410, the processing component(s) 416 may process the LiDAR data 418 to determine the occupancy information 412 associated with an environment. For example, the processing component(s) 416 may determine that voxels associated with the environment are unoccupied when rays represented by the LiDAR data 418 pass through the voxels, determine that voxels are occupied when rays represented by the LiDAR data 418 stop within the voxels, and/or determine any other state associated with the voxels. Additionally, in some examples, the processing component(s) 416 may process the LiDAR data 418 to determine the classification information 414 associated with the environment. For example, the processing component(s) 416 may process the LiDAR data 418 to determine classification labels associated with at least a portion of the voxels (e.g., the voxels that are occupied). As such, by performing such processes, the processing component(s) 416 is able to automatically generate at least a portion of the ground truth data 410 using the LiDAR data 418.

As described herein, in some examples, one or more additional tasks may be performed to generate the ground truth data 410 for training the multi-modal fusion network 402. For instance, when navigating within an environment, a machine may encounter an elevation change associated with a navigational surface, such as when a road elevation reduces when navigating down a hill and/or when a road elevation increases when navigating up a hill. As such, in some examples, such as to train the multi-modal fusion network 402 to generate output data that is more relevant for navigating machines, the ground truth data 410 may be converted in order to cause the ground truth data 410 to represent planar and/or substantially planar navigational surfaces. For a first example, if a navigational surface decreases in elevation, then elevations associated with voxels corresponding to the ground truth data 410 may be increased in order to represent a planar navigational surface. For a second example, if a navigational surface increases in elevation, then elevations associated with voxels corresponding to the ground truth data 410 may be decreased in order to represent a planar navigational surface.

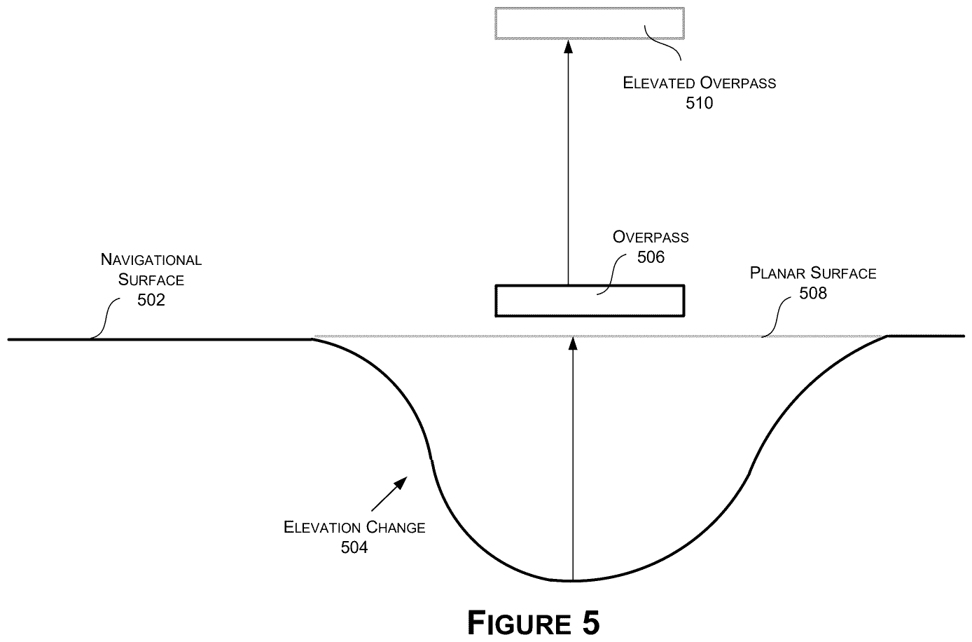

For instance, FIG. 5 illustrates an example of converting a navigational surface 502 to include a planar surface when generating ground truth data, in accordance with some embodiments of the present disclosure. As shown, the navigational surface 502 may initially include an elevation change 504. For example, the navigational surface 502 may include the elevation change 504 such that machines are able to navigate underneath an overpass 506. As such, if the multi-modal fusion network 402 were to process sensor data representing the environment associated with the navigational surface 502, then an output from the multi-modal fusion network 402 may indicate that an area of the environment that is located along the path of a machine is occupied by the overpass 506. However, this may cause the machine to perform one or more operations that are unnecessary based on the driving situation since the area that is located along the path is actually unoccupied since the navigational surface 502 includes the elevation change 504 underneath the overpass 506.

As such, when generating ground truth data 410 associated with the environment, an elevation of the navigational surface 502 may be converted to include a planar surface 508, which is indicated by an arrow. Additionally, an elevation of the overpass 506 may also be converted to include an elevated overpass 510, which is also indicated by an arrow. The ground truth data 410 may then be generated using the planar surface 508 and the elevated overpass 510. This way, when training the multi-modal fusion network 402 using the ground truth data 410, the multi-modal fusion network 402 may be trained to generate output data that is associated with planar surfaces. As such, if the multi-modal fusion network 402 were again to process sensor data representing the environment associated with the navigational surface 502 after this training, then an output from the multi-modal fusion network 402 may indicate that the area of the environment that is located along the path of the machine is unoccupied.

Referring back to the example of FIG. 4, the process 400 may include the multi-modal fusion network 402 processing the training input data 404 and generating output data 420. As shown, the output data 420 may represent at least occupancy information 422 associated with the environment(s) and/or classification information 424 associated with the environment(s), which is described in more detail herein. For example, and for an instance of the training input data 404, the output data 420 may represent the occupancy information 422 that indicates whether voxels located within a 3D space associated with an environment are occupied and/or the classification information 424 indicating classification labels associated with the voxels.

The process 400 may then include one or more training engines 426 using one or more loss functions to measure loss (e.g., error) in the output data 420 as compared to the ground truth data 410. For instance, the loss function(s) may measure loss based at least on differences between the occupancy information 422 and the occupancy information 412 and/or based at least on differences between the classification information 424 and the classification information 414. As described herein, the training engine(s) 426 may use any type of loss function to measure the loss between the output data 420 and the ground truth data 410. The process 400 may then include the training engine(s) 426 performing backward pass computations to recursively compute gradients of the loss function(s) with respect to training parameters in order to update the parameters, weights, and/or biases of the multi-modal fusion network 402, which is indicated by the arrow from the training engine(s) 426 to the multi-modal fusion network 402. For example, the training engine(s) 426 may update the parameters, weights, and/or biases of the encoder(s), the fusion layer(s), and/or the output layer(s) of the multi-modal fusion network 402.

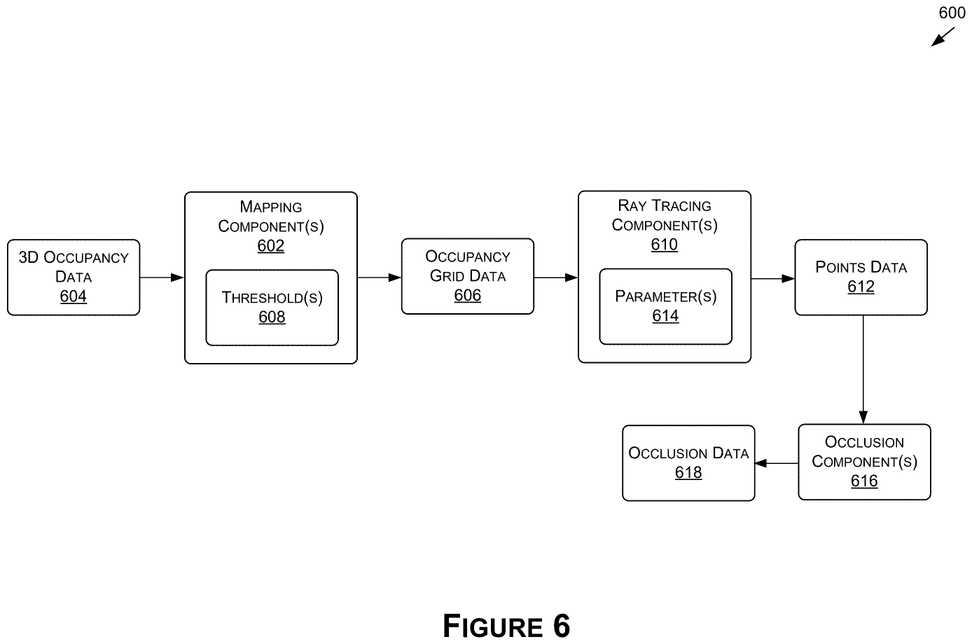

As described herein, in some examples, output data from a multi-modal fusion network may be used to perform one or more additional tasks. For instance, FIG. 6 illustrates an example data flow diagram for a process 600 of performing occlusion detection using occupancy data, in accordance with some embodiments of the present disclosure.

As shown, the process 600 may include one or more mapping components 602 receiving 3D occupancy data 604 associated with an environment. In some examples, the 3D occupancy data 604 may include data that is output by a multi-modal fusion network, such as the occupancy data 138 output by the multi-modal fusion network 102 in the example of FIG. 1A and/or the occupancy data 152 output by the multi-modal fusion network 144 in the example of FIG. 1B. For instance, the 3D occupancy data 604 may represent at least the occupancy information associated with the environment. Additionally, in some examples, the occupancy information may indicate whether voxels associated with the environment are occupied, unoccupied, and/or in any other state.

The mapping component(s) 602 may then process the 3D occupancy data 604 to generate occupancy grid data 606 associated with the environment. In some examples, the mapping component(s) 602 may include and/or use any type of processing component to process the 3D occupancy data 604 in order to generate the occupancy grid data 606, such as one or more machine learning models, one or more neural networks, one or more classifiers, one or more algorithms, one or more processors, one or more applications, one or more modules, and/or any other type of processing component that is configured to perform one or more of the processes descried herein. Additionally, in some examples, the occupancy grid data 606 may represent a 2D occupancy map that indicates whether 2D areas of the environment are occupied, unoccupied, and/or in a different state. However, in other examples, the occupancy grid data 606 may represent a 3D occupancy map that indicates whether 3D areas (e.g., voxels) of the environment are occupied, unoccupied, and/or in a different state, similar to the occupancy information.

For instance, in some examples, a 2D occupancy map may include a 2D occupancy grid where the 2D areas of the environment correspond to the voxels represented by the 3D occupancy data 604. For example, an individual 2D area of the 2D occupancy grid may be associated with one or more voxels that are vertically located at the 2D area within the environment. As such, the mapping component(s) 602 may use the voxels to determine whether the 2D areas of the 2D occupancy map are occupied, unoccupied, and/or in a different state. For instance, to determine whether a 2D area of the environment is occupied, the mapping component(s) 602 may identify the voxel(s) that are associated with the 2D area, such as the voxel(s) that are associated with the same surface area (e.g., voxels that are stacked vertically above the surface of the environment). In some examples, the mapping component(s) 602 may then determine that the 2D area is occupied when at least one of the voxel(s) is indicated as being occupied or determine that the 2D area is unoccupied when all of the voxel(s) are indicated as being unoccupied. In some examples, the mapping component(s) 602 may use a height threshold 608 to determine whether the 2D area is occupied. For example, the mapping component(s) 602 may determine that the 2D area is occupied when at least one of the voxel(s) that is at least the threshold distance above the surface is indicated as being occupied or determine that the 2D area is unoccupied when all of the voxel(s) that is at least the threshold distance above the surface are indicated as being unoccupied. The mapping component(s) 602 may then perform similar processes for one or more (e.g., each) of the 2D areas.

Additionally, or alternatively, in some examples, the mapping component(s) 602 may generate the 2D occupancy grid to indicate the height of objects at the 2D areas within the environment. For example, and for a 2D area, the mapping component(s) 602 may use the voxels that are vertically located at the 2D area within the environment. The mapping component(s) 602 may then use the voxels to determine the height of the highest object at the 2D area and generate the 2D occupancy grid to indicate the height. Additionally, the occupancy component(s) 602 may perform similar processes for one or more (e.g., each) of the 2D areas.

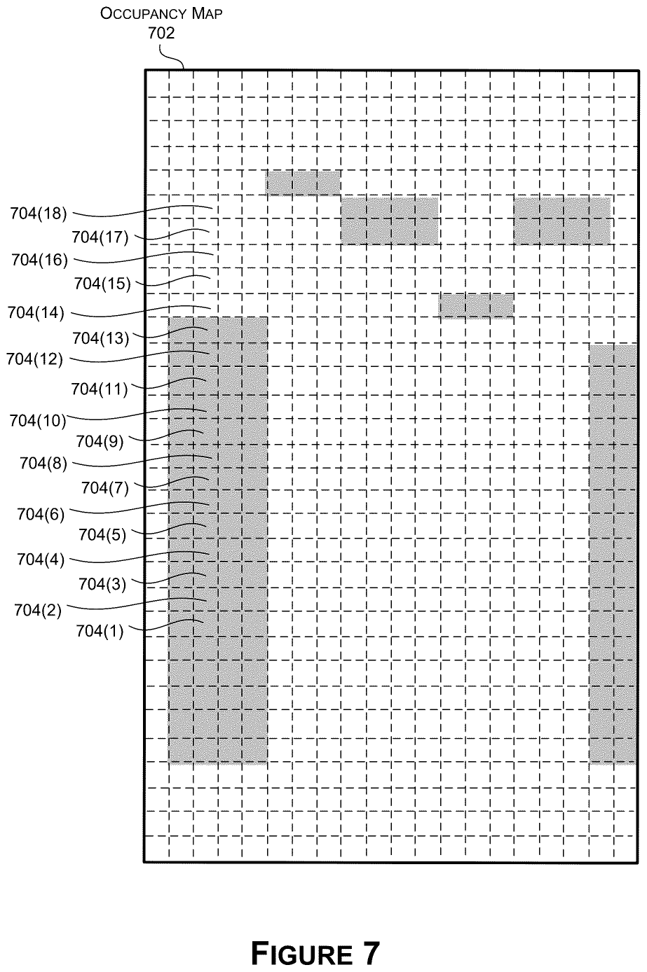

For instance, FIG. 7 illustrates an example of generating a 2D occupancy map 702 indicating occupancy information associated with the environment 204, in accordance with some embodiments of the present disclosure. As shown, the 2D occupancy map 702 may include a 2D occupancy grid that represents 2D areas 704(1)-(18) (also referred to singularly as “2D area 704” or in plural as “2D areas 704”) associated with the environment 204, where only eighteen are labeled for clarity reasons. Additionally, for illustration purposes, the 2D areas 704(1)-(18) may respectively correspond the voxels 302 from the example of FIG. 3 that indicate the occupancy information. For example, the 2D area 704(1) may correspond to the labeled voxels 302(1)-(7) such that the voxels 302(1)-(7) are located at the 2D area 704(1) and layered vertically. As such, the mapping component(s) 602 may use at least the voxels 302 to generate the 2D occupancy map 702.

For example, to determine whether the 2D area 704(1) is occupied, the mapping component(s) 602 may determine that the voxels 302(1)-(7) are associated with the 2D area 704(1). In some examples, the mapping component(s) 602 may then determine that the 2D area 704(1) is occupied based at least on one or more of the voxels 302(1)-(7) being indicated as occupied. Additionally, or alternatively, in some examples, the mapping component(s) 602 may then determine that the 2D area 704(1) is occupied based at least on one or more of the voxels 302(1)-(7) that are at least the threshold distance above the surface of the environment 204 being indicated as occupied. In any of the examples, the mapping component(s) 602 may then continue to perform these processes to determine whether one or more (e.g., each) of the other 2D areas 704 are occupied. In the example of FIG. 7, the 2D areas 704 that are occupied may be indicated by shading while the 2D areas 704 that are unoccupied may be indicated by no shading.

As shown by the example of FIG. 7, the 2D areas 704 of the occupancy map 702 that are associated with the objects 206(1)-(5) and 206(8)-(9) are indicated as being occupied while the 2D areas 704 of the occupancy map 702 that are associated with the objects 206(6)-(7) are indicated as being unoccupied. In some examples, this is because the objects 206(6)-(7) may not satisfy (e.g., are less than) the threshold height while the objects 206(1)-(5) and 206(8)-(9) do satisfy (e.g., are equal to or greater than) the threshold height. Additionally, while the example of FIG. 7 illustrates the occupancy map 702 as indicating occupancies based on both static objects 206(1)-(7) and dynamic objects 206(8)-(9), in other examples, an occupancy map may only indicate occupancies based on just static objects or just dynamic objects.

Furthermore, while the example of FIG. 7 illustrates using shading to indicate whether the 2D areas 704 are occupied or unoccupied, in other examples, the 2D occupancy map 702 may indicate height values associated with the 2D areas 704. For example, and for a 2D area 704, the mapping component(s) 602 may determine the voxels 302 that are associated with the 2D area 704 and then determine the height associated with the 2D area 704 as including the height of the highest voxel 302 that is occupied. The mapping component(s) 602 may then perform similar processes for one or more (e.g., each) of the other 2D areas 704. Moreover, while the example of FIG. 7 illustrates the mapping component(s) 602 as generating a 2D occupancy map 702, in other examples, the mapping component(s) 602 may generate a 3D occupancy map. For instance, the mapping component(s) 602 may generate the 3D occupancy map to include at least a portion of the voxels 302 associated with the environment 204.

Referring back to the example of FIG. 6, the process 600 may include using one or more ray tracing components 610 to determine points within the occupancy map that are associated with object occupancies, where the points may be represented by points data 612. As described herein, in some examples, the ray tracing component(s) 610 may utilize one or more ray tracing techniques to identify the points within the occupancy map. For an example, the ray tracing component(s) 610 may project rays that start at a location associated with the machine within the occupancy map and traverse outwards in multiple directions. In some examples, the ray tracing component(s) 610 projects the rays in all directions with respect to the machine (e.g., in a 360 degrees direction around the machine). However, in some examples, the ray tracing component(s) 610 may only project the rays in specific directions with respect to the machine. For example, the ray tracing component(s) 610 may project the rays in the forward direction along with the side directions with respect to the machine. In other words, the ray tracing component(s) 610 may project the rays in directions that are important to the navigation of the machine, such as locations for which objects may be located that pose a potential safety risk to the machine.

To project the rays with respect to the occupancy map, the ray tracing component(s) 610 may use one or more parameters 614. As described herein, the parameter(s) 614 may include, but is not limited to, a first parameter 614 indicating a horizontal angle at which the rays should be projected (e.g., an angle between the rays horizontally), a second parameter 614 indicating a number of rays that should be projected, a third parameter 614 indicating a maximum distance for projecting the rays, a fourth parameter 614 indicating a vertical angle at which the rays should be projected (e.g., an angle between the rays vertically), a fifth parameter 614 indicating a threshold azimuth for relating rays together, and/or any other parameter. Additionally, in some examples, one or more of the parameter(s) 614 may be based on one or more factors. For instance, the horizontal angle associated with the first parameter 614 may be set such that one or more (e.g., each) of the areas of the occupancy map may be traversed by a respective ray. For example, the angle may be determined based at least on one or more dimensions associated with the occupancy map along with sizes of the areas represented by the occupancy map.

In some examples, the ray tracing component(s) 610 may then determine the points as including locations within the occupancy map at which the rays initially intersect objects. For example, the ray tracing component(s) 610 may determine the points as including locations of occupied 2D areas and/or voxels for which the rays initially intersect within the occupancy map. In other words, by performing such processes, the ray tracing component(s) 610 may identify the closest locations within the environment at which objects are located with respect to the machine, where the closest locations at least partially surround the machine.

Additionally, or alternatively, in some examples, the ray tracing component(s) 610 may use other techniques to determine whether points within the environment are associated with occluded areas of the environment. For example, the ray tracing component(s) 610 may select a test area (e.g., a 2D area, a voxel, etc.) of the occupancy map for testing. The ray tracing component(s) 610 may then determine a test point within the area, such as a center point, a corner point, and/or any other point and determine a first length of a ray that projects from the starting location associated with the machine to the test point, where the ray may be referred to as a “test segment.” Additionally, the ray tracing component(s) 610 may then determine one or more other rays that are projected, such as by using the examples above, and related to the test ray. For example, the ray tracing component(s) 610 may identify the other ray(s) as including one or more azimuths that are similar to (e.g., with a threshold to) the azimuth of the test ray. The ray tracing component(s) 610 may then use one or more second lengths of the other ray(s) that end at one or more occluded areas of the environment, which may be referred to as the “occupancy segment(s),” to determine whether the test point is occluded.

For instance, in some examples, such as when the ray tracing component(s) 610 only identifies a single other ray that is related to the test ray, the ray tracing component(s) 610 may determine that the test point is occluded when the first length of the test segment is equal to or greater than the second length of the occupancy segment associated with the other ray or determine that the test point is not occluded when the first length of the test segment is less than the second length of the occupancy segment. Additionally, or alternatively, in some examples, such as when the ray tracing component(s) 610 identifies multiple other rays that are related to the test ray, the ray tracing component(s) 610 may determine that the test point is occluded when the first length of the test segment is equal to or greater than a majority of the second lengths of the occupancy segments associated with the other rays or determine that the test point is not occluded when the first length of the test segment is less than a majority of the second lengths of the occupancy segments. In other words, the ray tracing component(s) 610 may use test rays associated with individual test points of the occupancy map, along with projected rays associated with the occupancy map, to determine whether the test points are occluded.

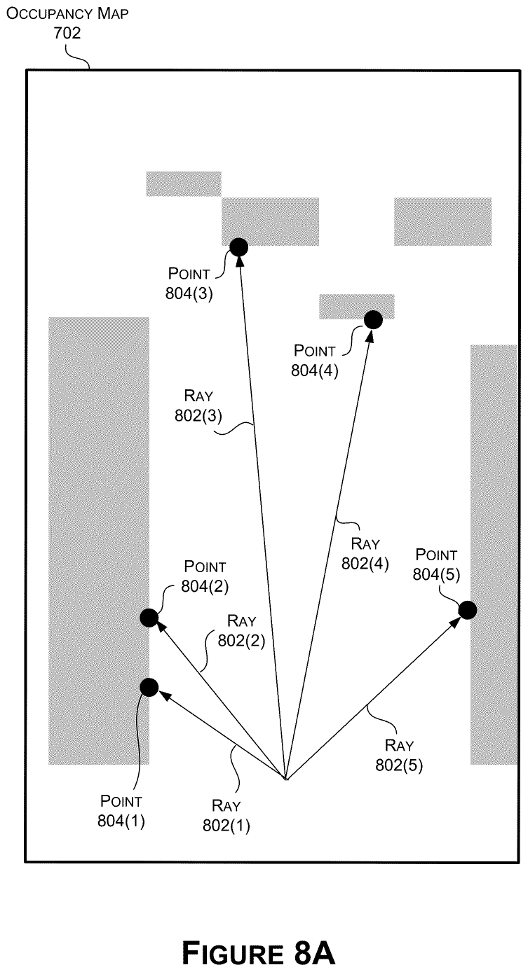

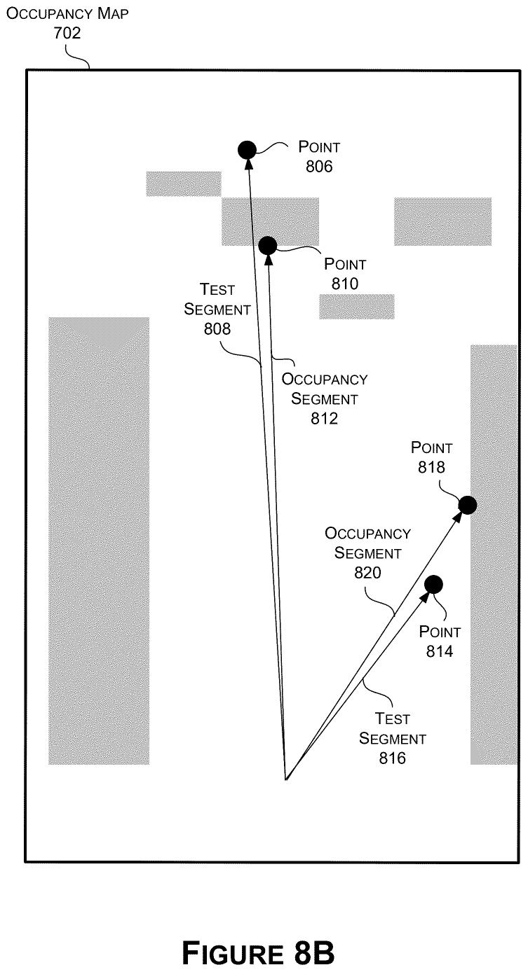

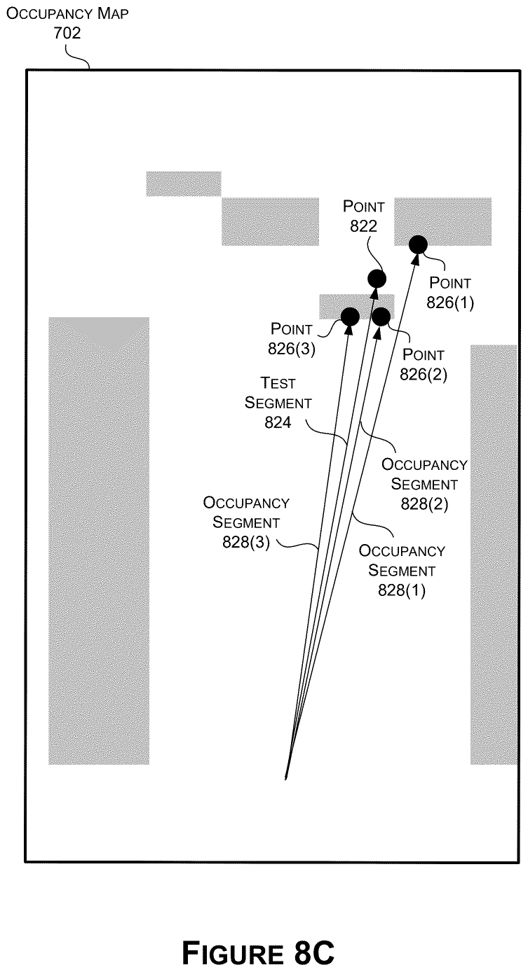

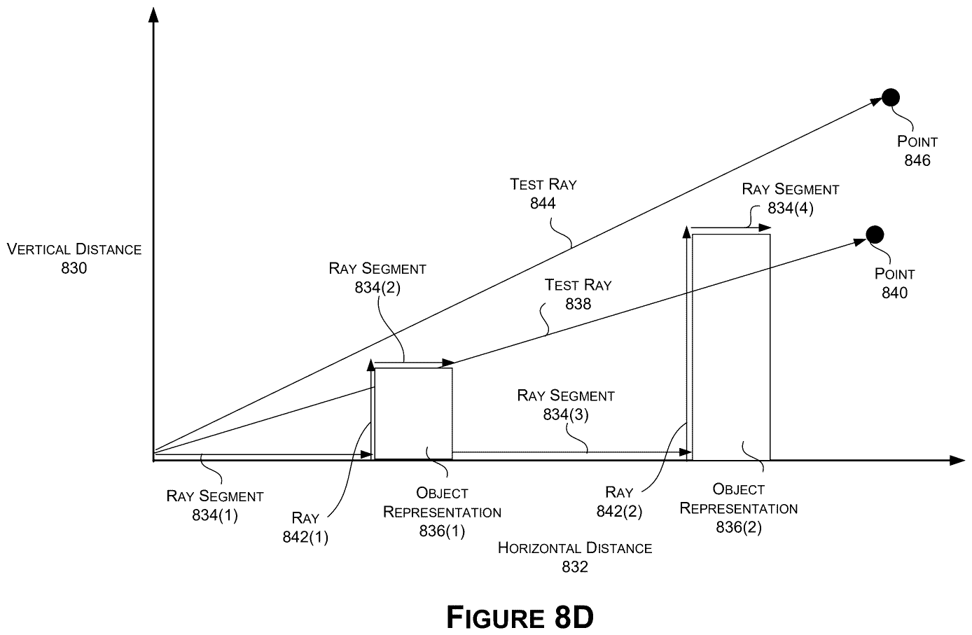

For instance, FIG. 8A illustrates a first example of using ray tracing to identify points within the 2D occupancy map 702 (although the segmentation lines have been removed for clarity reasons) that are associated with closest occupancies with respect to a machine, in accordance with some embodiments of the present disclosure. As shown, the ray tracing component(s) 610 may project rays 802(1)-(5) (also referred to singularly as “ray 802” or in plural as “rays 802”) with respect to the 2D occupancy map 702. While the example of FIG. 8A illustrates the ray tracing component(s) 610 as projecting five rays 802 in three directions with respect to a location of the machine 202, in other examples, the ray tracing component(s) 610 may project any number of rays in any direction with respect to the location of the machine 202. Additionally, in some examples, the ray tracing component(s) 610 may use the parameter(s) 614 when projecting the rays 802, such as an angle between the rays 802. For example, the angle may be set such that the rays 802 traverse through each of the 2D areas 704 of the 2D occupancy map 702 for which occlusions are to be detected.

The ray tracing component(s) 610 may then use the rays to identify points 804(1)-(5) (also referred to singularly as “point 804” or in plural as “points 804”) associated with occupied locations indicated by the 2D occupancy map 702. For instance, in some examples, the points 804 may be located at the occupied 2D areas 704 of the 2D occupancy map 702 for which the rays 802 initially intersect. By performing such processes, the points 804 may represent the objects 206(1)-(5) and 206(8)-(9) that are visible to the machine 202.

Next, FIG. 8B illustrates a second example of using ray tracing to determine whether points within the 2D occupancy map 702 (although the segmentation lines have been removed for clarity reasons) are occupied, in accordance with some embodiments of the present disclosure. As shown, the ray tracing component(s) 610 may project a ray associated with a test point 806 of a 2D area 704 of the 2D occupancy map 702 that is being tested to determine a test segment 808 that includes a first length. The ray tracing component(s) 610 may then determine that another ray associated with an occupied point 810 is related to the ray associated with the test point 806 and then use the other ray to determine an occupancy segment 812 that includes a second length. The ray tracing component(s) 610 may then determine that the 2D area associated with the test point 806 is occluded based at least on the first length of the test segment 808 being greater than the second length of the occupancy segment 812.

Additionally, the ray tracing component(s) 610 may project a ray associated with a test point 814 of a 2D area 704 of the 2D occupancy map 702 that is being tested to determine a test segment 816 that includes a third length. The ray tracing component(s) 610 may then determine that another ray associated with an occupied point 818 is related to the ray associated with the test point 814 and then use the other ray to determine an occupancy segment 820 that includes a fourth length. The ray tracing component(s) 610 may then determine that the 2D area associated with the test point 814 is not occluded based at least on the third length of the test segment 808 being less than the fourth length of the occupancy segment 812. In some examples, the ray tracing component(s) 610 may then perform similar processes to determine whether one or more (e.g., each) of the other 2D areas 704 of the 2D occupancy map 702 are occupied.

Next, FIG. 8C illustrates a third example of using ray tracing to determine whether points within the 2D occupancy map 702 (although the segmentation lines have been removed for clarity reasons) are occluded, in accordance with some embodiments of the present disclosure. As shown, the ray tracing component(s) 610 may project a ray associated with a test point 822 of a 2D area 704 of the 2D occupancy map 702 that is being tested to determine a test segment 824 that includes a fifth length. The ray tracing component(s) 610 may then determine other rays associated with occupied points 826(1)-(3) (also referred to singularly as “occupied point 826” or in plural as “occupied points 826”) that are related to the ray associated with the test point 822 and then use the other rays to determine occupancy segments 828(1)-(3) (also referred to singularly as “occupancy segment 828” or in plural as “occupancy segments 828”) that include sixth lengths. The ray tracing component(s) 610 may then determine that the 2D area associated with the test point 822 is occluded based at least on the fifth length of the test segment 824 being greater than a majority of the sixth lengths of the occupancy segments 828(1)-(3).

FIG. 8D illustrates an example of using ray tracing to determine whether points within a 3D occupancy map (and/or a 2D occupancy map with indicated height values) are occluded, in accordance with some embodiments of the present disclosure. As shown, vertical distances 830 within the environment 204 are graphed with respect to horizontal distances 832 within the environment 204. Additionally, the ray tracing component(s) 610 may project one or more rays with respect to a 3D occupancy map to determine ray segments 834(1)-(4) (also referred to singularly as “ray segment 834” or in plural as “ray segments 834”) with respect to a direction within the environment 204. In some examples, a ray segment 834 may be associated with a horizontal distance 832 and/or location with respect to the 3D occupancy map and/or the environment 204 along with a vertical distance 830. Additionally, the ray segments 834 may be determined based on changes in the vertical distance 830 that is caused to objects, where the objects are represented by object representations 836(1)-(2). The ray tracing component(s) 610 may then store data representing the ray segments 834 and use the data to determine whether points within the environment 204 are occluded.

For a first example, the ray tracing component(s) 610 may project a first test ray 838 to a first test point 840 within the 3D occupancy map, where the first test ray 838 may be associated with a first test segment. The ray tracing component(s) 610 may then use the ray segments 834(1)-(2) to determine a first ray 842(1) associated with the first object and use the ray segments 834(3)-(4) to determine a second ray 842(2) associated with the second object. The ray tracing component(s) 610 may then determine that the first point 840 is occluded based at least on the first test ray 838 intersecting with the first ray 842(1) and/or intersecting with the second ray 842(2). For a second example, the ray tracing component(s) 610 may project a second test ray 844 to a second test point 846 within the 3D occupancy map, where the second test ray 844 may be associated with a second test segment. The ray tracing component(s) 610 may then determine that the second point 846 is not occluded based at least on the second test ray 844 not intersecting with either the first ray 842(1) or the second ray 842(2). The ray tracing component(s) 610 may then perform similar processes for one or more additional points within the environment.

Referring back to the example of FIG. 6, the process 600 may include using one or more occlusion components 616 to determine at least one or more occluded areas of the environment using the points data 612. For instance, in some examples, to determine the occluded area(s), the occlusion component(s) 616 may use the points associated with the rays that initially intersect with objects as represented by the occupancy map. For instance, the occlusion component(s) 616 may determine a region of the occupancy map by connecting the points to from a polygon, where the region of the occupancy map corresponds to a visible area of the environment is not occluded to the machine. The occlusion component(s) 616 may then determine that one or more regions of the occupancy map that are located outside of the polygon correspond to the occluded area(s) of the environment. Additionally, or alternatively, in some examples, the occlusion component(s) 616 may determine that the areas of the occupancy map that the rays continue traversing after the points correspond to the occluded area(s) of the environment.

Additionally, or alternatively, in some examples, to determine the occluded area(s), the occlusion component(s) 616 may use the points data 612 that represent the test points. For instance, the occlusion component(s) 616 may determine first test points that are indicated as being occluded and second test points that are indicated as being not occluded. The occlusion component(s) 616 may then determine that first areas of the occupancy map that correspond to the first test points are occluded and second areas of the occlusion map that correspond to the second test points are not occluded. While these are just two example techniques for how the occlusion component(s) 616 may identify the occluded area(s) of the environment, in other examples, the occlusion component(s) 616 may use additional and/or alternative techniques.

As shown, the process 600 may include the occlusion component(s) 616 generating and/or outputting occlusion data 618 indicating the occluded area(s) of the environment. In some examples, the occlusion data 618 may represent an occlusion map that includes one or more regions (e.g., the region within the polygon) indicating the visible area(s) of the environment and one or more regions (e.g., the region(s) outside of the polygon) indicating the occluded area(s) of the environment. Additionally, or alternatively, in some examples, the occlusion data 618 may represent the occupancy map that includes one or more regions (e.g., the region within the polygon) indicating the visible area(s) of the environment and one or more regions (e.g., the region(s) outside of the polygon) indicating the occluded area(s) of the environment. While these are just two example types of output that the occlusion data 618 may represent, in other examples, the occlusion data 618 may represent any other type of output indicating the occluded area(s) of the environment.

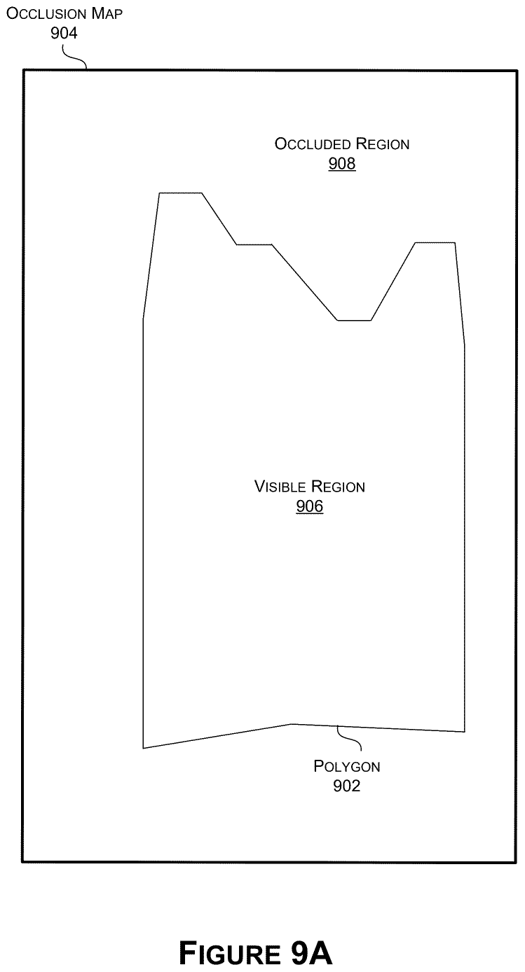

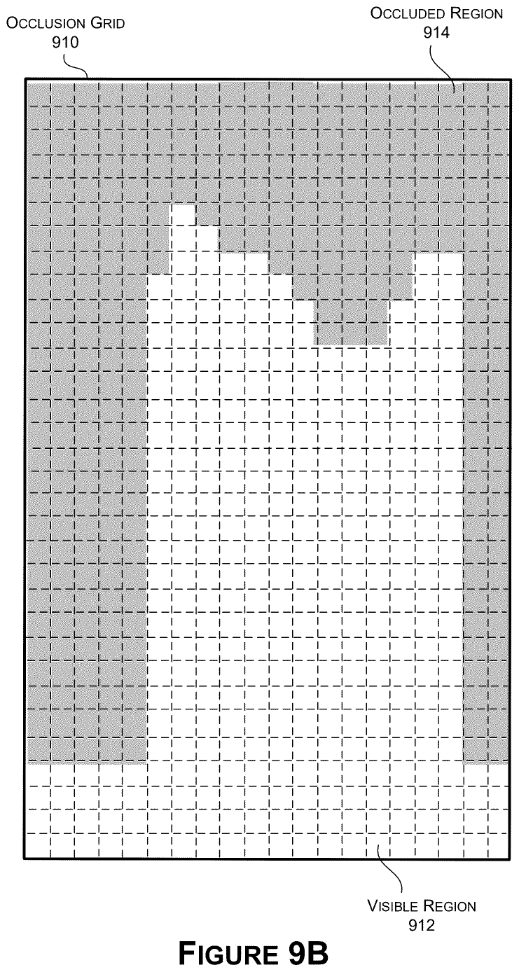

For instance, FIGS. 9A-9B illustrate example outputs that represent one or more occluded areas of the environment 204, in accordance with some embodiments of the present disclosure. As shown by the example of FIG. 9A, the occlusion component(s) 616 may initially connect the points 804 determined using the ray tracing in order to generate a polygon 902. The occlusion component(s) 616 may then generate an occlusion map 904 that indicates at least a visible region 906 within the polygon 902, where the visible region 906 corresponds to a visible area of the environment 204 with respect to the machine 202, and an occluded region 908 that is located outside of the polygon 902, where the occluded region 908 corresponds to an occluded area of the environment 204 that is occluded from the machine 202.

Next, and as shown by the example of FIG. 9B, the occlusion component(s) 616 may use the 2D occupancy map 702 to generate an occlusion grid 910 that also indicates the 2D areas 704 associated with the environment 204. In some examples, the occlusion component(s) 616 may then use the polygon 902 to determine the 2D areas that are associated with a visible region 912 of the occlusion grid 910, where the visible region 912 corresponds to the visible area of the environment 204 with respect to the machine 202, and an occluded region 914 of the occlusion grid 910, where the occluded region 914 corresponds to the occluded area of the environment 204 with respect to the machine 202. For instance, in the example of FIG. 9B, the visible region 912 is indicated by 2D areas of the occlusion grid 910 that include no shading while the occluded region 914 is indicated by 2D areas of the occlusion grid 910 that include the shading.

Additionally, or alternatively, in some examples, the occlusion component(s) 616 may use the test points (e.g., the test points 806 and 814 from the example of FIG. 8B and/or the test point 822 from the example of FIG. 8C) to determine the 2D areas that are associated with the visible region 912 of the occlusion grid 914 and the 2D areas that are associated with the occluded region 924 of the occlusion grid 910. For instance, and for a 2D area of the occlusion grid 910, the occlusion component(s) 616 may determine that the 2D area is occluded when the test point associated with the 2D area is indicated as occluded or determine that the 2D area is not occluded when the test point associated with the 2D area is indicated as being not occluded.

Referring back to the example of FIG. 6, the process 600 may continue to repeat as new 3D occupancy data 604 is obtained, such as by the multi-modal fusion network processing additional image data and RADAR data. This way, the process 600 may continue to generate new occlusion data 618 representing occluded areas of the environment as the machine is navigating through the environment. Additionally, and as described herein, the machine may perform one or more operations using at least the occlusion data 618. For instance, in some examples, the machine may assume that one or more objects are located within an occluded area of the environment and navigate based at least on that assumption. For example, the machine may reduce the velocity of the machine and/or stop when approaching the occluded area for safety. Additionally, the machine may then continue to navigate normally when the area is no longer occluded to the machine and/or when the machine determines that navigating normally is safe, such as by using new occlusion data 618 associated with the environment.

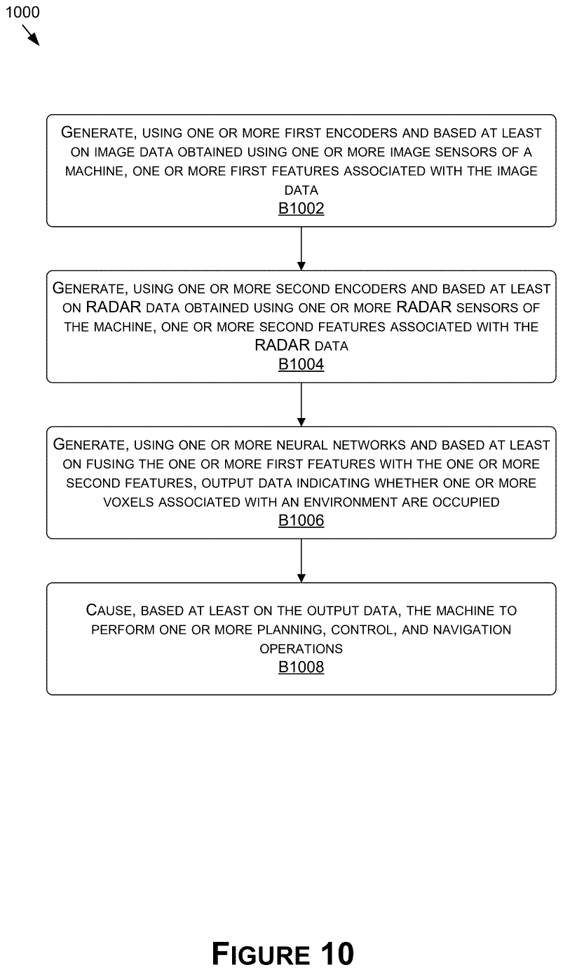

Now referring to FIGS. 10-14, each block of methods 1000, 1100, 1200, 1300, and 1400 described herein, comprises a computing process that may be performed using any combination of hardware, firmware, and/or software. For instance, various functions may be carried out using one or more processors (such as, but not limited to, those described herein) executing instructions stored in one or more memories or memory systems. In some embodiments, the computer processes may also be embodied as computer-usable instructions stored on computer storage media. The methods 1000, 1100, 1200, 1300, and 1400 may be provided by a standalone application, a service or hosted service (standalone or in combination with another hosted service), an application programming interface (API) and/or a plug-in to another product, etc. In addition, the methods 1000, 1100, 1200, 1300, and 1400 described, by way of example, with respect to FIGS. 1A and 6. However, these methods 1000, 1100, 1200, 1300, and 1400 may additionally or alternatively be executed by any one system, or any combination of systems, including, but not limited to, those described herein.

FIG. 10 illustrates a flow diagram showing a method 1000 for a multi-modal fusion network processing image data and RADAR data to determine occupancy information associated with an environment, in accordance with some embodiments of the present disclosure. The method 1000, at block B1002, may include generating, using one or more first encoders and based at least on image data obtained using one or more image sensors of a machine, one or more first features associated with the image data. For instance, the machine may obtain the image data 104 using the image sensor(s) 106, where the image data 104 represents one or more images of an environment. The multi-modal fusion network may then use the image encoder(s) 112 and/or the BEV encoder(s) 116 to process the image data 104 and generate the first feature(s). In some examples, the first feature(s) may correspond to one or more BEV feature maps associated with the image data 104.

The method 1000, at block B1004, may include generating, using one or more second encoders and based at least on RADAR data obtained using one or more RADAR sensors of the machine, one or more second features associated with the RADAR data. For instance, the machine may also obtain the RADAR data 108 using the RADAR sensor(s) 110, where the RADAR data 108 also represents the environment. The multi-modal fusion network 102 may then process the RADAR data 108 using the RADAR encoder(s) 120 to generate the second feature(s). In some examples, the second feature(s) may correspond to one or more BEV maps associated with the RADAR data 108. Additionally, in some examples, the multi-modal fusion network 102 may use the alignment component(s) 124 to align the second feature(s) with respect to the first feature(s), such as the resolution and/or the channel(s).

The method 1000, at block B1006, may include generating, using one or more neural networks and based at least on fusing the one or more first features with the one or more second features, output data indicating whether one or more voxels associated with an environment are occupied. For instance, the multi-modal fusion network 102 may use the BEV fusion layer(s) 128 to fuse the first feature(s) with the second feature(s) to generate one or more fused features. In some examples, the fused feature(s) may correspond to one or more fused BEV feature maps. The multi-modal fusion network 102 may then process the fused feature(s) using the occupancy layer(s) 136 to generate the occupancy data 138 representing the occupancy information. In some examples, the occupancy information may indicate whether the voxels associated with the environment are occupied. Additionally, in some examples, the multi-modal fusion network 102 may process the fused feature(s) using the semantic layer(s) 140 to generate the classification data 142 representing the classification labels associated with the voxels.

The method 1000, at block B1008, may include causing, based at least on the output data, the machine to perform one or more planning, control, or navigation operations. For instance, the machine may use at least the occupancy data 138 to perform the planning, control, and navigation operations. For example, the machine may use the occupancy data 138 to determine one or more paths to navigate in order to at least avoid collisions with objects. The machine may then navigate along one of the paths.

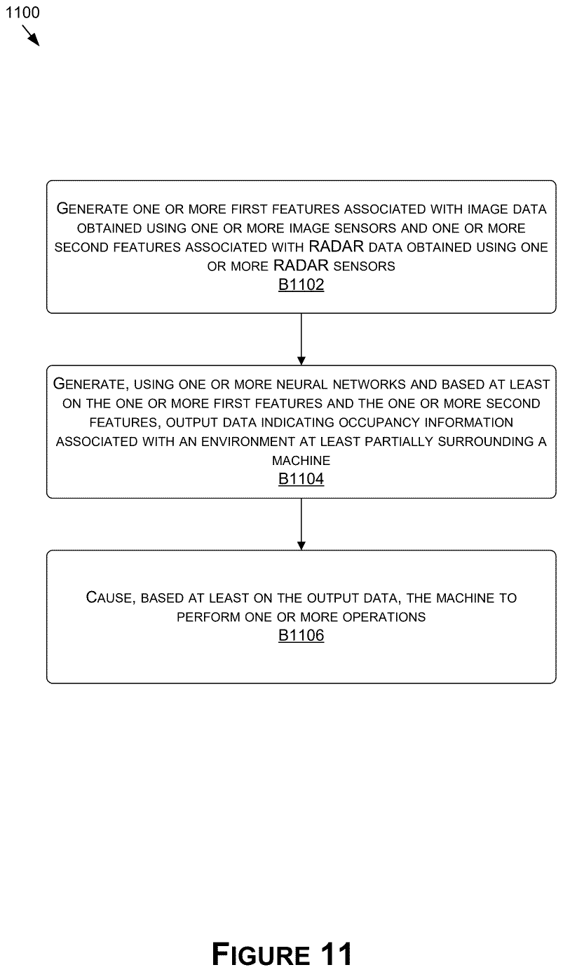

FIG. 11 illustrates a flow diagram showing a method 1100 for fusing image data with RADAR data to perform object detection, in accordance with some embodiments of the present disclosure. The method 1100, at block B1102, may include generating one or more first features associated with image data obtained using one or more image sensors and one or more second features associated with RADAR data obtained using one or more RADAR sensors. For instance, the multi-modal fusion network 102 may use the image encoder(s) 112 and/or the BEV encoder(s) 116 to process the image data 104 and generate the first feature(s). Additionally, the multi-modal fusion network 102 may use the RADAR encoder(s) 120 to process the RADAR data 108 and generate the second feature(s). In some examples, the multi-modal fusion network 102 may then use the alignment component(s) 124 to process the second feature(s) in order to cause the second feature(s) to include the same resolution and/or channel alignment as the first feature(s).

The method 1100, at block B1104, may include generating, using one or more neural networks and based at least on the one or more first features and the one or more second features, output data indicating occupancy information associated with an environment at least partially surrounding a machine. For instance, the multi-modal fusion network 102 may then use the BEV fusion layer(s) 128 to fuse the first feature(s) with the second feature(s) (e.g., the updated feature(s) after alignment) and generate the fused feature(s). The multi-modal fusion network 102 may then process the fused feature(s) using the occupancy layer(s) 136 to generate the occupancy data 138 representing the occupancy information. In some examples, the occupancy information may indicate whether voxels associated with the environment are occupied. Additionally, in some examples, the multi-modal fusion network 102 may process the fused feature(s) using the semantic layer(s) 140 to generate the classification data 142 representing the classification information associated with the voxels.

The method 1100, at block B1106, may include causing, based at least on the output data, the machine to perform one or more operations. For instance, the machine may use at least the occupancy data 138 to perform planning, control, and/or navigation operations within the environment. For example, the machine may use the occupancy data 138 to determine one or more paths to navigate in order to at least avoid collisions with objects. The machine may then navigate along one of the paths.

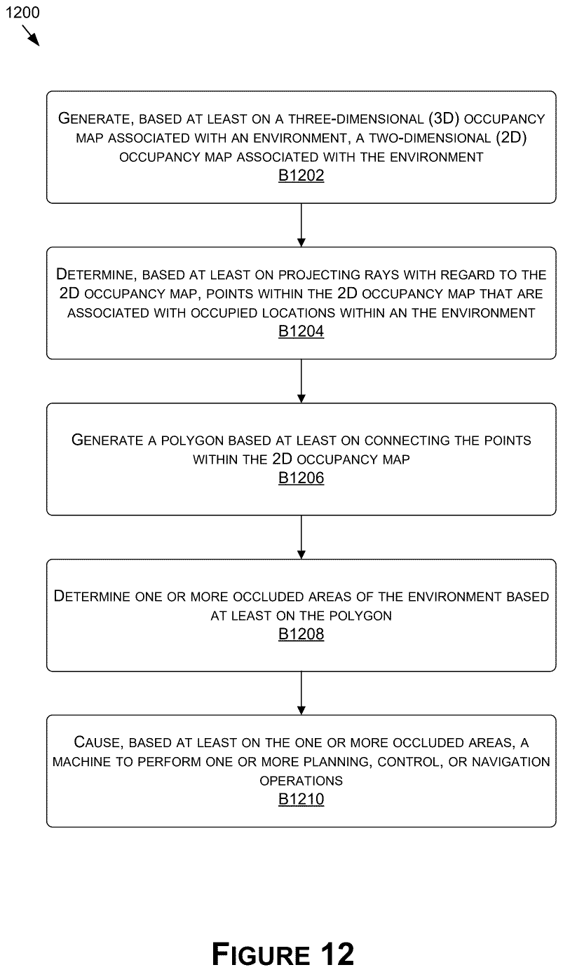

FIG. 12 illustrates a flow diagram showing a method 1200 for performing occlusion detection using an occupancy map associated with an environment, in accordance with some embodiments of the present disclosure. The method 1200, at block B1202, may include generating, based at least on a three-dimensional (3D) occupancy map associated with an environment, a two-dimensional (2D) occupancy map associated with the environment. For instance, the mapping component(s) 602 may use the 3D occupancy map to generate the 2D occupancy map associated with the environment. As described herein, in some examples, the 3D occupancy map may be generated using the multi-modal fusion network 102 processing the image data 104 and the RADAR data 108. Additionally, the 2D occupancy map may include an occupancy grid indicating 2D areas that are occupied, unoccupied, and/or in any other state.

The method 1200, at block B1204, may include determining, based at least on projecting rays with regard to the 2D occupancy map, points within the 2D occupancy map that are associated with occupied locations within the environment. For instance, the ray tracing component(s) 610 may project the rays with respect to the 2D occupancy map. In some examples, the ray tracing component(s) 610 may project the rays based on the parameter(s) 614, such as a parameter 614 that indicates an angle for projecting the rays with respect to one another. The ray tracing component(s) 610 may then use the projected rays to determine the points, such as at locations within the 2D occupancy map that the rays initially intersect with 2D areas that are occupied.

The method 1200, at block B1206, may include generating a polygon based least on connecting the points within the 2D occupancy map and the method 1200, at block B1208, may include determining one or more occluded areas of the environment based at least on the polygon. For instance, the occlusion component(s) 616 may determine the polygon by connecting the points together with respect to the 2D occupancy map. As described herein, the occlusion component(s) 616 may then determine that the region within the polygon corresponds to a visible area of the environment. Additionally, the occlusion component(s) 616 may determine that one or more regions outside of the polygon correspond to the occluded area(s) of the environment.

The method 1200, at block B1210, may include causing, based at least on the one or more occluded areas, a machine to perform one or more planning, control, or navigation operations. For instance, the machine may determine the one or more planning, control, or navigation operations based at least on the occluded area(s). As described herein, in some examples, the machine may make an assumption that one or more objects are located within the occluded area(s). The machine may then determine the one or more planning, control, and navigation operations based on that assumption. For instance, the machine may reduce a velocity and/or stop when approaching the occluded area(s) based on the assumption. Once the occluded area(s) is then visible, the machine may then determine whether the object(s) is actually located within the area(s) and navigate accordingly.

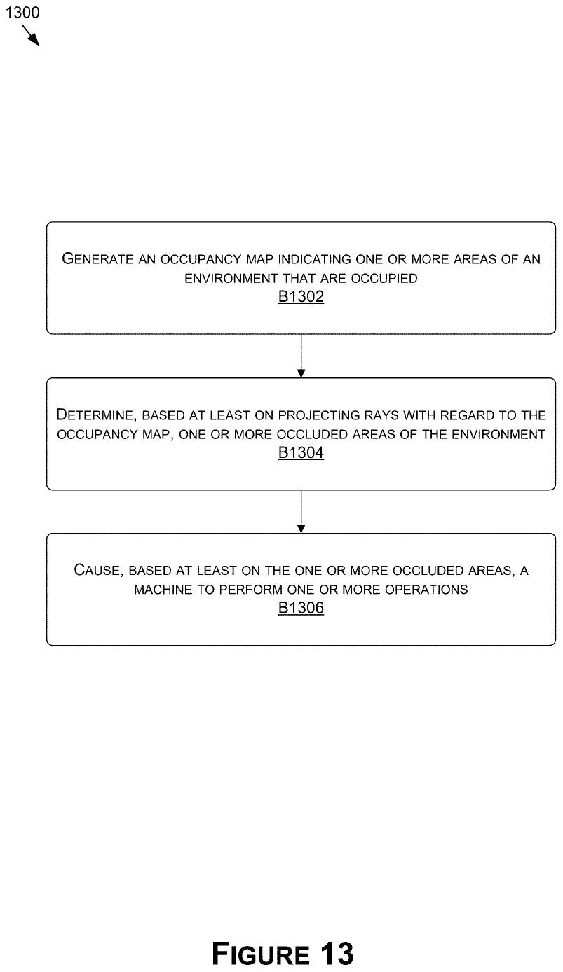

FIG. 13 illustrates a flow diagram showing a method 1300 for using ray tracing to perform occlusion detection with respect to an environment, in accordance with some embodiments of the present disclosure. The method 1300, at block B1302, may include generating an occupancy map indicating one or more areas of an environment that are occupied. For instance, the mapping component(s) 602 may generate the occupancy map associated with the environment. As described herein, in some examples, the occupancy map may include a 2D occupancy grid associated with the environment that indicates the 2D area(s) that is occupied. For example, the 2D occupancy grid may be generated using a 3D occupancy map, such as a 3D occupancy grid indicating whether voxels within the environment are occupied. However, in other examples, the occupancy map may include any other type of representation indicating the occupancy associated with the environment.

The method 1300, at block B1304, may include determining, based at least on projecting rays with regard to the occupancy map, one or more occluded areas of the environment. For instance, the ray tracing component(s) 610 may perform one or more ray tracing techniques to analyze the occupancy map and determine the occluded area(s). For example, the ray tracing component(s) 610 may project one or more rays starting at a location associated with the machine within the environment and outwards. The ray tracing component(s) 610 may then determine one or more points associated with the occupancy map at which the ray(s) intersects with the occupied area(s). Additionally, the occlusion component(s) 616 may use the point(s) to determine the occluded area(s) of the environment. For example, the occlusion component(s) 616 may determine that the occluded area(s) corresponds to one or more regions of the occupancy map that are located outside of a polygon that is generated by connecting the point(s) together.

The method 1300, at block B1306, may include causing, based at least on the one or more occluded areas, a machine to perform one or more operations. For instance, the machine may determine one or more planning, control, or navigation operations based at least on the occluded area(s). As described herein, in some examples, the machine may make an assumption that one or more objects are located within the occluded area(s). The machine may then determine the one or more planning, control, and navigation operations based on that assumption. For instance, the machine may reduce a velocity and/or stop when approaching the occluded area(s) based on the assumption. Once the occluded area(s) is then visible, the machine may then determine whether the object(s) is actually located within the area(s) and navigate accordingly.

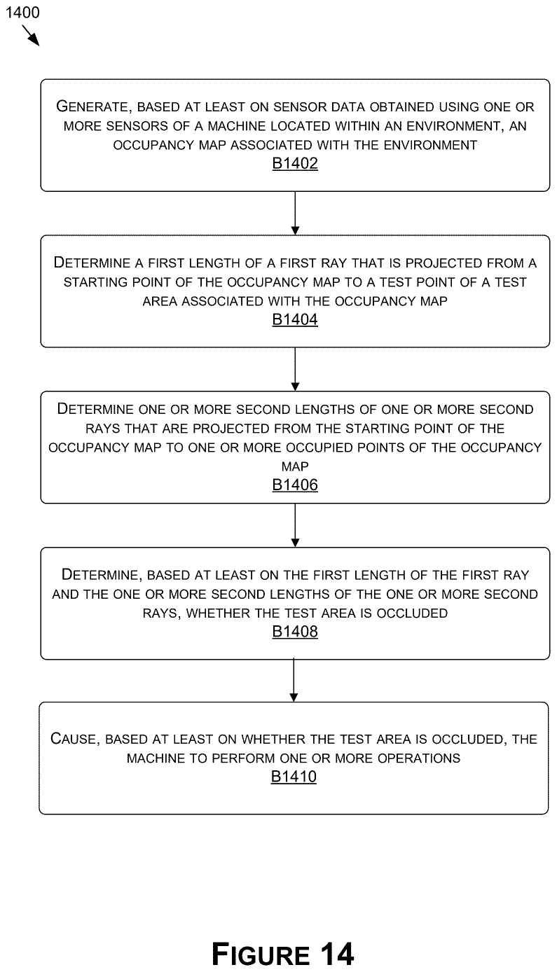

FIG. 14 illustrates a flow diagram showing a method 1400 for using ray tracing on an occlusion map to perform occlusion detection, in accordance with some embodiments of the present disclosure. The method 1400, at block B1402, may include generating, based at least on sensor data obtained using one or more sensors of a machine located within an environment, an occupancy map associated with the environment. For instance, the mapping component(s) 602 may generate the occupancy map associated with the environment. As described herein, in some examples, the occupancy map may include a 2D occupancy grid associated with the environment that indicates the 2D area(s) that is occupied. For example, the 2D occupancy grid may be generated using a 3D occupancy map, such as a 3D occupancy grid indicating whether voxels within the environment are occupied. Additionally, in other examples, the occupancy map may include a 3D occupancy map indicating 3D areas (e.g., voxels) within the environment that are occupied.

The method 1400, at block B1404, may include determining a first length of a first ray that is projected from a starting point of the occupancy map to a test point of a test area associated with the occupancy map. For instance, the ray tracing component(s) 610 may project the first ray from the starting point of the occupancy map to the test point of the test area. For instance, as described herein, the test point may include a center point, a corner point, and/or any other point associated with the test area. Additionally, the first ray may be associated with a test segment that includes the first length.

The method 1400, at block B1406, may include determining one or more second lengths of one or more second rays that are projected from the starting point of the occupancy map to one or more occupied points of the occupancy map. For instance, the ray tracing component(s) 610 may determine that the second ray(s) is related to the first ray using one or more techniques, such as one or more azimuths associated with the second ray(s) being within a threshold to an azimuth of the first ray (and/or any other technique). The ray tracing component(s) 610 may then determine that the second ray(s) is associated with one or more occupancy segments that include the second length(s) since the second point(s) indicated one or more occupied locations within the environment.

The method 1400, at block B1408, may include determining, based at least on the first length of the first ray and the one or more second lengths of the one or more second rays, whether the test area is occluded. For instance, the ray tracing component(s) 610 may determine whether the test area is occluded using the first length of the test segment and the second length(s) of the occupancy segment(s). As described herein, in some examples, the ray tracing component(s) 610 may determine that the test area is occluded based at least on the first length of the test segment being equal to or greater than the second length(s) of the occupancy segment(s) or determine that the test area is not occluded based at least on the first length of the test segment being less than the second length(s) of the occupancy segment(s). Additionally, or alternatively, in some examples, the ray tracing component(s) 610 may determine that the test area is occluded based at least on the first length of the test segment being equal to or greater than a majority of the second length(s) of the occupancy segment(s) or determine that the test area is not occluded based at least on the first length of the test segment being less than the majority of the second length(s) of the occupancy segment(s).

The method 1400, at block B1410, may include causing, based at least on whether the test area is occluded, the machine to perform one or more operations. For instance, the machine may determine one or more planning, control, or navigation operations based at least on the whether the test area is occluded. As described herein, in some examples, the machine may make an assumption that one or more objects are located within the test area(s) if it is determined that the test area is occluded. The machine may then determine the one or more planning, control, and navigation operations based on that assumption. For instance, the machine may reduce a velocity and/or stop when approaching the test area based on the assumption. Once the test area is then visible, the machine may then determine whether the object(s) is actually located within the test area and navigate accordingly.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, watercraft, shuttles (e.g., robotaxis), emergency response vehicles, motorcycles, electric or motorized bicycles, aircraft, construction vehicles, underwater craft (e.g., piloted or unpiloted submarines), drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets (e.g., NVIDIA's Omniverse), cloud computing, and/or any other suitable applications.

Disclosed embodiments may be comprised in a variety of different systems such as automotive systems (e.g., a control system for an autonomous or semi-autonomous machine, a perception system for an autonomous or semi-autonomous machine, etc.), systems implemented using a robot, aerial systems, medial systems, boating systems, smart area monitoring systems, systems for performing deep learning operations, systems for performing simulation operations, systems for performing digital twin operations, systems implemented using an edge device, systems implementing language models—such as large language models (LLMs), vision language models (VLMs), vision-language-action (VLA) models, and/or multi-modal language models (MMLMs), systems using or deploying one or more inference microservices, systems that incorporate deploy one or more machine learning models in a service or microservice along with an OS-level virtualization package (e.g., a container), a system for performing one or more wireless cellular transmissions using a wireless cellular network, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for performing generative AI operations, systems implemented at least partially using cloud computing resources, and/or other types of systems.

### Example Autonomous or Semi-Autonomous Machine

FIG. 15A is an example of sensor locations having corresponding fields of view or sensory fields for an autonomous or semi-autonomous vehicle 1500a, an autonomous mobile robot (AMR) 1500b, and a humanoid robot 1500c, in accordance with some embodiments of the present disclosure. Although three types of machines 1500 are illustrated, this is not intended to be limiting, and the machine(s) 1500 described herein may include a vehicle, a car, a truck, a bus, a first responder vehicle, a shuttle, an electric or motorized bicycle, a motorcycle, a fire truck, a police or emergency vehicle, an ambulance, a watercraft, a construction vehicle, an underwater craft, a robot (e.g., AMR, humanoid, robotic arm, end-effector, forklift, etc.), a drone, an aircraft, a vehicle coupled to a trailer (e.g., a semi-tractor-trailer truck used for hauling cargo), and/or another type of vehicle or machine (e.g., that is unmanned and/or that accommodates one or more passengers). The vehicle 1500a, AMR 1500b, humanoid robot 1500c, and/or other machine types may be referred to herein collectively as machine 1500, in some instances.

With respect to vehicles 1500A, autonomous and semi-autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The machine 1500 may be capable of functionality in accordance with one or more of Level 3-Level 5 of the autonomous driving levels. The machine 1500 may be capable of functionality in accordance with one or more of Level 1-Level 5 of the autonomous driving levels. For example, the machine 1500 may be capable of driver assistance (Level 1), partial automation (Level 2, Level 2+, Level 2++), conditional automation (Level 3), high automation (Level 4), and/or full automation (Level 5), depending on the embodiment. The term “autonomous,” as used herein, may include any and/or all types of autonomy for the machine 1500 or other machine, such as being fully autonomous, being highly autonomous, being conditionally autonomous, being partially autonomous, providing assistive autonomy, being semi-autonomous, being primarily autonomous, or other designation.

With respect to FIG. 15A, the sensors and their respective fields of view (not illustrated for clarity purposes) or sensory fields (not illustrated for clarity purposes) are one example embodiment and are not intended to be limiting. Although not illustrated, each sensor may have a corresponding field of view (e.g., a 360 degree field of view of a surround camera 1568D, a 180 degree field of view of a wide-view camera 1570, a 360 degree sensory field of a LiDAR sensor 1564, etc.). For example, only a subset of the sensors illustrated may be included, additional sensors may be included, alternative sensors may be included, the number of each sensor modality may differ, the sensor modalities may differ (e.g., may not include LiDAR or RADAR, may include SONAR, thermal sensors, etc.), the sensor locations may be different from those illustrated on the vehicle 1500a, AMR 1500b, and/or humanoid robot 1500c, etc. For example, with respect to the vehicle 1500a, depending on the type (e.g., SUV, truck, sedan, robot, motorcycle, etc.), size (e.g., 18-wheeler, moving van, small sedan, etc.), and related functionality (e.g., L2 vs. L5), the locations, numbers, modalities, and/or other sensor information may differ. Similarly, for the AMR 1500b and/or humanoid robot 1500c, the shape, size, purpose, implementation, model, etc. may dictate the number and types of sensors used.

As illustrated in FIG. 1A, the autonomous or semi-autonomous vehicle 1500A, the AMR 1500B, and the humanoid robot 1500C may include different sensor types, number, and locations. For a non-limiting example, the vehicle 1500A may include twelve cameras 1564, such as a front wide camera (e.g., 120 degree field of view (FOV)), a front telephoto camera (e.g., 30 degree FOV), a side rear left camera (e.g., 70 degree FOV), a side rear right camera (e.g., 70 degree FOV), a front fisheye camera (e.g., 200 degree FOV), a rear fisheye camera (e.g., 200 degree FOV), a left fisheye camera (e.g., 200 degree FOV), a right fisheye camera (e.g., 200 degree FOV), a front telephoto satellite camera (e.g., 30 degree FOV), a rear telephoto camera (e.g., 30 degree FOV), a cross left camera (e.g., 120 degree FOV), and a cross right camera (e.g., 120 degree FOV). The camera(s) 1564 may use, in embodiments, a gigabit multimedia serial link (GMSL) interface—such as GMSL2—as input/output (I/O).

In some embodiments, although not illustrated in FIG. 15A, the vehicle 1500A may include an in-cabin occupant and/or driver monitoring system, that may include various different sensors. For example, the in-cabin sensors may include various cameras 1568, such as a driver monitoring camera (e.g., 55 degree FOV positioned forward of and facing toward the driver seat), a front occupant monitoring camera (e.g., 190 degree FOV positioned forward of and facing the front occupant(s) seat(s)), and a rear occupant monitoring camera (e.g., 190 degrees positioned forward of and facing the rear occupant(s) seat(s)). Similar to the external facing camera(s) 1568, the internal camera(s) 1568 may, in embodiments, use a GMSL (such as GMSL2) interface for I/O.

As another non-limiting example, the vehicle 1500A may further include nine RADAR sensors 1560. For example, the vehicle 1500A may include a front center imaging RADAR sensor (e.g., 120 degree FOV or sensory field), a corner front left RADAR sensor (e.g., 160 degree FOV or sensory field), a corner front right RADAR sensor (e.g., 160 degree FOV or sensory field), a corner rear right RADAR sensor (e.g., 160 degree FOV or sensory field), a side left RADAR sensor (e.g., 160 degree FOV or sensory field), a side right RADAR sensor (e.g., 160 degree FOV or sensory field), a rear left RADAR sensor (e.g., 50 degree FOV or sensory field), and rear right RADAR sensor (e.g., 50 degree FOV or sensory field). The RADAR sensor(s) 1560 may use, in embodiments, an Ethernet interface as I/O.

The vehicle(s) 1500A may further include, as a non-limiting example, twelve ultrasonic sensors 1562. As illustrated in FIG. 15A, the ultrasonic sensors may be positioned along the front and rear bumpers of the vehicle 1500A, and along the side of the vehicle 1500A, and may be used to detect objects (static and dynamic) in close proximity to the vehicle 1500A. In some embodiments, the ultrasonic sensor(s) 1562 may use a DS13 interface as I/O.

The vehicle(s) 1500A may further include, as a non-limiting example, a LiDAR sensor 1564, such as a front center LiDAR sensor (e.g., 120 degree horizontal FOV or sensory field and 30 degree vertical FOV or sensor field). In some embodiments, such as where additional or alternative LiDAR sensors are used, the LiDAR sensor may have differing horizontal and vertical fields of view or sensory fields. For example, a LiDAR sensor 1564 may include a 360 degree horizontal FOV or sensory field (such as in a spinning LiDAR sensor) and a 90 degree vertical FOV or sensory field. In some embodiment, the LiDAR sensor(s) 1564 may use an Ethernet interface as I/O.

The autonomous mobile robot (AMR) 1500B may include, as a non-limiting example, three LiDAR sensors 1564. For example, the top-most illustrated LiDAR sensor 1564 may include a beam or 3D LiDAR sensor (e.g., 360 degree horizontal and 90 degree vertical FOV or sensory field), and the front and rear LiDAR sensors may include planar or 2D LiDAR sensors (e.g., 180 degree horizontal FOV or sensory field).

The AMR 1500B may further include, as a non-limiting embodiment, eight cameras 1568, such as a front stereo camera (e.g., 120 degree FOV), a rear stereo camera (e.g., 120 degree FOV), a left stereo camera (e.g., 120 degree FOV), a right stereo camera (e.g., 120 degree FOV), a front fisheye camera (e.g., 202 degree+−3 degree FOV), a rear fisheye camera (e.g., 202 degree+−3 degree FOV), a left fisheye camera (e.g., 202 degree+−3 degree FOV), and a right fisheye camera (e.g., 202 degree+−3 degree FOV).

The AMR 1500B may further include a charging port, charging port contacts, a status indicator light, one or more (e.g., four) RGB LEDs, one or more IMU sensors 1566, a magnetometer, and a barometer. The AMR 1500B is capable of high-precision time synchronization between sensors using hardware time stamping, and PTP over Ethernet with less than 10 microseconds for sensor acquisition time. The AMR 1500B provides simultaneous camera capture across all cameras 1568 within 100 microseconds from a single hardware trigger, in embodiments, and can write to disk at 4 GB/second for sensor capture to bag writing (e.g., writing to ROSbags for the robot operation system (ROS)). As such, the AMR 1500B is capable of running the ROS (such as NVIDIA's Isaac ROS), can be teleoperated (as described herein), can map an environment, and can navigate within an environment using visual cameras 1568, LiDARs 1564, and/or other sensor types or modalities.

The humanoid robot 1500C may include, as a non-limiting example, one LiDAR sensor 1564. For example, the LiDAR sensor 1564 may include a beam or 3D LiDAR sensor (e.g., 360 degree horizontal and 90 degree vertical FOV or sensory field), or may include a planar or 2D LiDAR sensor (e.g., 180 degree horizontal FOV or sensory field).

The humanoid robot 1500C may further include, as a non-limiting embodiment, four cameras 1568, such as a front stereo camera (e.g., 120 degree FOV), a rear stereo camera (e.g., 120 degree FOV), a front fisheye camera (e.g., 202 degree+−3 degree FOV), and a rear fisheye camera (e.g., 202 degree+−3 degree FOV).

The humanoid robot 1500C may further include, as a non-limiting embodiment, four ultrasonic sensors 1562, such as a left arm ultrasonic sensor, a right arm ultrasonic sensor, a left leg ultrasonic sensor, and right leg ultrasonic sensor.

The humanoid robot 1500C may further include any number of actuators—such as to allow control and maneuverability of joints. For example, the humanoid robot 1500C may include actuators that allow for various degrees of freedom (DoF) depending on the design. In a non-limiting embodiment, the humanoid robot 1500C may have 40 total degrees of freedom (DoF) (e.g., 6 DoF×2 for the arms, 6 DoF×2 for the hands, 6 DoF×2 for the legs, 2 DoF for the torso, and 2 DoF for the neck). The actuators may convert energy into physical motion, allowing for actions such as joint movements, locomotion, and gripping/manipulation. For example, joint movements may be performed using motors and servos to control the rotation of joints in an arm or manipulator, and to allow for reaching, grabbing, and manipulating objects. Locomotion may be accomplished using wheels, tracks, or other locomotion devices (robotic legs) to move around the environment. Gripping and manipulation may be performed using end-effectors or hands/fingers, which may be equipped with actuators to grip objects, apply force, and perform specific tasks. In some examples, the humanoid robot 1500C may include position and orientation sensors, such as encoders, gyroscopes, and the like, to determine the position of the robot 1500C in space, allowing for location determination and movement tracking. The humanoid robot 1500C may include force and pressure sensors, in embodiments, to detect environment interactions, allowing the robot 1500C to grasp objects with the right force and to avoid obstacles along the way. The perception sensors (e.g., cameras, LiDARs, RADARs, ultrasonic, SONAR, etc.) may be used along with tactile sensors to allow the robot 1500C to perceive objects, shapes, and textures, and to understand when touch is initiated and stopped (along with force sensors that regulate the force used during touch). As a non-limiting example, the humanoid robot 1500C may have a height of about 1-2 meters (e.g., 1.7 meters or 5′ 6″), a weight of 50-70 kg, be capable of moving at a speed of 8 or more km/h, and be able to carry payloads anywhere from 20-100 kg, depending on the design and requirements of the system.

The humanoid robot 1500C, in embodiments, may include a conversational system—such as a conversational system powered by language models (e.g., LLMs, VLMs, MMLMs, VLAs, etc.)—in order to help understand the environment, reason, and communicate with humans, animals, devices, and/or other robots, and/or make planning, control, and navigation decisions. As such, in addition to performing various tasks, the humanoid robot 1500C may use onboard sensors, microphones, and speakers to understanding speech, audio and visual cues, etc., while also being able to communicate back to the environment.

With reference to cameras 1568 of the machine(s) 1500, the camera types for the cameras 1568 may include, but are not limited to, digital cameras that may be adapted for use with the components and/or systems of the machine 1500. For a vehicle 1500a implementation, the camera(s) 1568 may operate at automotive safety integrity level (ASIL) B and/or at another ASIL. The camera types may be capable of any image capture rate, such as 30 frames per second (fps), 60 fps, 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

Cameras with a field of view that include portions of the environment in front of the machine 1500 (e.g., front-facing cameras) may be used for surround view, to help identify forward facing paths and obstacles, as well aid in, with the help of one or more controllers 1536 and/or control SoCs, providing information critical to generating an occupancy grid and/or determining the preferred machine movements, trajectories, and/or paths. Front-facing cameras may be used to perform many of the same ADAS functions as LiDAR, including emergency braking, pedestrian detection, and collision avoidance. Front-facing cameras may also be used for ADAS functions and systems including Lane Departure Warnings (“LDW”), Autonomous Cruise Control (“ACC”), and/or other functions such as traffic sign recognition.

A variety of cameras may be used in a front-facing configuration, including, for example, a monocular camera platform that includes a complementary metal oxide semiconductor (“CMOS”) color imager. Another example may be a wide-view camera(s) 1568B that may be used to perceive objects coming into view from the periphery (e.g., pedestrians, warehouse vehicles, other robots, crossing traffic, or bicycles). In addition, any number of long-range camera(s) 1568E (e.g., a long-view stereo camera pair) may be used for depth-based object detection, especially for objects for which a neural network has not yet been trained. The long-range camera(s) 1568E may also be used for object detection and classification, as well as basic object tracking.

Any number of stereo cameras 1568A may also be included in a front-facing and/or other (e.g., rear-facing) configuration. In at least one embodiment, one or more of stereo camera(s) 1568A may include an integrated control unit comprising a scalable processing unit, which may provide a programmable logic (“FPGA”) and a multi-core micro-processor with an integrated Controller Area Network (“CAN”) or Ethernet interface on a single chip. Such a unit may be used to generate a 3D map of the machine's 1500 environment, including a distance estimate for points in the image (e.g., a disparity or depth image). An alternative stereo camera(s) 1568A may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 1568A may be used in addition to, or alternatively from, those described herein. For example, in some embodiments, stereo depth estimation may be performed using other than stereo cameras, such as two monocular cameras having at least partially overlapping fields of view.

Cameras with a field of view that include portions of the environment to the side of the machine 1500 (e.g., side-view cameras) may be used, for example, for surround view, providing information used to create and update the occupancy grid, as well as to generate side impact collision warnings and/or to indicate to an AMR 1500B or humanoid robot 1500C, for example, that there are objects, features, and/or persons present to the side. For example, surround camera(s) 1568D may be positioned on the machine 1500. The surround camera(s) 1568D may include wide-view camera(s) 1568B, fisheye camera(s), 360 degree camera(s), and/or the like. For example, four fisheye cameras may be positioned on the machine's 1500 front, rear, and sides. In an alternative arrangement, the machine 1500 may use three surround camera(s) 1568D (e.g., left, right, and rear), and may leverage one or more other camera(s) (e.g., a forward-facing camera) as a fourth surround view camera.

Cameras 1568 with a field of view that include portions of the environment to the rear of the machine 1500 (e.g., rear-view cameras) may be used for gaining an understanding of objects, features, persons, and/or other information to the rear of the machine 1500, such as for park assistance, surround view, rear collision warnings, planning, control, and navigation determinations, and/or creating and updating an occupancy grid, BEV image representing the environment, height map, etc. A wide variety of cameras 1568 may be used including, but not limited to, cameras 1568 that are also suitable as a front-facing camera(s) (e.g., long-range and/or mid-range camera(s) 1568E, stereo camera(s) 1568A), infrared camera(s) 1568C, etc.), rear-facing camera(s), side-facing camera(s), downward facing camera(s), upward facing camera(s), and/or the like, as described herein.

Similarly, for LiDAR sensors 1564, RADAR sensors 1560, ultrasonic sensors 1562, and/or other sensor modalities or types, the location and placement of the sensors, and their corresponding fields of view or sensory fields may be determined based on the use case, implementation, or design of the particular machine 1500.

For example, the machine(s) 1500 include RADAR sensor(s) 1560 that may be used by the machine 1500 for long-range object detection, even in darkness and/or severe weather conditions. RADAR functional safety levels may be ASIL B, in embodiments. The RADAR sensor(s) 1560 may use the CAN and/or the bus 1502 (e.g., to transmit data generated by the RADAR sensor(s) 1560) for control and to access object tracking data, with access to Ethernet to access raw data in some examples. A wide variety of RADAR sensor types may be used. For example, and without limitation, the RADAR sensor(s) 1560 may be suitable for front, rear, and side RADAR use. In some example, Pulse Doppler RADAR sensor(s) are used.

The RADAR sensor(s) 1560 may include different configurations, such as long range with narrow field of view, short range with wide field of view, short range side coverage, etc. In some examples, long-range RADAR may be used for adaptive cruise control (ACC) functionality. The long-range RADAR systems may provide a broad field of view realized by two or more independent scans, such as within a 250 m range. The RADAR sensor(s) 1560 may help in distinguishing between static and moving objects, and may be used by ADAS systems for emergency brake assist and forward collision warning, by robots for detecting dynamic objects in various environments—such as those with lower or no lighting. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the machine's 1500 surroundings at higher speeds with minimal interference from the periphery (e.g., from traffic in adjacent lanes). The other two antennae may expand the field of view, making it possible to quickly detect objects entering or leaving the machine's immediate path (e.g., lane).

Mid-range RADAR systems may include, as an example, a range of up to 1560 m (front) or 80 m (rear), and a field of view of up to 42 degrees (front) or 150 degrees (rear). Short-range RADAR systems may include, without limitation, RADAR sensors designed to be installed at both ends of a lateral surface (e.g., a rear bumper) such that two beams may be used to constantly monitor the blind spot in the rear and next to the machine 1500 (e.g., vehicle, robot, etc.). As such, short-range RADAR systems may be used in an ADAS system for blind spot detection and/or lane change assist.

The machine 1500 may further include ultrasonic sensor(s) 1562. The ultrasonic sensor(s) 1562, which may be positioned at the front, back, and/or the sides of the machine 1500, may be used for assisting with near-field perception, such as for park assist, collision avoidance (e.g., for robotic parts), and/or to create and update an occupancy grid, evidence grid map (EGM), height map, BEV image, and/or other representation of objects and features in an environment of the machine 1500. A wide variety of ultrasonic sensor(s) 1562 may be used, and different ultrasonic sensor(s) 1562 may be used for different ranges of detection (e.g., 2.5 m, 4 m). The ultrasonic sensor(s) 1562 may operate at functional safety levels of ASIL B, as an example.

The machine 1500 may include LiDAR sensor(s) 1564. The LiDAR sensor(s) 1564 may be used for object and feature detection, pedestrian and other robot detection, emergency braking, collision avoidance, simultaneous localization and mapping (SLAM), free-space detection, and/or other functions. The LiDAR sensor(s) 1564 may be functional safety level ASIL B, in embodiments. In some examples, the machine 1500 may include multiple LiDAR sensors 1564 (e.g., two, four, six, etc.) that may use Ethernet (e.g., to provide data to a Gigabit Ethernet switch).

In some examples, the LiDAR sensor(s) 1564 may be capable of providing a list of objects and their distances for a 360-degree field of view. Commercially available LiDAR sensor(s) 1564 may have an advertised range of approximately 1500 m, with an accuracy of 2 cm-3 cm, and with support for a 1500 Mbps Ethernet connection, for example. In some examples, one or more non-protruding LiDAR sensors 1564 may be used. In such examples, the LiDAR sensor(s) 1564 may be implemented as a small device that may be embedded into the front, rear, sides, top, and/or corners of the machine 1500. The LiDAR sensor(s) 1564, in such examples, may provide up to a 120-degree horizontal and 35-degree vertical field-of-view, with a 200 m range even for low-reflectivity objects. Front-mounted LiDAR sensor(s) 1564 may be configured for a horizontal field of view between 45 degrees and 135 degrees.

In some examples, LiDAR technologies, such as 3D flash LiDAR, may also be used. 3D Flash LiDAR uses a flash of a laser as a transmission source, to illuminate vehicle surroundings up to approximately 200 m. A flash LiDAR unit includes a receptor, which records the laser pulse transit time and the reflected light on each pixel, which in turn corresponds to the range from the vehicle to the objects. Flash LiDAR may allow for highly accurate and distortion-free images of the surroundings to be generated with every laser flash. In some examples, four flash LiDAR sensors may be deployed, one at each side of the machine 1500. Available 3D flash LiDAR systems include a solid-state 3D staring array LiDAR camera with no moving parts other than a fan (e.g., a non-scanning LiDAR device). The flash LiDAR device may use a 5 nanosecond class I (eye-safe) laser pulse per frame and may capture the reflected laser light in the form of 3D range point clouds and co-registered intensity data. By using flash LiDAR, and because flash LiDAR is a solid-state device with no moving parts, the LiDAR sensor(s) 1564 may be less susceptible to motion blur, vibration, and/or shock.

FIG. 15B is an illustration of sensor and component locations of an example autonomous or semi-autonomous vehicle 1500A (alternatively referred to herein as “vehicle 1500,” “ego-vehicle 1500,” “ego-machine 1500,” or “machine 1500,”), in accordance with some embodiments of the present disclosure. Although the vehicle 1500A is illustrated, this is not intended to be limiting, and similar components and/or sensors may be included on any other machine type without departing from the scope of the present disclosure. For example, similar sensors and/or components may be used for a vehicle, a car, a truck, a bus, a first responder vehicle, a shuttle, an electric or motorized bicycle, a motorcycle, a fire truck, a police vehicle, an ambulance, a watercraft, a construction vehicle, an underwater craft, a robot (e.g., AMR, humanoid, robotic arm, end-effector, forklift, etc.), a drone, an aircraft, a vehicle coupled to a trailer (e.g., a semi-tractor-trailer truck used for hauling cargo), and/or another type of vehicle or machine (e.g., that is unmanned and/or that accommodates one or more passengers).

FIG. 15C is a block diagram of an example system architecture for a machine 1500, such as autonomous or semi-autonomous vehicle 1500A, autonomous mobile robot (AMR) 1500B, humanoid robot 1500C, and/or other types of machines, in accordance with some embodiments of the present disclosure. It should be understood that this and other arrangements described herein are set forth only as examples. Other arrangements, components, features, and elements (e.g., machines, interfaces, functions, orders, groupings of functions, etc.) may be used in addition to or instead of those shown, and some elements may be omitted altogether. Further, many of the arrangements, components, features, elements, etc. described herein are functional entities that may be implemented as discrete or distributed components or in conjunction with other components, and in any suitable combination and location (e.g., on a local device, vehicle, or machine at the edge, on-premises—such as locally hosted servers, remotely located—such as in one or more computing or server devices in one or more data centers in the cloud, and/or at other locations). Various functions described herein as being performed by entities may be carried out by hardware, firmware, and/or software. For instance, various functions may be carried out using one or more processors (e.g., central processing units (CPU(s)), graphics processing units (GPU(s)), microprocessors, microcontrollers, embedded processors, digital signal processors (DSPs), image signal processors (ISPs), physics processing units (PPUs), field-programmable gate arrays (FPGAs), accelerator(s) (e.g., deep learning accelerators (DLAs, deep learning accelerator cluster (XNNs), neural network accelerators (NNAs), and/or neural processing units (NPUs), programmable vision accelerators (PVAs), optical flow accelerators (OFAs), etc.), application-specific integrated circuits (ASICs), data processing units (DPUs), quantum processors, etc.) executing instructions stored in memory. In some embodiments, the systems, methods, and processes described herein may be executed using similar components, features, and/or functionality to those of example machine 1500 of FIGS. 15A-15E, example computing ecosystem 1600 of FIG. 16, example generative language model system 1700 of FIG. 17, and/or example computing device 1800 of FIG. 18.

Each of the components, features, and systems of the machine 1500 in FIG. 15C are illustrated as being connected via bus 1502 (alternatively referred to as a “machine communications network 1502,” or just “communications network 1502”). The bus 1502 may include a Controller Area Network (CAN) data interface (alternatively referred to herein as a “CAN bus”). A CAN may be a network inside the machine 1500 used to aid in control of various features and functionality of the machine 1500, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant. In some embodiments, in addition to or alternatively from a CAN bus, the bus 1502 may include FlexRay, an embedded bus (e.g., SPI, I2C), local interconnect link (LIN), NVIDIA's NVLink, USB (2.0, 3.0, onward), radio frequency (RF), Ethernet (e.g., 10BASE/100BASE, 1000BASE, 10G, etc.), and/or another communication protocol or functionality. Additionally, although a single line is used to represent the bus 1502, this is not intended to be limiting. For example, there may be any number of busses 1502, which may include one or more CAN busses, one or more FlexRay busses, one or more Ethernet busses, and/or one or more other types of busses using a different protocol. In some examples, two or more busses 1502 may be used to perform different functions, and/or may be used for redundancy. For example, a first bus 1502 may be used for collision avoidance functionality and a second bus 1502 may be used for actuation control. In any example, each bus 1502 may communicate with any of the components of the machine 1500, and two or more busses 1502 may communicate with the same components. In some examples, each SoC 1504, each controller 1536, and/or each computer or compute engine within the machine 1500 may have access to the same input data (e.g., inputs from sensors of the machine 1500), and may be connected to a common bus, such as a CAN bus.

The machine 1500 may include components such as a chassis, a vehicle body, wheels (e.g., 2, 4, 6, 8, 18, etc.), tires, axles, batteries, side-view mirrors, and/or other components of a vehicle or machine. The machine 1500 may include a propulsion system 1550, such as an internal combustion engine, hybrid electric power plant, an all-electric engine, a hydrogen-fueled engine, and/or another propulsion system type. The propulsion system 1550 may be connected to a drive train of the machine 1500, which may include a transmission, to enable the propulsion of the machine 1500. The propulsion system 1550 may be controlled in response to receiving signals from the throttle/accelerator 1552.

A steering system 1554, which may include a steering wheel and/or other steering device (e.g., remote steering and/or local steering), may be used to steer the machine 1500 (e.g., along a desired path or route) when the propulsion system 1550 is operating (e.g., when the vehicle is in motion). The steering system 1554 may receive signals from a steering actuator 1556. In some embodiments, a steering wheel or other steering mechanism may not be included, such as for a machine 1500 capable of full automation (e.g., Level 5) functionality.

The brake sensor system 1546 may be used to operate the vehicle brakes in response to receiving signals from the brake actuators 1548 and/or brake sensors.

The machine 1500 may include one or more controller(s) 1536, such as those described herein with respect to FIG. 15A. The controller(s) 1536 may be used for a variety of functions, and may be coupled to any of the various other components and systems of the machine 1500. For example, the controllers 1536 may be used for control of the machine 1500, artificial intelligence executing on the machine 1500, infotainment for the machine 1500, and/or the like. For example, one controller 1536 may be used for some or all of the functionality, or different controllers 1536 may be used for different functionalities—e.g., to ensure availability and a safety separation between various controllers for different tasks. For example, the controller(s) 1536 may use plans computed by the system—e.g., paths or trajectories for vehicles 1500A or AMRs 1500B, or movements, components trajectories, movement locations or displacements, etc. for joints or components (e.g., of manipulators, end effectors, limbs, hands, fingers, legs, feet, etc.), of a humanoid robot 1500C—to control the machine(s) 1500 in the environment. In some instances, the controller(s) 1536 may include a proportional-integral-derivative (PID) controller, a fuzzy logic controller, a neural controller (e.g., a controller embodied as one or more neural networks), a force control controller, a programmable logic controller (PLC), and/or another type of controller. In a humanoid robot 1500C, for example, the controller(s) 1536 may act as the brain, responsible for analyzing sensor data, making decisions, and sending commands to the actuators. The controller(s) 1536 may include a low-level controller that handles basic motor control, ensuring accurate and precise movements of individual joints and actuators. The controller(s) 1536 may include a high-level controller to coordinate multiple actuators and sensors, planning complex motions and adapting to changing environments.

The controller(s) 1536 may include an artificial intelligence controller, in embodiments, that may use AI algorithms (e.g., DNNs, MLMs, etc.) to learn, make decisions, and autonomously perform tasks for the machine 1500. In some embodiments, the controller(s) 1536 may use an open-loop control algorithm that is fixed and does not adjust actions to the environment. In other embodiments, closed-loop control may be used that incorporates feedback mechanisms to monitor the robot's performance and make necessary adjustments. In examples, the controller(s) 1536 may implement reactive control in order to respond directly to sensory inputs, allowing for quick reflexes and real-time changes. Further, deliberative control may be implemented in some examples, using internal models and planning algorithms to generate high-level actions, which may be suited for complex tasks that require reasoning, decision making, and long-term planning.

Controller(s) 1536, which may include one or more systems on chip (SoCs) 1504 (FIGS. 15C and 15D), CPUs, GPU(s), accelerator(s), etc., may provide signals (e.g., representative of commands or messages) to one or more components and/or systems of the machine 1500. Although the controller(s) 1536 is listed separately from the SoC(s) 1504, this is not intended to be limiting, and in some embodiments one or more components of the SoC(s) 1504 may perform the operations of the controller(s) 1536. For example, the controller(s) may send signals to operate the machine brakes via one or more brake actuators 1548, to operate the steering system 1554 via one or more steering actuators 1556, to operate the propulsion system 1550 via one or more throttle/accelerators 1552, etc. The controller(s) 1536 may include one or more onboard (e.g., integrated) computing devices (e.g., supercomputers) that process sensor signals, and output operation commands (e.g., signals representing commands) to enable autonomous or semi-autonomous navigation and movement and/or to assist a human operator using the machine 1500. The controller(s) 1536 may include a first controller 1536 for autonomous control and navigation functions, a second controller 1536 for functional safety functions, a third controller 1536 for artificial intelligence functionality (e.g., computer vision), a fourth controller 1536 for infotainment functionality, a fifth controller 1536 for redundancy in emergency conditions, and/or other controllers. For example, the hardware used for safety monitoring and other safety functions (such as a functional safety island) may be discrete or partitioned (physically or via separation of processing) with respect to hardware used for processing sensor data for perception and making vehicle control decisions. Similarly, hardware (e.g., a controller, an SOC, etc.) for controlling in-vehicle infotainment and/or in-cabin monitoring may be discrete or separate from the hardware used for vehicle perception and control. In some examples, a single controller 1536 may handle two or more of the above functionalities, two or more controllers 1536 may handle a single functionality, and/or any combination thereof.

The controller(s) 1536 may provide the signals for controlling one or more components and/or systems of the machine 1500 in response to sensor data received from one or more sensors (e.g., sensor inputs). The sensor data may be received from, for example and without limitation, global navigation satellite systems (“GNSS”) sensor(s) 1558 (e.g., Global Positioning System sensor(s)), RADAR sensor(s) 1560, ultrasonic sensor(s) 1562, LiDAR sensor(s) 1564, inertial measurement unit (IMU) sensor(s) 1566 (e.g., accelerometer(s), gyroscope(s), magnetic compass(es), magnetometer(s), etc.), microphone(s) 1596, camera(s) 1568 (e.g., stereo camera(s) 1568A, wide-view camera(s) 1568B (e.g., fisheye cameras), infrared camera(s) 1568C, surround camera(s) 1568D (e.g., 360 degree cameras), long-range and/or mid-range camera(s) 1568E, and/or other camera types), speed sensor(s) 1544 (e.g., for measuring the speed of the machine 1500), vibration sensor(s) 1542, steering sensor(s) 1540, brake sensor(s) (e.g., as part of the brake sensor system 1546), actuators, and/or other sensor types.

One or more of the controller(s) 1536 may receive inputs (e.g., represented by input data) from an instrument cluster 1532 of the machine 1500 and provide outputs (e.g., represented by output data, display data, etc.) via a human-machine interface (HMI) display 1534 (e.g., screen, heads-up display, mirror display, facial display, robotic display, etc.), an audible annunciator, a loudspeaker, a speaker, and/or via other components of the machine 1500. The outputs may include information such as machine velocity, speed, time, map data corresponding to a map(s) 1522 of FIG. 15C (e.g., from a navigation map, a Standard Definition (SD) map, a High Definition (“HD”) map, etc.), location data (e.g., the machine's 1500 location, such as on a map 1522), direction, location of other vehicles (e.g., an occupancy map, height map, bird's eye view (BEV) image, grid, etc.), information about objects and status of objects as perceived by the system, system status information, etc. For example, the HMI display(s) 1534 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The machine 1500 may include one or more systems on a chip (SoCs) 1504 (described in more detail in FIG. 15D). The SoC(s) 1504 may include CPU(s) 1506, GPU(s) 1508, processor(s) 1510, cache(s) 1512, accelerator(s) 1514, data store(s) 1516, and/or other components and features. The SoC(s) 1504 may be used to process and provide data for various operations, such as navigation, planning, reasoning, inference, perception, control, and/or actuation operations of the machine 1500 in a variety of platforms and systems. For example, the SoC(s) 1504 may process live perception data (e.g., from camera, LiDAR, RADAR, ultrasonic, etc.) in addition to map data corresponding to one or more maps 1522 (e.g., HD map, SD map, navigational map, occupancy map, etc.) in order to make or aid in performing various operations of the machine 1500. Where a map and/or AI is used, map and/or AI (e.g., model parameter updates, fine-tuning, etc.) refreshes and/or updates via a network interface 1524 from one or more servers (e.g., server(s) 1578 of FIG. 15E)—such as one or more servers of a cloud-based data center.

Although an SoC(s) 1504 is illustrated throughout FIGS. 15A-15E, additional or alternative components and/or architectures may be used—such as multi-chip modules (MCMs), application-specific integrated circuits (ASICs), system-in-packages (SiPs), field programmable gate arrays (FPGAs), heterogeneous integration (HI), single-board computers (SBCs)—without departing from the scope of the present disclosure. For example, depending on the type of machine 1500, use of the machine 1500, model of the machine 1500, and required capabilities of the machine 1500, one or more SoCs 1504 and/or alternative architectures and/or components may be used to satisfy the particular implementation.

The machine 1500 may include a CPU(s) 1518 (e.g., discrete CPU(s), or dCPU(s)), that may be coupled to the SoC(s) 1504 via a high-speed interconnect (e.g., PCIe). The CPU(s) 1518 may include an X86 processor, for example. The CPU(s) 1518 may be used to perform any of a variety of functions, including arbitrating potentially inconsistent results between ADAS sensors and the SoC(s) 1504, and/or monitoring the status and health of the controller(s) 1536 and/or infotainment SoC 1530, for example.

The machine 1500 may include a GPU(s) 1520 (e.g., discrete GPU(s), or dGPU(s)), that may be coupled to the SoC(s) 1504 via a high-speed interconnect (e.g., NVIDIA's NVLink). The GPU(s) 1520 may provide additional artificial intelligence functionality, such as by executing redundant and/or different neural networks, and may be used to train and/or update neural networks based on input (e.g., sensor data) from sensors of the machine 1500.

The machine 1500 may further include the network interface 1524 which may include one or more wireless antennas 1526 and/or modems (e.g., one or more wireless antennas for different communication protocols, such as a cellular antenna, a Bluetooth antenna, etc.). The network interface 1524 may be used to enable wireless connectivity over the Internet with the cloud (e.g., with the server(s) 1578 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the machine 1500 information about vehicles in proximity to the machine 1500 (e.g., vehicles in front of, on the side of, and/or behind the machine 1500). This functionality may be part of a cooperative adaptive cruise control functionality of the machine 1500.

The network interface 1524 may include a SoC that provides modulation and demodulation functionality and enables the controller(s) 1536 to communicate over wireless networks. The network interface 1524 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. For example, the network interface 1524 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”), fifth generation of mobile communications technology (5G), sixth generation of mobile communications technology (6G), and/or other cellular and/or wireless communication standards. The wireless antenna(s) 1526 may also enable communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

The machine 1500 may further include data store(s) 1528 which may include off-chip (e.g., off the SoC(s) 1504) storage. The data store(s) 1528 may include one or more storage elements including RAM, SRAM, DRAM, VRAM, Flash, hard disks, and/or other components and/or devices that may store at least one bit of data.

The machine 1500 may further include GNSS sensor(s) 1558. The GNSS sensor(s) 1558 (e.g., GPS, assisted GPS sensors, differential GPS (DGPS) sensors, etc.), to assist in mapping, perception, occupancy grid generation, and/or path planning functions. Any number of GNSS sensor(s) 1558 may be used, including, for example and without limitation, a GPS using a USB connector with an Ethernet to Serial (RS-232) bridge.

The machine 1500 may further include IMU sensor(s) 1566. The IMU sensor(s) 1566 may be located at a center of the rear axle of the machine 1500, in some examples. The IMU sensor(s) 1566 may include, for example and without limitation, an accelerometer(s), a magnetometer(s), a gyroscope(s), a magnetic compass(es), and/or other sensor types. In some examples, such as in six-axis applications, the IMU sensor(s) 1566 may include accelerometers and gyroscopes, while in nine-axis applications, the IMU sensor(s) 1566 may include accelerometers, gyroscopes, and magnetometers.

In some embodiments, the IMU sensor(s) 1566 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 1566 may enable the machine 1500 to estimate heading without requiring input from a magnetic sensor by directly observing and correlating the changes in velocity from GPS to the IMU sensor(s) 1566. In some examples, the IMU sensor(s) 1566 and the GNSS sensor(s) 1558 may be combined in a single integrated unit.

The vehicle may include one or more microphone 1596 placed in and/or around the machine 1500. The microphone(s) 1596 may be used for emergency vehicle detection and identification, among other things.

The machine 1500 may further include vibration sensor(s) 1542. The vibration sensor(s) 1542 may measure vibrations of components of the machine, such as the arms or legs of a humanoid robot 1500C, or the axle(s) of a vehicle 1500A or AMR 1500B. For example, changes in vibrations may indicate a change in road, walking, or traversable surfaces. In another example, when two or more vibration sensors 1542 are used, the differences between the vibrations may be used to determine friction or slippage of the surface (e.g., when the difference in vibration is between a power-driven axle and a freely rotating axle).

The machine 1500 may include an ADAS system 1538—such as when the machine 1500 is a vehicle 1500A. The ADAS system 1538 may include a dedicated SoC(s), in some examples. The ADAS system 1538 may include autonomous/adaptive/automatic cruise control (ACC), cooperative adaptive cruise control (CACC), forward crash or collision warning (FCW), automatic emergency braking (AEB), lane departure warning (LDW), lane keep assist (LKA), blind spot warning (BSW), blind spot monitoring (BSM), rear cross-traffic warning (RCTW), pedestrian detection, driver monitoring, collision warning systems (CWS), traffic sign recognition, speed limit detection, automatic parking, lane centering (LC), high beam safety system, and/or other features and functionality.

The machine 1500 may further include the infotainment SoC 1530 (e.g., an in-vehicle infotainment system (IVI)). Although illustrated and described as a SoC, the infotainment system may not be an SoC, and may include one or more discrete components, such as multi-chip modules (MCMs), application-specific integrated circuits (ASICs), system-in-packages (SiPs), heterogeneous integration (HI), single-board computers (SBCs), etc. The infotainment SoC 1530 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., wireless, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the machine 1500. For example, the infotainment SoC 1530 may radios, disk players, navigation systems, video players, USB and Bluetooth connectivity, carputers, in-car entertainment, Wi-Fi, steering wheel audio controls, hands free voice control, a heads-up display (HUD), an HMI display 1534, a telematics device, a control panel (e.g., for controlling and/or interacting with various components, features, and/or systems), and/or other components. The infotainment SoC 1530 may further be used to provide information (e.g., visual and/or audible) to a user(s) of the vehicle, such as information from the ADAS system 1538, autonomous driving information such as planned vehicle maneuvers, trajectories, surrounding environment information (e.g., intersection information, vehicle information, road information, etc.), and/or other information.

The infotainment SoC 1530 may include GPU functionality. The infotainment SoC 1530 may communicate over the bus 1502 (e.g., CAN bus, Ethernet, etc.) with other devices, systems, and/or components of the machine 1500. In some examples, the infotainment SoC 1530 may be coupled to a supervisory MCU such that the GPU of the infotainment system may perform some self-driving functions in the event that the primary controller(s) 1536 (e.g., the primary and/or backup computers of the machine 1500) fail. In such an example, the infotainment SoC 1530 may put the machine 1500 into a chauffeur to safe stop mode, as described herein.

In some embodiments, the infotainment system may provide a digital or virtual assistant, that may be voice only, or may have a visual component (e.g., in the form of a digital human or digital avatar). The assistant may provide basic functions, like texting, adjusting vehicle settings, music or video control, navigation features, etc., and/or may provide more advanced features such as those supported by one or more language models—such as large language models (LLMs), vision language models (VLMs), multi-modal language models (MMLMs), etc. For example, the driver and/or occupants may be able to interact with the assistant similar to how a user may interact with a language model, such as to ask general questions, specific questions, to request restaurant, gas station, and/or other recommendations and/or locations, to learn about the vehicle functionality or troubleshooting (e.g., to ask tire pressure information, oil change information, battery exchange information, etc.). As such, the machine 1500—whether a vehicle 1500A, AMR 1500B, humanoid robot 1500C, and/or other type of machine—may include a locally stored language model(s) and/or communicate to a remotely hosted language model (e.g., via one or more APIs) to provide more detailed and in-depth communication features to the users of the machine(s) 1500.

In some examples, an infotainment SoC 1530, the SoC(s) 104, and/or another SoC or computing/processing system may perform in-cabin driver and/or occupant monitoring. For example, the computing system may perform facial recognition and vehicle owner identification may use data from camera and/or other sensors to identify the presence of an authorized driver and/or owner of the machine 1500. The always on sensor processing engine may be used to unlock the vehicle when the owner approaches the driver door and turn on the lights, and, in security mode, to disable the vehicle when the owner leaves the vehicle. In this way, the SoC(s) 1504 provide for security against theft and/or carjacking.

In some embodiments, an in-cabin monitoring camera sensor may be monitored using one or more neural networks running on another or dedicated SoC—such as an in-vehicle infotainment or in-vehicle monitoring SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. The in-cabin system may further include one or more in-cabin AI agents or assistants, which may use one or more APIs or plug-ins to interact with one or more LLMs, VLMs, MMLMs, etc. in the cloud. For example, the in-cabin AI agents or assistants may provide directions, vehicle or machine feedback information, answer general questions, handle music/video and/or other requests, activate windows, doors, and/or other vehicle components, etc. As such, one or more dedicated SoCs and/or sets of processors may be used to perform the in-cabin infotainment and/or in-cabin monitoring (e.g., as an occupant monitoring system (OMS)) for the machine 1500.

The machine 1500 may further include an instrument cluster 1532 (e.g., a digital dash, an electronic instrument cluster, a digital instrument panel, etc.). The instrument cluster 1532 may include a controller and/or supercomputer (e.g., a discrete controller or supercomputer). The instrument cluster 1532 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 1530 and the instrument cluster 1532. In other words, the instrument cluster 1532 may be included as part of the infotainment SoC 1530, or vice versa.

FIG. 15D is a block diagram of an example architecture of a computing system (a subset of the system described with respect to FIG. 15C), in accordance with at least some embodiments of the present disclosure. Although illustrated as an SoC(s) 1504, this is not intended to be limiting, and the computing system may additionally or instead include multi-chip modules (MCMs), application-specific integrated circuits (ASICs), system-in-packages (SiPs), heterogeneous integration (HI), single-board computers (SBCs), and/or other components and/or architectures, without departing from the scope of the present disclosure.

The SoC(s) 1504 may be an end-to-end platform with a flexible architecture that spans automation levels 2-5, or the SoC(s) 1504 may be specifically designed for a specific automation level (e.g., a first SoC 1504 for level 2 to level 2++, a second SoC 1504 for level 3, a third SoC 1504 for level 4, etc.), thereby providing a comprehensive functional safety architecture that leverages and makes efficient use of computer vision, neural network inferencing, robotic planning, control, and navigation, ADAS techniques, and the like, with diversity and redundancy, to provide a platform for a flexible, reliable driving or robotic control software stack, along with deep learning tools. The SoC(s) 1504 may be faster, more reliable, and even more energy-efficient and space-efficient than conventional systems. For example, the accelerator(s) 1514, when combined with the CPU(s) 1506, the GPU(s) 1508, and the data store(s) 1516, may provide for a fast, efficient platform for level 2-5 autonomous vehicles as well as for safe planning, navigation, and control of AMRs 1500B, humanoid robots 1500C, and/or other robot or machine types.

In some embodiments, such as where the SoC(s) 1504 include a GPU 1508 with 2000 or more cores (e.g., 2048 cores), 60 or more tensor cores (e.g., 64 tensor cores), and a GPU max frequency of over 1 GHz (e.g., 1.3 GHz), a CPU 1506 including 10 or more cores (e.g., 12 cores), with 64 bits, 3 MB L2 and 6 MB L3 cache memory, and a max frequency of 2 or more GHz (e.g., 2.2 GHz), one or more deep learning accelerators (DLAs), deep learning accelerator clusters (XNNs), neural network accelerators (NNAs), or neural processing units (NPUs) 1509 (e.g., 2 DLAs/XNNs/NNAs/NPUs 1509), and a vision accelerator—such as a programmable vision accelerator (PVA) 1507, a single SoC 1504) may be capable of 275 tera operations per second (TOPS) of AI performance. For example, NVIDIA's Jetson AGX Orin 64 GB SoC satisfies these criteria, and achieves this performance.

Similarly, in embodiments where the SoC(s) 1504 include a GPU 1508 with 1700 or more cores (e.g., 1792 cores), 50 or more tensor cores (e.g., 56 tensor cores), and a GPU max frequency of over 900 MHz (e.g., 930 MHz), a CPU 1506 including 8 or more cores (e.g., 8 cores), with 64 bits, 2 MB L2 and 4 MB L3 cache memory, and a max frequency of 2 or more GHz (e.g., 2.2 GHz), one or more deep learning accelerators (DLAs), deep learning accelerator clusters (XNNs), neural network accelerators (NNAs), or neural processing units (NPUs) 1509 (e.g., 2 DLAs/XNNs/NNAs/NPUs 1509), and a vision accelerator—such as a programmable vision accelerator (PVA) 1507, a single SoC 1504) may be capable of 200 tera operations per second (TOPS) of AI performance. For example, NVIDIA's Jetson AGX Orin 32 GB SoC satisfies these criteria, and achieves this performance.

In some embodiments, such as where the SoC(s) 1504 include a GPU 1508 with 1000 or more cores (e.g., 1024 cores), 28 or more tensor cores (e.g., 32 tensor cores), and a GPU max frequency of over 900 MHz (e.g., 1173 MHz), a CPU 1506 including 8 or more cores (e.g., 8 cores), with 64 bits, 2 MB L2 and 4 MB L3 cache memory, and a max frequency of 2 or more GHz (e.g., 2 GHz), one or more deep learning accelerators (DLAs), deep learning accelerator clusters (XNNs), neural network accelerators (NNAs), or neural processing units (NPUs) 1509 (e.g., 1 DLA/XNN/NNA/NPU 1509), and a vision accelerator—such as a programmable vision accelerator (PVA) 1507, a single SoC 1504) may be capable of 157 tera operations per second (TOPS) of AI performance. For example, NVIDIA's Jetson AGX Orin NX 16 GB SoC satisfies these criteria, and achieves this performance.

In various embodiments, such as where the SoC(s) 1504 include a GPU 1508 with 1000 or more cores (e.g., 1024 cores), 28 or more tensor cores (e.g., 32 tensor cores), and a GPU max frequency of over 900 MHz (e.g., 1020 MHz), a CPU 1506 including 6 or more cores (e.g., 6 cores), with 64 bits, 1.5 MB L2 and 4 MB L3 cache memory, and a max frequency of 1.5 or more GHz (e.g., 1.7 GHz), a single SoC 1504) may be capable of 67 tera operations per second (TOPS) of AI performance. For example, NVIDIA's Jetson Orin Nano 8 GB SoC satisfies these criteria, and achieves this performance.

The SoC(s) 1504 may include one or more CPUs 1506. The CPU(s) 1506 may include a CPU cluster or CPU complex (alternatively referred to herein as a “CCPLEX”), in embodiments. The CPU(s) 1506 may include multiple cores and/or (e.g., L2, L3) caches. For example, in some embodiments, the CPU(s) 1506 may include twelve cores in a coherent multi-processor configuration. In some embodiments, the CPU(s) 1506 may include four dual-core clusters where each cluster has a dedicated L2 cache (e.g., a 3 MB L2 cache). The CPU(s) 1506 (e.g., the CCPLEX) may be configured to support simultaneous cluster operation enabling any combination of the clusters of the CPU(s) 1506 to be active at any given time.

The SoC(s) 1504 may include any type and number of GPUs 1508. For example, an integrated GPU(s) (alternatively referred to herein as an “iGPU(s)”) may be used in some embodiments. The GPU(s) 1508 may be programmable and may be efficient for parallel workloads. The GPU(s) 1508, in some examples, may use an enhanced tensor instruction set. The GPU(s) 1508 may include one or more streaming microprocessors, where each streaming microprocessor may include a cache (e.g., an L1 cache with at least 96 KB storage capacity), and two or more of the streaming microprocessors may share an L2 cache (e.g., an L2 cache with a 512 KB storage capacity). In some embodiments, the GPU(s) 1508 may include at least eight streaming microprocessors. The GPU(s) 1508 may use compute application programming interface(s) (API(s)). In addition, the GPU(s) 1508 may use one or more parallel computing platforms and/or programming models (e.g., NVIDIA's CUDA).

The GPU(s) 1508 may be power-optimized for best performance in automotive, robotics, and/or other embedded use cases. For example, the GPU(s) 1508 may be fabricated on a Fin field-effect transistor (FinFET). However, this is not intended to be limiting and the GPU(s) 1508 may be fabricated using other semiconductor manufacturing or fabrication processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an (e.g., L0) instruction cache, a warp scheduler, a dispatch unit, and/or a (e.g., 64 KB) register file. In addition, the streaming microprocessors may include independent parallel integer and floating-point data paths to provide for efficient execution of workloads with a mix of computation and addressing calculations. The streaming microprocessors may include independent thread scheduling capability to enable finer-grain synchronization and cooperation between parallel threads. The streaming microprocessors may include a combined L1 data cache and shared memory unit in order to improve performance while simplifying programming.

The GPU(s) 1508 may include a high bandwidth memory (HBM) and/or a (e.g., 16 GB) HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 1508 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 1508 to access the CPU(s) 1506 page tables directly. In such examples, when the GPU(s) 1508 memory management unit (MMU) experiences a miss, an address translation request may be transmitted to the CPU(s) 1506. In response, the CPU(s) 1506 may look in its page tables for the virtual-to-physical mapping for the address and transmits the translation back to the GPU(s) 1508. As such, unified memory technology may allow a single unified virtual address space for memory of both the CPU(s) 1506 and the GPU(s) 1508, thereby simplifying the GPU(s) 1508 programming and porting of applications to the GPU(s) 1508.

The SoC(s) 1504 may include any number of cache(s) 1512, including those described herein. For example, the cache(s) 1512 may include L0 caches, L1 caches, L2 caches, L3 caches (e.g., that are available to both the CPU(s) 1506 and the GPU(s) 1508 (e.g., that is connected both the CPU(s) 1506 and the GPU(s) 1508)), etc. The cache(s) 1512 may include a write-back cache that may keep track of states of lines, such as by using one or more cache coherence protocol (e.g., MEI, MESI, MSI, etc.). The (e.g., L3) cache may include 4 MB or more, depending on the embodiment, although smaller or larger cache sizes may be used.

The SoC(s) 1504 may include one or more arithmetic logic units (ALUs) 1565 which may be leveraged in performing processing with respect to any of the variety of tasks or operations of the machine 1500—such as computer vision, machine learning or deep learning processing, world model management, etc. In addition, the SoC(s) 1504 may include a floating point unit(s) (FPU(s)) 1567—or other math coprocessor or numeric coprocessor types—for performing mathematical operations within the system. For example, the SoC(s) 104 may include one or more FPUs 1567 integrated as execution units within a CPU(s) 1506 and/or GPU(s) 1508.

The SoC(s) 1504 may include one or more accelerators 1514 (e.g., hardware accelerators, software accelerators, or a combination thereof). For example, the SoC(s) 1504 may include a hardware acceleration cluster that may include optimized hardware accelerators and/or large on-chip memory. The large on-chip memory 1515 (e.g., 4 MB of SRAM, 32 GB and/or 64 GB 256-bit LPDDR5 at 204.8 GB/s, 8 GB and/or 16 GB 128-bit LPDDR5 at 102.4 GB/s, and/or other memory types and sizes), may enable the hardware acceleration cluster to accelerate neural network processing, transformer processing, optical flow processing, vision processing, and/or other calculations or processing. The hardware acceleration cluster may be used to complement the GPU(s) 1508 and to off-load some of the tasks of the GPU(s) 1508 (e.g., to free up more cycles of the GPU(s) 1508 for performing other tasks). As an example, the accelerator(s) 1514 may be used for targeted workloads (e.g., perception, convolutional neural networks (CNNs), deep neural networks (DNNs), language models (LLMs, VLMs, MMLMs, VLAs, etc.), transformer models, diffusion models, encoder-only models, encoder-decoder models, etc. that are stable enough to be amenable to acceleration.

The accelerator(s) 1514 (e.g., the hardware acceleration cluster) may include a deep learning accelerator(s) (DLA) 1509 (alternatively referred to herein as “a deep learning accelerator cluster (XNN) 1509,” “neural network accelerator (NNA) 1509,” or “neural processing unit (NPU) 1509”). The DLA(s) 1509 may include one or more Tensor processing units (TPUs) 1541 that may be configured to provide an additional, e.g., ten trillion operations per second for deep learning applications and inferencing. The TPUs 1541 may be accelerators configured to, and optimized for, performing image processing functions (e.g., for CNNs, RCNNs, DNNs, etc.). The DLA(s) 1509 may further be optimized for a specific set of neural network types and floating point operations, as well as inferencing. The design of the DLA(s) may provide more performance per millimeter than a general-purpose GPU, and vastly exceeds the performance of a CPU. The TPU(s) 1541 may perform several functions, including a single-instance convolution function, supporting, for example, INT8, INT16, and FP16 data types for both features and weights, as well as post-processor functions. Although the TPU(s) 1541 are described as being included as part of the DLA(s) 1509, this is not intended to be limiting, and the TPU(s) 1541 may be included in additional or alternative accelerator(s) 1514 and/or other components, and/or may be included as a discrete processing component(s).

The DLA(s) 1509 may quickly and efficiently execute neural networks on processed or unprocessed data for any of a variety of functions, including, for example and without limitation: for object and feature identification and detection (e.g., vehicles, pedestrians, other robots, lane lines, road boundary lines, debris, potholes, boxes, warehouse items, etc.) using data from one or more sensor modalities; for distance estimation using data from one or more sensor modalities; for emergency vehicle detection and identification and detection using data from microphones and/or vision-based sensors; for facial recognition; for pick and place operations; for manipulation operations; for occupant monitoring; for vehicle owner identification; and/or other in-cabin operations using data from in-cabin cameras and/or other sensor types; and/or a for security and/or safety related events, to name a few.

The DLA(s) 1509 may perform any function of the GPU(s) 1508, and by using an inference accelerator, for example, a designer may target either the DLA(s) 1509 or the GPU(s) 1508 for any function. For example, the designer may focus processing of DNNs and floating point operations on the DLA(s) 1509 and leave other functions to the GPU(s) 1508 and/or other accelerator(s) 1514. The DLA(s) 1509 may be used to run any type of network to enhance control and safety, including for example, a neural network that outputs a measure of confidence for each object detection.

The accelerator(s) 1514 (e.g., the hardware acceleration cluster) may include a programmable vision accelerator(s) (PVA) 1507, which may alternatively be referred to herein as a computer vision accelerator or generally a vision accelerator. The PVA(s) 1507 may be designed and configured to accelerate computer vision algorithms for the advanced driver assistance systems (ADAS), semi-autonomous driving, autonomous driving, robotics applications, security and surveillance applications, augmented reality (AR), virtual reality (VR), and/or mixed reality (MR) applications, etc. The PVA(s) 1507 may provide a balance between performance and flexibility. For example, each PVA(s) 1507 may include, for example and without limitation, any number of reduced instruction set computer (RISC) cores, direct memory access (DMA) systems, pixel processing engines (PPEs), vector processors or vector processing units (VPUs), and/or other components. The PVA engine may include an advanced very long instruction word (VLIW), single instruction multiple data (SIMD) digital signal processor. The PVA(s) 1507 may be optimized for the tasks of image processing and computer vision algorithm acceleration. For example, the PVA(s) 1507 provides excellent performance with extremely low power consumption, and can be used asynchronously and concurrently with the CPU(s) 1506, GPU(s) 1508, and/or other accelerators in the system (e.g., vehicle, robot, etc.) as part of a heterogeneous compute pipeline.

The PVA(s) 1507 may include one or more (e.g., two) vector processing subsystems (VPS), where each VPS may include one or more vector processing unit (VPU) cores, one or more decoupled look-up units (DLUTs), one or more shared or vector memories (VMEMs), and one or more instruction caches (I-caches). The VPU core(s) may be the main processing unit, and may include a vector SIMD VLIW DSP 1543 optimized for computer vision. The VPU core(s) may fetch instructions through the I-cache(s), and may access data through the VMEM(s). The DLUT(s) may include a specialized hardware component that enhances the efficiency of parallel lookup operations. For example, the DLUT(s) allow parallel lookups using a single copy of the lookup table by executing these lookups in a decoupled pipeline, independent of the primary processor pipeline. By doing so, the DLUT(s) minimize or reduce memory usage and enhance throughput while avoiding data-dependent memory bank conflicts—ultimately leading to improved overall system performance. The VPU VMEM(s) may provide local data storage for the VPU, allowing efficient implementation of various image processing and computer vision algorithms. The VPU VMEM(s) may support access from outside-VPS hosts such as direct memory access (DMA) and the CPU(s) 1506 (e.g., ARM Cortex-R5 processor), facilitating data exchange with the CPU(s) 1506 and other system-level components. The VPU I-cache may supply instruction data to the VPU(s) when requested, may request missing instruction data from system memory, and/or may maintain temporary instruction storage for the VPU. For each VPU task, the CPU(s) 1506 may configures the DMA system, optionally prefetch the VPU program into VPU I-cache, and/or kick off each VPU-DMA pair to process a task. The PVA(s) 1507 may also include an L2 SRAM memory to be shared between the one or more (e.g., two) sets of VPS and DMA. In some embodiments, one or more (e.g., two) DMA devices are used to move data among external memory, PVA L2 memory, the VMEMs (e.g., one in each VPS), CPU(s) tightly coupled memory (TCM), DMA descriptor memory, and/or PVA-level config registers. In a lightly loaded system, two parallel DMA accesses to DRAM can achieve a read/write bandwidth of up to 15 GB/s each and, in a heavily loaded system, this bandwidth can reach up to 10 GB/s each. With respect to compute compacity, the INT8 Giga Multiply-Accumulate Operations per Second (GMACs) may be 2048 or greater, excluding the DLUT. The FP32 GMACs may include 32 per PVA instance.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA system may enable components of the PVA(s) 1507 to access the system memory independently of the CPU(s) 1506. The DMA may support any number of features used to provide optimization to the PVA(s) 1507 including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors or VPUs may be programmable processors that may be designed to efficiently and flexibly execute programming for computer vision algorithms and provide signal processing capabilities. In some examples, the PVA(s) 1507 may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA(s) 1507, and may include one or more vector processing units (VPUs), one or more pixel processing engines (PPEs)—which may include a 2D layout of interconnected (e.g., for north, south, east, west intercommunication) processing elements, one or more instruction caches, and/or one or more shared or vector memories (e.g., VMEMs). A VPU core may include a digital signal processor such as, for example, a single instruction, multiple data (SIMD), very long instruction word (VLIW) digital signal processor. The combination of the SIMD and VLIW may enhance throughput and speed.

In some embodiments, each of the vector processors may include an instruction cache and may be coupled to dedicated memory. As a result, in some examples, each of the vector processors may be configured to execute independently of the other vector processors. In other examples, the vector processors that are included in a particular PVA(s) 1507 may be configured to employ data parallelism. For example, in some embodiments, the plurality of vector processors included in a single PVA(s) 1507 may execute the same computer vision algorithm, but on different regions of an image. In other examples, the vector processors included in a particular PVA(s) 1507 may simultaneously execute different computer vision algorithms, on the same image, or even execute different algorithms on sequential images or portions of an image. Among other things, any number of PVAs 1507 may be included in the hardware acceleration cluster and any number of vector processors may be included in each of the PVAs. In addition, the PVA(s) 1507 may include additional error correcting code (ECC) memory, to enhance overall system safety.

The accelerator(s) 1514 (e.g., the hardware accelerator cluster) have a wide array of uses for autonomous and semi-autonomous machine control. The PVA(s) 1507 may be a programmable vision accelerator that may be used for key processing stages in perception, robotics understanding and reasoning, ADAS, semi-autonomous, and autonomous vehicles, etc. The PVA's 1507 capabilities are a good match for algorithmic domains needing predictable processing, at low power and low latency. In other words, the PVA(s) 1507 performs well on semi-dense or dense regular computation, even on small data sets, which need predictable run-times with low latency and low power. Thus, in the context of platforms for autonomous vehicles and robotics, the PVAs 1507 are designed to run classic computer vision algorithms, as they are efficient at object detection and operating on integer math.

For example, according to one embodiment of the technology, the PVA 1507 is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA(s) 1507 may perform computer stereo vision function on inputs from two monocular cameras.

In some examples, the PVA(s) 1507 may be used to perform dense optical flow. According to process raw RADAR data (e.g., using a 4D Fast Fourier Transform) to provide Processed RADAR. In other examples, the PVA(s) 1507 is used for time-of-flight depth processing, by processing raw time of flight data to provide processed time of flight data, for example.

Although the VPU(s), DMA(s), RISC Core(s), VMEM(s), and decoupled co-processors (e.g., the DLUT(s)) are described as being included within the PVA(s) 1507, this is not intended to be limiting. In some embodiments, these components may be included in alternative or additional processing components and/or accelerator(s) 1514, and/or may be included as discrete components of the SoC(s) 1504 and/or other computing system architecture(s).

In some examples, the SoC(s) 1504 may include a real-time ray-tracing hardware accelerator (RTA) 1551 that may be used to quickly and efficiently determine the positions and extents of objects (e.g., within a world model), to generate real-time or near-real time visualization simulations, for RADAR signal interpretation, for sound propagation synthesis and/or analysis, for simulation of SONAR, RADAR, LiDAR, camera, and/or other sensor modalities within a simulation, for general wave propagation simulation, for comparison to LiDAR data for purposes of localization, to generate realistic training data for training neural networks, and/or other functions and uses. In some embodiments, one or more tree traversal units (TTUs) may be used for executing one or more ray-tracing related operations. For example, the machine 1500 (or another machine or device) may be simulated within a simulation environment, and the simulation environment may be generated using one or more light transport simulation algorithms (e.g., ray-tracing, path-tracing, etc.). These ray-tracing algorithms may thus be accelerated using a ray-tracing accelerator 1551 and/or a ray-tracing optimized GPU 1506—such as NVIDIA's RTX GPU.

The accelerator(s) 1514 (e.g., in the hardware acceleration cluster) may include one or more optical flow accelerators (OFAs) 1511. For example, the OFA(s) 1511 may be used for computing optical flow and stereo disparity between frames of sensor data (e.g., images). Optical flow may be accelerated on the OFA(s) 1511 for uses such as object detection and tracking, and/or for stereo depth estimation where used for computing stereo disparity between stereo image frames (e.g., two or more frames captured using two or more image sensors with at least partially overlapping fields of view).

The SoC(s) 1504 may include one or more camera serial interfaces (CSIs) 1523. For example, the CSI(s) 1523 may include a mobile industry processor interface (MIPI) camera serial interface (CSI) for receiving video and input from cameras, a high-speed interface, and/or a video input block that may be used for camera and related pixel input functions. The SoC(s) 1504 may further include an input/output controller(s) that may be controlled by software and may be used for receiving I/O signals that are uncommitted to a specific role. For example, the CSI 1523 may include a MIPI CSI-2 connector—e.g., a 16 lane MIPI CSI-2 connector, D-PHY 2.1 (up to 40 Gbps), and C-PHY 2.0 (up to 164 Gbps) for supporting 16 virtual channels and six or more cameras, an 8 lane MIPI CSI-2 connector, D-PHY 2.1 (up to 20 Gbps for supporting 8 virtual channels and 4 or more cameras, and/or a 2×MIPI CSI-2, 22 pin camera connector, depending on the embodiment and implementation.

The accelerator(s) 1514 (e.g., the hardware acceleration cluster) may include a computer vision network on-chip (CVNOC) 1563 and SRAM, for providing a high-bandwidth, low latency SRAM for the accelerator(s) 1514. In some examples, the on-chip memory may include at least 4 MB SRAM, consisting of, for example and without limitation, eight field-configurable memory blocks, that may be accessible by the PVA 1507, OFA 1511, DLA 1509, and/or other accelerator(s) 1514. Each pair of memory blocks may include an advanced peripheral bus (APB) interface, configuration circuitry, a controller, and a multiplexer. Any type of memory 1515 may be used. The PVA 1507, OFA 1511, DLA 1509, and/or other accelerator(s) 1514 may access the memory via a backbone that provides the accelerator(s) 1514 with high-speed access to memory. The backbone may include a computer vision network on-chip that interconnects the accelerator(s) 1514 to the memory (e.g., using the APB).

The CVNOC 1563 may include an interface that determines, before transmission of any control signal/address/data, that the accelerator(s) 1514 provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

The SoC(s) 1504 may include data store(s) 1516 and/or memory 1515. The data store(s) 1516 may be on-chip memory 1515 of the SoC(s) 1504, which may store neural networks and/or other algorithms to be executed on the CPU(s) 1506, the GPU(s) 1508, and/or one or more of the accelerator(s) 1514. In some examples, the data store(s) 1516 may be large enough in capacity to store multiple instances of neural networks for redundancy and safety. The data store(s) 1512 may comprise L2 and/or L3 cache(s) 1512, for example. The memory(ies) 1515 may include SRAM, LPDDR5, and/or other memory types. For example, the memory(ies) 1515 may include 4 MB of SRAM, 32 GB and/or 64 GB 256-bit LPDDR5 at 204.8 GB/s, 8 GB and/or 16 GB 128-bit LPDDR5 at 102.4 GB/s, and/or other memory types and sizes. Reference to the data store(s) 1516 may include reference to the memory associated with the PVA 1507, OFA 1511, DLA 1509, and/or other accelerator(s) 1514, as described herein.

The data store(s) 116 may include various storage types, such as eMMC, NVMe, etc. For example, the SoC(s) 1504 may include storage in the form of an embedded multimedia card (eMMC) (e.g., 64 GB eMMC 5.1) and/or an SD card slot, with external NVM express (NVMe) capability, e.g., via M.2 Key M. For example, the data store(s) 1516 and/or other storage may be accessed via, e.g., NVMe, using PCI Express (PCIe), RDMA, TCP, and/or other protocols.

The SoC(s) 1504 may include one or more processor(s) 1510 (e.g., embedded processors). The processor(s) 1510 may include a boot and power management processor (BPMP) 1553, that may be a dedicated processor and subsystem to handle boot power and management functions and related security enforcement. The BPMP 1553 may be a part of the SoC(s) 1504 boot sequence and may provide runtime power management services. The BPMP 1553 may provide clock and voltage programming, assistance in system low power state transitions, management of SoC(s) 1504 thermals and temperature sensors, and/or management of the SoC(s) 1504 power states. Each temperature sensor may be implemented as a ring-oscillator whose output frequency is proportional to temperature, and the SoC(s) 1504 may use the ring-oscillators to detect temperatures of the CPU(s) 1506, GPU(s) 1508, accelerator(s) 1514, and/or other components. If temperatures are determined to exceed a threshold, BPMP 1553 may enter a temperature fault routine and put the SoC(s) 1504 into a lower power state and/or put the machine 1500 into a chauffeur to safe stop mode (e.g., bring the machine 1500 to a safe stop).

The processor(s) 1510 may further include a set of embedded processors that may serve as an audio processing engine (APE) 1555. The APE 1555 may be an audio subsystem that enables full hardware support for multi-channel audio over multiple interfaces, and a broad and flexible range of audio I/O interfaces. In some examples, the APE 1555 is a dedicated processor core with a digital signal processor with dedicated RAM.

The processor(s) 1510 may further include an always on processor engine (AOPE) 1557 that may provide necessary hardware features to support low power sensor management and wake use cases. The AOPE 1557 may include a processor core, a tightly coupled RAM, supporting peripherals (e.g., timers and interrupt controllers), various I/O controller peripherals, and routing logic.

The processor(s) 1510 may further include a safety processor(s) 1513 (alternatively referred to as “safety island 1513”), which may include a safety cluster engine that includes a dedicated processor or processor subsystem to handle safety management for automotive, robotics, and/or other applications. The safety processor(s) 1513—and/or safety cluster engine—may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations. In some embodiments, the safety processor(s) 1513 may include a discrete processor(s), such that fault of other system components may not impact the performance and availability of the safety processor 1513.

The processor(s) 1510 may further include a real-time or near real-time sensor engine (SE) 1559 that may include a dedicated processor subsystem for handling real-time or near real-time camera, LiDAR, RADAR, and/or other sensor modality management.

The processor(s) 1510 may further include one or more image signal processors (ISPs) 1527, which may include a high-dynamic range signal processor and/or a hardware engine that is part of one or more sensor processing pipelines.

The processor(s) 1510 may include a video image compositor (VIC) 1561 that may be a processing block (e.g., implemented on a microprocessor) that implements video post-processing functions needed by a video playback application to produce the final image for the player window. The VIC 1561 may perform lens distortion correction on wide-view camera(s) 1568B, surround camera(s) 1568D, in-cabin monitoring camera sensors, and/or other camera sensors with distorted fields of view.

A VIC 1561 may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

A VIC 1561 may also be configured to perform stereo rectification on input stereo lens frames. The video image compositor may further be used for user interface composition when the operating system desktop is in use, and the GPU(s) 1508 is not required to continuously render new surfaces. Even when the GPU(s) 1508 is powered on and active doing 3D rendering, the video image compositor may be used to offload the GPU(s) 1508 to improve performance and responsiveness.

The SoC(s) 1504 may further include a broad range of peripheral interfaces for input/output (I/O) 1525, such as to enable communication with peripherals, audio codecs, power management, and/or other devices. The SoC(s) 1504 may be used to process data from cameras (e.g., connected over Gigabit Multimedia Serial Link and/or Ethernet), sensors (e.g., LiDAR sensor(s) 1564, RADAR sensor(s) 1560, etc. that may be connected over Ethernet), data from bus 1502 (e.g., speed of machine 1500, steering wheel position, etc.), data from GNSS sensor(s) 1558 (e.g., connected over Ethernet or CAN bus). The SoC(s) 1504 may further include dedicated high-performance mass storage controllers that may include their own DMA engines, and that may be used to free the CPU(s) 1506 from routine data management tasks. In some embodiments, the SoC(s) 1504 I/O 1525 may include a header (e.g., a 40 pin header, or 40 pin expansion header) with support for universal asynchronous receiver/transmitter (UART), serial peripheral interface (SPI), inter-integrated circuit sound (I²S), inter-integrated circuit (I2C), controller area network (CAN), pulse width modulation (PWM), digital microphone interface (DMIC), digital speaker station (DSPK), general purpose I/O (GPIO), etc., an automation header (e.g., 12 pin automation header), an audio panel header (e.g., a 10 pin audio panel header), a joint test action group (JTAG) header (e.g., a 10 pin JTAG header), a fan header (e.g., a 4 pin fan header), an RTC battery backup connector (e.g., a 2 pin battery backup connector), a microSD slot, a DC power jack, power, force, recovery, and reset buttons, one or more display connectors (e.g., DisplayPort (DP), such as a DP 1.4A (+MST), an eDP 1.41, an HDMI 2.1, and/or a 4K30 multi-model DP 1.2 (+MST) connector), and/or other I/O 1525 elements, components, or features.

The SoC(s) 1504 may include in-machine networking capability using, for example, Ethernet (e.g., automotive Ethernet), SERDES, controller area network (CAN), FlexRay, local interconnect network (LIN), low voltage differential signaling (LVDS), media oriented system transport (MOST), another networking type, and/or a combination thereof. For example, the SoC(s) 1504 may include an RJ45 connector with up to 10 GbE, a 1 GbE connector, and/or other networking connector types.

The SoC(s) 104 may include one or more digital signal processors (DSPs) 1543. For example, the DSP(s) 1543 may include a dedicated or specialized microprocessor chip optimized for digital signal processing—such as in audio signal processing, telecommunications, digital image processing, RADAR, SONAR, LiDAR, and/or other sensor processing, speech recognition, and/or other applications.

The SoC(s) 1504 may include one or more video encoders 1519 and/or one or more video decoders 1521. For example, the video encoder(s) 1519 may include a hardware-based (e.g., as part of the GPU(s) 1508) video encoder (e.g., supporting H.264, H.265, etc., and being HEVC compliant, such as NVIDIA's NVENC) that may process image inputs (e.g., as YUV, RGB, etc.) to generate a video bit stream. The video decoder(s) 1521 may include a video decoder engine that may provide fully-accelerated hardware video decoding capabilities (e.g., supporting decoding of bitstreams in various formats, such as AV1, H.264, H.265, VP8, VP9, MPEG-1, MPEG-2, MPEG-4, VC-1, etc, and being HEVC compliant, such as NVIDIA's NVDEC). In some examples, the video decoder(s) 1521 may be hardware-based (e.g., as part of the GPU(s) 1508).

The SoC(s) 1504 may include one or more general compute acceleration clusters (GCAC(s)) 1529. For example, the GCAC(s) 1529 may include various processor types that may be used to accelerate compute, such as one or more vector microcode processors (VMPs) 1533, one or more multi-threaded processing clusters (MPCs) 1531, one or more programmable macro arrays (PMA(s)) 1535, and/or one or more other processor types. For example, the GCAC(s) 1529 may include a PMA 1535, two VMPs 1533, and 2 MPCs 1531.

The SoC(s) 1504 may include one or more vector microcode processors (VMPs) 1533. The VMP(s) 1533, in embodiments, may include a wide vector (very long instruction word (VLIW) and single instruction multiple data (SIMD)) machine with performing various operations, such as short integral type operations common in computer vision and deep learning algorithms.

The SoC(s) 1504 may include one or more multi-threaded processing clusters (MPCs) 1531. The MPC(s) 1531 may include a processing cluster that be, in embodiments, more versatile than a GPU, and with higher efficiency than a CPU. For example, the MPC(s) 1531 may include a multi-threaded processor that allows multiple threads to share resources and execute instructions concurrently.

The SoC(s) 1504 may include one or more programmable macro arrays (PMA(s)) 1535. The PMA(s) 1535 may include a coarse-grained reconfigurable architecture (CGRA) dataflow machine, having a unique architecture that delivers strong performance on dense computer vision and deep learning algorithms that may be unachievable in classic digital signal processing (DSP) architectures.

The SoC(s) 1504 may include one or more display processing units (DPUs) 1545 for performing hardware-accelerated image processing. For example, the DPU(s) 1545 may retrieve pixel data from memory 1515 and send it to a display peripheral through standard interfaces. As such, the DPU(s) 1545 may handle display processing and rendering for in-machine and/or on-machine displays.

The SoC(s) 1504 may include one or more application processing units (APUs) 1539. For example, the APU(s) 1539 may include a quad or dual-core processor with 48 KB/32 KB L1 cache with parity and ECC, along with a 1 MB L2 cache with ECC. The APU(s) 1539 may support NEON instructions and single and double precision floating point operations.

The SoC(s) 1504 may include one or more real-time processing units (RTPUs) 1569. The RTPU(s) 1569 may include a dual-core processor with 32 KB/32 KB L1 cache, and 256 KB TCM with ECC. The RTPU(s) 1569 may support single and double precision floating point operations.

The SoC(s) 1504 may include one or more built-in self-test (BIST) components 1537. For example, the BIST component(s) 1537 may include memory BIST (MBIST) to test memories of the system and/or logic BIST (LBIST) to test logic of the system. The BIST components 1537 may include embedded logic for directly testing logic and/or memory of the system.

The SoC(s) 1504 may include one or more dynamically reconfigurable processors (DRPs) 1571. For example, the DRP(s) 1571 may be used for accelerating various computing operations. For example, the DRP(s) 1571 may be combined, in embodiments, with a MAC unit for use as an AI accelerator. In embodiments, the DRP(s) 1571 may execute applications while dynamically switching the circuit connection configuration of the arithmetic units (e.g., ALUs) on the chip at each operating clock according to the content to be processed. Since only the necessary arithmetic circuits are used, the DRP(s) 1571 may consume less power than with CPU processing and can achieve higher speed. Furthermore, compared to CPUs, where frequent external memory accesses due to cache misses and other causes will degrade performance, the DRP(s) 1571 can build the necessary data paths in hardware ahead of time, resulting in less performance degradation and less variation in operating speed (jitter) due to memory accesses. The DRP(s) 1571 may include a dynamic loading function that switches the circuit connection information each time the algorithm changes, enabling processing with limited hardware resources, even in robotic/automotive applications that require processing of multiple algorithms.

In some embodiments, the accelerator(s) 1514 may include an OpenCV accelerator for speeding up processing of OpenCV, an open-source industry standard library for computer vision processing. In some embodiments, the combination of one or more DRP(s) 1571 deployed as an AI accelerator along with an OpenCV accelerator(s) may enhance AI computing and image processing algorithms, enabling complex and compute-heavy operations such as Visual simultaneous localization and mapping (SLAM).

In contrast to conventional systems, by providing a CPU complex, GPU complex, and a hardware acceleration cluster, the technology described herein allows for multiple neural networks to be performed simultaneously (e.g., at least partially in parallel) and/or sequentially, and for the results to be combined together to enable Level 2-5 autonomous driving functionality and/or autonomous robotics movement, control, planning, and/or navigation operations. In addition, because the SoC(s) 1504 may include various compute engines (e.g., processors 1510, CPUs 1506, GPU(s) 1508, accelerator(s) 1514, etc.), tasks may be distributed between and among the compute engines, in some instances without common cause failures due to the discrete footprint of the compute engines. Further, because the SoC(s) 1504 may include a dedicated safety processor(s) 1513 (or safety island 1513), critical safety or redundant operations may be performed without common cause failures from the main processing components or compute engines of the SoC(s) 1514. Due to these features, the SoC(s) 1504 and/or the underlying systems of the machine 1500 may be capable of satisfying higher levels of safety—such as automotive safety integrity level (ASIL) D from the ISO 26262 standard.

FIG. 15E is a system diagram for communication between a cloud-based server(s) (e.g., in a data center, such as those described herein) and the example autonomous or semi-autonomous vehicle or machine 1500 of FIG. 15A, in accordance with some embodiments of the present disclosure. The system 1576 may include a server(s) 1578, a network(s) 1590, and a machine(s) 1500. The server(s) 1578 may include a plurality of GPUs 1584(A)-1584(H) (collectively referred to herein as GPUs 1584), switches 1582(A)-1582(H) (such as PCIe 4.0/5.0/etc switches, M.2 slots, thunderbolt, USB4, NVIDIA's NVLink, NVIDIA's NVSwitch, GPUDirect RDMA, GPUDirect Storage, etc.), CPUs 1580(A)-1580(B) (collectively referred to herein as CPUs 1580), accelerators, and/or other processor types. The GPUs 1584, the CPUs 1580, and the PCIe switches may be interconnected with high-speed interconnects such as, for example and without limitation, NVLink interfaces 1588 developed by NVIDIA and/or PCIe connections 1586. In some examples, the GPUs 1584 are connected via NVLink and/or NVSwitch SoC and the GPUs 1584 and the PCIe switches 1582 are connected via PCIe interconnects. Although eight GPUs 1584, two CPUs 1580, and two PCIe switches are illustrated, this is not intended to be limiting. Depending on the embodiment, each of the server(s) 1578 may include any number of GPUs 1584, CPUs 1580, and/or PCIe switches. For example, the server(s) 1578 may each include eight, sixteen, thirty-two, and/or more GPUs 1584.

The server(s) 1578 may receive, over the network(s) 1590 and from the machine(s) 1500, sensor data indicating information about new or previously unexplored locations, and/or sensor data indicating changes to previously seen/stored locations (e.g., unexpected or changed road conditions, such as recently commenced road-work). The server(s) 1578 may transmit, over the network(s) 1590 and to the machine(s) 1500, neural networks 1592, updated neural networks 1592, map information 1594, etc., including information regarding traffic and road conditions. The updates to the map information 1594 may include updates for the HD map 1522, SD map, navigation map, etc., such as information regarding construction sites, potholes, detours, flooding, and/or other obstructions. In some examples, the neural networks 1592, the updated neural networks 1592, the map information 1594, and/or the other information may have resulted from new training and/or experiences represented in data received from any number of machine(s) 1500 in the environment, and/or based on training performed at a datacenter (e.g., using the server(s) 1578 and/or other servers).

The server(s) 1578 may be used to train machine learning models (e.g., neural networks) based on training data. The training data may be generated by the machine(s) 1500, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the machine(s) 1500 (e.g., transmitted to the machine(s) 1500 over the network(s) 1590, and/or the machine learning models may be used by the server(s) 1578 to remotely monitor and/or control the machine(s) 1500.

In some examples, the server(s) 1578 may receive data from the machine(s) 1500 and apply the data to up-to-date real-time neural networks for real-time intelligent inferencing. The server(s) 1578 may include deep-learning supercomputers and/or dedicated AI computers powered by GPU(s) 1584, such as a DGX and DGX Station machines developed by NVIDIA. However, in some examples, the server(s) 1578 may include deep learning infrastructure that use only CPU-powered datacenters.

The deep-learning infrastructure of the server(s) 1578 may be capable of fast, real-time inferencing, and may use that capability to evaluate and verify the health of the processors, software, and/or associated hardware in the machine 1500. For example, the deep-learning infrastructure may receive periodic updates from the machine 1500, such as a sequence of images and/or objects that the machine 1500 has located in that sequence of images (e.g., via computer vision and/or other machine learning object classification techniques). The deep-learning infrastructure may run its own neural network to identify the objects and compare them with the objects identified by the machine 1500 and, if the results do not match and the infrastructure concludes that the AI in the machine 1500 is malfunctioning, the server(s) 1578 may transmit a signal to the machine 1500 instructing a fail-safe computer of the machine 1500 to assume control, notify the passengers, and complete a safety maneuver or operation—such as to slow down, hand control back to a driver, come to a stop, and/or pull over/shut down.

For inferencing, the server(s) 1578 may include the GPU(s) 1584 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

### Computing Ecosystem for Generating, Training, and Deploying AI

FIG. 16 is a system diagram illustrating a three computer ecosystem 1600, including a first computing system 1602 for generating or creating artificial intelligence (AI)—such as AI training and validation data, a second computing system 1604 for training artificial intelligence, and a third computing system 1606 (which may include or correspond to the SoC(s) 1504 of FIGS. 15A-15E) deploying the AI at the edge, in accordance with at least some embodiments of the present disclosure. For example, to develop and deploy embodied or physical AI, the three computer ecosystem 1600 may be used, including three accelerated computer systems to handle physical AI training, simulation, and runtime (e.g., edge deployment). These systems may generate training data for and train multimodal foundation models (and/or other model types) using scalable, physically based simulations of the machine(s) 1500 and their worlds. By doing so, simulation of machine(s) 1500 may be performed at scale, allowing for refinement, testing, and optimization of skills (e.g., robot skills) in a virtual world (e.g., using NVIDIA's OMNIVERSE) that mimics the laws of physics—helping to reduce real-world data acquisition costs and ensuring the machine(s) 1500 can perform safely in controlled settings.

The computing system 1604 (e.g., NVIDIA's DGX Platform) may be used to train and fine-tune powerful foundation and generative AI models. Models, such as general purpose foundation models (e.g., NVIDIA's Project GROOT), may be used to enable robots and other machine(s) 1500 to understand natural language and emulate movements by observing human actions. The computing system 1604 may include a platform that incorporates software, infrastructure, and expertise in a modern, unified AI development and training solution. The computing system 1604 may include individual computing devices 1610 (e.g., NVIDIA's DGX B200, H200, etc.) and/or any number of computing devices 1610 in a data center infrastructure 1612 (e.g., NVIDIA's DGX SuperPOD).

For example, the individual computing devices 1610 may include GPUs (e.g., 8 GPUs with 1,440 GB total GPU memory) and CPUs (e.g., 2 CPUs with 112 cores total, 2.1 GHz, or 4 GHz (with boost)) that provide upwards of 72 petaFLOPS for training and 144 petaFLOPS for inference. The computing devices 1610 may include memory (e.g., 4 TB memory, and storage (e.g., OS storage of 2×1.9 TB NVMe M.2, and internal storage of 8×3.84 TB NVMe U.2). The computing devices 1610 may include various networking and network management components, such as OSFP ports (e.g., 4 OSFP ports) serving single-port smart host channel adapters (e.g., 8 single port ConnextX-7 virtual protocol interconnects (VPIs)), providing up to 400 GB/s Infiniband/Ethernet. The computing devices 1610 may further include, e.g., dual port quad small form-factor pluggable (QSFFP) data processing units (DPUs) (e.g., 2 dual-port QSFP112 DPUs—such as NVIDIA's BlueField-3 DPUs), providing up to 400 Gb/s InfiniBand/Ethernet. The computing device(s) 1610 may include an onboard network interface card (NIC) (e.g., 10 Gb/s onboard NIC with RJ45), a dual-port Ethernet NIC (e.g., 100 GB/s dual-port Ethernet NIC), and/or a host baseboard management controller (MBC) (e.g., with RJ45). In some embodiments, the NICs used for the computing device(s) 1610 may include SuperNICs (e.g., NVIDIA's ConnectX-8 SuperNIC) to provide up to 800 Gb/s of data throughput for in-network computing acceleration engines to deliver the performance and robust feature set needed to power trillion-parameter scale AI factories and scientific computing workloads. In other embodiments, the computing device(s) 1610 may include a smart host channel adapter (HCA) (e.g., NVIDIA's ConnectX-7) to provide ultra-low latency, 400 Gb/s throughput for in-network computing acceleration engines.

The data center infrastructure 1612 may include any number of the computing devices 1610, along with an operating system (OS) (e.g., DGX OS extensions for Linux distributions) to maximize system uptime, security, and reliability, network/storage acceleration libraries and management to accelerate end-to-end infrastructure performance, cluster management to scale and manage one node (e.g., one computing device 1610) to thousands, job scheduling and orchestration to ensure hassle-free execution of every developer's job, AI workflow management and machine learning operations (MLOps) to move more models from prototype to production, and enterprise software to speed developer success.

The computing system 1602 (e.g., NVIDIA's OVX servers) may provide a development and simulation platform for testing and optimizing physical AI with APIs and frameworks for simulation (e.g., NVIDIA's DriveSIM, ISAAC Sim, ISAAC Gym, ISAAC Labetc.). The computing system 1602 allows developers to use simulation frameworks to simulate and validate robot models, and/or to generate massive amounts of physically-based synthetic data to bootstrap model training. The computing system 1602 may support learning frameworks that power robot reinforcement learning and imitation learning, to accelerate robot policy training and refinement. For example, the computing system 1602 may be used to generate any number of simulations 1608—such as within NVIDIA's OMNIVERSE. The computing system 1602 may be used optimized for accelerating an entire software stack, from training, fine-tuning, and deploying generative AI to powering industrial digitalization within a content collaboration platform of APIs, software developer kits (SDKs), and services that allow for integration of OpenUSD, ray-tracing rendering technologies (e.g., NVIDIA's RTX), and generative physical AI into existing software tools and simulation workflows for, e.g., industrial and robotics use cases (e.g., NVIDIA's OMNIVERSE). As such, the computing system 1602 may host or support a native OpenUSD software platform enabling enterprises to connect 3D pipelines and develop advanced, real-time 3D applications for industrial digitalization. With powerful ray-tracing-accelerated AI and graphics capabilities, the computing system 1602 delivers powerful performance for workloads like extended reality (XR), multi-user design collaboration, and digital twins. This allows creation of physically accurate models with high-fidelity ray-traced and path-traced rendering of materials, operation of large-scale, AI-enabled simulations, and generation of photorealistic 3D synthetic data for training. The computing system 1602 may include individual computing devices 1614 (e.g., NVIDIA's OVX L40S Server) and/or any number of computing devices 1614 in a data center infrastructure 1616 (e.g., NVIDIA's OVX Systems).

The computing device(s) 1614 (which may include a server) may include CPUs (e.g., 2 CPUs with 32 cores each), and GPUs (e.g., 4 or 8 GPUs, each including 48 GB GDDR6 with ECC memory, 864 GB/s memory bandwidth, PCIe Gen4×16: 64 GB/s bidirectional interconnect interface, 18,176 CUDA cores, 142 ray tracing (RT) cores, and 568 tensor cores). The computing devices 1614 may include various networking and network management components, such as smart host channel adapters (HCA) (e.g., 2 or 4 single port ConnextX-7 at 200 Gb/s each, providing up to 800 Gb/s Infiniband/Ethernet), one or more DPUs (e.g., a dual-port QSFP112 DPUs—such as an NVIDIA BlueField-3 DPU), providing up to 400 Gb/s InfiniBand/Ethernet. In some embodiments, the NICs used for the computing device(s) 1614 may include SuperNICs (e.g., NVIDIA's ConnectX-8 SuperNIC) to provide up to 800 Gb/s of data throughput for in-network computing acceleration engines to deliver the performance and robust feature set needed to power trillion-parameter scale AI factories and scientific computing workloads. In other embodiments, the computing device(s) 1614 may include a smart host channel adapter (HCA) (e.g., NVIDIA's ConnectX-7) to provide ultra-low latency, 400 Gb/s throughput for in-network computing acceleration engines. The computing device(s) 1614 may include a host memory (e.g., 384 Gb DDR5 ECC for 4 GPUs, or 768 Gb DDR5 ECC for 8 GPUs), and may include a dual in-line memory module (DIMM) slot(s), a host boot drive (e.g., 1 TB NVMe), and/or a host storage (e.g., 2 4 TB NVMe).

Similar to the data center infrastructure 1612, the data center infrastructure 1616 may allow for any number of computing device(s) 1614 to be combined in cluster configuration according to a reference architecture.

The computing system 1606 may be used to deploy trained AI models on a runtime computer—such as the SoC(s) 1504 described herein. For example, these computing systems 1606 may be designed for compact, on-board computing needs, including an ensemble of models for control policy, vision and language models, etc., deployed on a power-efficient on-board edge computing system 1606. Details of components, features, and capabilities of the computing system 1606 may be described in more detail herein with respect to FIGS. 15A-15E.

### Example Generative Models

In at least some embodiments, language models, such as large language models (LLMs), vision language models (VLMs), multi-modal language models (MMLMs), vision-language-action (VLA) models, and/or other types of generative artificial intelligence (AI) may be implemented. These models may be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models may be considered “large,” in embodiments, based on the models being trained on massive datasets and having architectures with large number of learnable network parameters (weights and biases)—such as millions or billions of parameters. The LLMs/VLMs/MMLMs/etc. may be implemented for summarizing textual data, analyzing and extracting insights from data (e.g., textual, image, video, etc.), and generating new text/image/video/etc. in user specified styles, tones, and/or formats. The LLMs/VLMs/MMLMs/etc. of the present disclosure may be used exclusively for text processing, in embodiments, whereas in other embodiments, multi-modal LLMs may be implemented to accept, understand, and/or generate text and/or other types of content like images, audio (sounds, synthetic speech, etc.), 2D and/or 3D data (e.g., in USD formats), and/or video. For example, vision language models (VLMs), or more generally multi-modal language models (MMLMs), may be implemented to accept image, video, sensor, audio, textual, 3D design (e.g., CAD), and/or other inputs data types and/or to generate or output image, video, audio, textual, 3D design, and/or other output data types.

Various types of LLMs/VLMs/MMLMs/etc. architectures may be implemented in various embodiments. For example, different architectures may be implemented that use different techniques for understanding and generating outputs—such as text, audio, video, image, 2D and/or 3D design or asset data, etc. In some embodiments, LLMs/VLMs/MMLMs/etc. architectures such as recurrent neural networks (RNNs) or long short-term memory networks (LSTMs) may be used, while in other embodiments transformer architectures—such as those that rely on self-attention and/or cross-attention (e.g., between contextual data and textual data) mechanisms—may be used to understand and recognize relationships between words or tokens and/or contextual data (e.g., other text, video, image, design data, USD, etc.). One or more generative processing pipelines that include LLMs/VLMs/MMLMs/etc. may also include one or more diffusion block(s) (e.g., denoisers). The LLMs/VLMs/MMLMs/etc. of the present disclosure may include encoder and/or decoder block(s). For example, discriminative or encoder-only models like BERT (Bidirectional Encoder Representations from Transformers) may be implemented for tasks that involve language comprehension such as classification, sentiment analysis, question answering, and named entity recognition. As another example, generative or decoder-only models like GPT (Generative Pretrained Transformer) may be implemented for tasks that involve language and content generation such as text completion, story generation, and dialogue generation. LLMs/VLMs/MMLMs/etc. that include both encoder and decoder components like T5 (Text-to-Text Transformer) may be implemented to understand and generate content, such as for translation and summarization. These examples are not intended to be limiting, and any architecture type—including but not limited to those described herein—may be implemented depending on the particular embodiment and the task(s) being performed using the LLMs/VLMs/MMLMs/etc.

In various embodiments, the LLMs/VLMs/MMLMs/etc. may be trained using unsupervised learning, in which an LLMs/VLMs/MMLMs/etc. learns patterns from large amounts of unlabeled text/audio/video/image/design/USD/etc. data. Due to the extensive training, in embodiments, the models may not require task-specific or domain-specific training. LLMs/VLMs/MMLMs/etc. that have undergone extensive pre-training on vast amounts of unlabeled data may be referred to as foundation models and may be adept at a variety of tasks like question-answering, summarization, filling in missing information, translation, image/video/design/USD/data generation. Some LLMs/VLMs/MMLMs/etc. may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/VLMs/MMLMs/etc. of the present disclosure may be implemented using various model alignment techniques. For example, in some embodiments, guardrails may be implemented to identify improper or undesired inputs (e.g., prompts) and/or outputs of the models. In doing so, the system may use the guardrails and/or other model alignment techniques to either prevent a particular undesired input from being processed using the LLMs/VLMs/MMLMs/etc., and/or preventing the output or presentation (e.g., display, audio output, etc.) of information generating using the LLMs/VLMs/MMLMs/etc. In some embodiments, one or more additional models—or layers thereof—may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/implementation. As a result, the LLMs/VLMs/MMLMs/etc. of the present disclosure may be less likely to output language/text/audio/video/design data/USD data/etc. that may be offensive, vulgar, improper, unsafe, out of domain, and/or otherwise undesired for the particular application/implementation.

In some embodiments, the LLMs/VLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3^{rd} party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s), and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources—such as APIs, plug-ins, and/or the like.

In some embodiments, multiple language models (e.g., LLMs/VLMs/MMLMs/etc., multiple instances of the same language model, and/or multiple prompts provided to the same language model or instance of the same language model may be implemented, executed, or accessed (e.g., using one or more plug-ins, user interfaces, APIs, databases, data stores, repositories, etc.) to provide output responsive to the same query, or responsive to separate portions of a query. In at least one embodiment, multiple language models e.g., language models with different architectures, language models trained on different (e.g. updated) corpuses of data may be provided with the same input query and prompt (e.g., set of constraints, conditioners, etc.). In one or more embodiments, the language models may be different versions of the same foundation model. In one or more embodiments, at least one language model may be instantiated as multiple agents—e.g., more than one prompt may be provided to constrain, direct, or otherwise influence a style, a content, or a character, etc., of the output provided. In one or more example, non-limiting embodiments, the same language model may be asked to provide output corresponding to a different role, perspective, character, or having a different base of knowledge, etc.—as defined by a supplied prompt.

In any one of such embodiments, the output of two or more (e.g., each) language models, two or more versions of at least one language model, two or more instanced agents of at least one language model, and/or two more prompts provided to at least one language model may be further processed, e.g., aggregated, compared or filtered against, or used to determine (and provide) a consensus response. In one or more embodiments, the output from one language model—or version, instance, or agent—maybe be provided as input to another language model for further processing and/or validation. In one or more embodiments, a language model may be asked to generate or otherwise obtain an output with respect to an input source material, with the output being associated with the input source material. Such an association may include, for example, the generation of a caption or portion of text that is embedded (e.g., as metadata) with an input source text or image. In one or more embodiments, an output of a language model may be used to determine the validity of an input source material for further processing, or inclusion in a dataset. For example, a language model may be used to assess the presence (or absence) of a target word in a portion of text or an object in an image, with the text or image being annotated to note such presence (or lack thereof). Alternatively, the determination from the language model may be used to determine whether the source material should be included in a curated dataset, for example and without limitation.

FIG. 17 is a block diagram of an example generative language model system 1700 suitable for use in implementing at least some embodiments of the present disclosure. In the example illustrated in FIG. 17, the generative language model system 1700 includes a retrieval augmented generation (RAG) component 1792, an input processor 1705, a tokenizer 1710, an embedding component 1720, plug-ins/APIs 1795, and a generative language model (LM) 1730 (which may include an LLM, a VLM, a MMLM, a VLA model, etc.).

At a high level, the input processor 1705 may receive an input 1701 comprising text and/or other types of input data (e.g., audio data, video data, image data, sensor data (e.g., LiDAR, RADAR, ultrasonic, etc.), 3D design data, CAD data, universal scene descriptor (USD) data—such as OpenUSD, etc.), depending on the architecture of the generative LM 1730 (e.g., LLM/VLM/MMLM/etc.). In some embodiments, the input 1701 includes plain text in the form of one or more sentences, paragraphs, and/or documents. Additionally or alternatively, the input 1701 may include numerical sequences, precomputed embeddings (e.g., word or sentence embeddings), and/or structured data (e.g., in tabular formats, JSON, or XML). In some implementations in which the generative LM 1730 is capable of processing multi-modal inputs, the input 1701 may combine text (or may omit text) with image data, audio data, video data, design data, USD data, and/or other types of input data, such as but not limited to those described herein. Taking raw input text as an example, the input processor 1705 may prepare raw input text in various ways. For example, the input processor 1705 may perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 1705 may remove stopwords to reduce noise and focus the generative LM 1730 on more meaningful content. The input processor 1705 may apply text normalization (TN), for example, by converting all characters to lowercase, removing accents, and/or or handling special cases like contractions or abbreviations to ensure consistency (e.g., converting ¼ to one quarter). Similarly, the input processor 1705 and/or a post-processor may perform inverse text normalization (ITN) in order to convert plain language back to canonical or other forms (e.g., to convert one quarter to ¼). These are just a few examples, and other types of input and/or output processing may be applied.

In some embodiments, a RAG component 1792 (which may include one or more RAG models, and/or may be performed using the generative LM 1730 itself) may be used to retrieve additional information to be used as part of the input 1701 or prompt. RAG may be used to enhance the input to the LLM/VLM/MMLM/etc. with external knowledge, so that answers to specific questions or queries or requests are more relevant—such as in a case where specific knowledge is required. The RAG component 1792 may fetch this additional information (e.g., grounding information, such as grounding text/image/video/audio/USD/CAD/etc.) from one or more external sources, which can then be fed to the LLM/VLM/MMLM/etc. along with the prompt to improve accuracy of the responses or outputs of the model.

For example, in some embodiments, the input 1701 may be generated using the query or input to the model (e.g., a question, a request, etc.) in addition to data retrieved using the RAG component 1792. In some embodiments, the input processor 1705 may analyze the input 1701 and communicate with the RAG component 1792 (or the RAG component 1792 may be part of the input processor 1705, in embodiments) in order to identify relevant text and/or other data to provide to the generative LM 1730 as additional context or sources of information from which to identify the response, answer, or output 1790, generally. For example, where the input indicates that the user is interested in a desired tire pressure for a particular make and model of vehicle, the RAG component 1792 may retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 1792 may retrieve a prior stored conversation history—or at least a summary thereof—and include the prior conversation history along with the current ask/request as part of the input 1701 to the generative LM 1730.

The RAG component 1792 may use various RAG techniques. For example, naïve RAG may be used where documents are indexed, chunked, and applied to an embedding model to generate embeddings corresponding to the chunks. A user query may also be applied to the embedding model and/or another embedding model of the RAG component 1792 and the embeddings of the chunks along with the embeddings of the query may be compared to identify the most similar/related embeddings to the query, which may be supplied to the generative LM 1730 to generate an output.

In some embodiments, more advanced RAG techniques may be used. For example, prior to passing chunks to the embedding model, the chunks may undergo pre-retrieval processes (e.g., routing, rewriting, metadata analysis, expansion, etc.). In addition, prior to generating the final embeddings, post-retrieval processes (e.g., re-ranking, prompt compression, etc.) may be performed on the outputs of the embedding model prior to final embeddings being used as comparison to an input query.

As a further example, modular RAG techniques may be used, such as those that are similar to naïve and/or advanced RAG, but also include features such as hybrid search, recursive retrieval and query engines, StepBack approaches, sub-queries, and hypothetical document embedding.

As another example, Graph RAG may use knowledge graphs as a source of context or factual information. Graph RAG may be implemented using a graph database as a source of contextual information sent to the LLM/VLM/MMLM/etc. Rather than (or in addition to) providing the model with chunks of data extracted from larger sized documents—which may result in a lack of context, factual correctness, language accuracy, etc.—graph RAG may also provide structured entity information to the LLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/VLM/MMLM/etc. to answer using them. The knowledge graph, in such embodiments, may contain relevant textual content and metadata about the knowledge graph as well as be integrated with a vector database. In some embodiments, the graph RAG may use a graph as a subject matter expert, where descriptions of concepts and entities relevant to a query/prompt may be extracted and passed to the model as semantic context. These descriptions may include relationships between the concepts. In other examples, the graph may be used as a database, where part of a query/prompt may be mapped to a graph query, the graph query may be executed, and the LLM/VLM/MMLM/etc. may summarize the results. In such an example, the graph may store relevant factual information, and a query (natural language query) to graph query tool (NL-to-Graph-query tool) and entity linking may be used. In some embodiments, graph RAG (e.g., using a graph database) may be combined with standard (e.g., vector database) RAG, and/or other RAG types, to benefit from multiple approaches.

In any embodiments, the RAG component 1792 may implement a plugin, API, user interface, and/or other functionality to perform RAG. For example, a graph RAG plug-in may be used by the LLM/VLM/MMLM/etc. to run queries against the knowledge graph to extract relevant information for feeding to the model, and a standard or vector RAG plug-in may be used to run queries against a vector database. For example, the graph database may interact with a plug-in's REST interface such that the graph database is decoupled from the vector database and/or the embeddings models.

The tokenizer 1710 may segment the (e.g., processed) text data into smaller units (tokens) for subsequent analysis and processing. The tokens may represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 1730 to understand morphological variations and handle out-of-vocabulary words more effectively. Character-based tokenization represents each character as a separate token, enabling the generative LM 1730 to process text at a fine-grained level. The choice of tokenization strategy may depend on factors such as the language being processed, the task at hand, and/or characteristics of the training dataset. As such, the tokenizer 1710 may convert the (e.g., processed) text into a structured format according to tokenization schema being implemented in the particular embodiment.

The embedding component 1720 may use any known embedding technique to transform discrete tokens into (e.g., dense, continuous vector) representations of semantic meaning. For example, the embedding component 1720 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 1701 includes image data/video data/etc., the input processor 1701 may resize the data to a standard size compatible with format of a corresponding input channel and/or may normalize pixel values to a common range (e.g., 0 to 1) to ensure a consistent representation, and the embedding component 1720 may encode the image data using any known technique (e.g., using one or more convolutional neural networks (CNNs) to extract visual features). In some implementations in which the input 1701 includes audio data, the input processor 1701 may resample an audio file to a consistent sampling rate for uniform processing, and the embedding component 1720 may use any known technique to extract and encode audio features—such as in the form of a spectrogram (e.g., a mel-spectrogram). In some implementations in which the input 1701 includes video data, the input processor 1701 may extract frames or apply resizing to extracted frames, and the embedding component 1720 may extract features such as optical flow embeddings or video embeddings and/or may encode temporal information or sequences of frames. In some implementations in which the input 1701 includes multi-modal data, the embedding component 1720 may fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 1730 and/or other components of the generative LM system 1700 may use different types of neural network architectures depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, linear-time sequence modeling with selective state space modeling (SSM) architectures (e.g., Mamba LLM architectures), and/or others. As such, depending on the implementation and architecture, the embedding component 1720 may apply an encoded representation of the input 1701 to the generative LM 1730, and the generative LM 1730 may process the encoded representation of the input 1701 to generate an output 1790, which may include responsive text and/or other types of data.

As described herein, in some embodiments, the generative LM 1730 may be configured to access or use—or capable of accessing or using—plug-ins/APIs 1795 (which may include one or more plug-ins, application programming interfaces (APIs), databases, data stores, repositories, etc.). For example, for certain tasks or operations that the generative LM 1730 is not ideally suited for, the model may have instructions (e.g., as a result of training, and/or based on instructions in a given prompt, such as those retrieved using the RAG component 1792) to access one or more plug-ins/APIs 1795 (e.g., 3^{rd} party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 1795 to the plug-in/API 1795, the plug-in/API 1795 may process the information and return an answer to the generative LM 1730, and the generative LM 1730 may use the response to generate the output 1790. This process may be repeated—e.g., recursively—for any number of iterations and using any number of plug-ins/APIs 1795 until an output 1790 that addresses each ask/question/request/process/operation/etc. from the input 1701 can be generated. As such, the model(s) may not only rely on its own knowledge from training on a large dataset(s) and/or from data retrieved using the RAG component 1792, but also on the expertise or optimized nature of one or more external resources—such as the plug-ins/APIs 1795.

In some embodiments, one or more transformer engines (TEs) may be implemented. The transformer engine may use micro-tensor scaling to optimize performance and accuracy—such as to enable 16-bit floating point (FP16), 8-bit floating point (FP8), and/or 4-bit floating point (FP4) artificial intelligence processing. For example, the transformer engine may use 16-bit or 8-bit floating point precision and an 8-bit or 4-bit floating point data format combined with software algorithms for increasing AI performance and capabilities. By reducing math operations to 8-bits or 4-bits, the TE allows for training larger networks faster without compromising accuracy. For example, the TEs may include a library for accelerating transformer models on processing devices—such as GPUs—to provide better performance with lower memory utilization in both training and inference. When the TE is combined with other technologies, such as high-speed interconnects between nodes (e.g., using switches—such as NVLink Switches) and tensor cores (which enable mixed-precision computing, such as micro-scaling precision support), server clusters may be more capable of training enormous networks (e.g., billions of parameters) at high speeds. As such, tensor core precisions of FP64, TF32, BF16, FP16, FP8, INT8, FP6, and FP4 may be supported, as well as CUDA core precisions of FP64, FP32, FP16, and BF16.

These and other architectures for LLMs/VLMs/MMLMs/VLAs/etc. described herein are meant simply as examples, and other suitable architectures may be implemented within the scope of the present disclosure.

### Example Computing Device

FIG. 18 is a block diagram of an example computing device(s) 1800 suitable for use in implementing some embodiments of the present disclosure. Computing device 1800 may include an interconnect system 1802 that directly or indirectly couples the following devices: memory 1804, one or more central processing units (CPUs) 1806, one or more graphics processing units (GPUs) 1808, a communication interface 1810, input/output (I/O) ports 1812, input/output components 1814, a power supply 1816, one or more presentation components 1818 (e.g., display(s), speaker(s), etc.), and one or more logic units 1820. In at least one embodiment, the computing device(s) 1800 may comprise one or more virtual machines (VMs), and/or any of the components thereof may comprise virtual components (e.g., virtual hardware components). For non-limiting examples, one or more of the GPUs 1808 may comprise one or more vGPUs, one or more of the CPUs 1806 may comprise one or more vCPUs, and/or one or more of the logic units 1820 may comprise one or more virtual logic units. As such, a computing device(s) 1800 may include discrete components (e.g., a full GPU dedicated to the computing device 1800), virtual components (e.g., a portion of a GPU dedicated to the computing device 1800), or a combination thereof.

Although the various blocks of FIG. 18 are shown as connected via the interconnect system 1802 with lines, this is not intended to be limiting and is for clarity only. For example, in some embodiments, a presentation component 1818, such as a display device, may be considered an I/O component 1814 (e.g., if the display is a touch screen). As another example, the CPUs 1806 and/or GPUs 1808 may include memory (e.g., the memory 1804 may be representative of a storage device in addition to the memory of the GPUs 1808, the CPUs 1806, and/or other components). As such, the computing device of FIG. 18 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 18.

The interconnect system 1802 may represent one or more links or busses, such as an address bus, a data bus, a control bus, or a combination thereof. The interconnect system 1802 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1806 may be directly connected to the memory 1804. Further, the CPU 1806 may be directly connected to the GPU 1808. Where there is direct, or point-to-point connection between components, the interconnect system 1802 may include a PCIe link to carry out the connection. In these examples, a PCI bus need not be included in the computing device 1800.

The memory 1804 may include any of a variety of computer-readable media. The computer-readable media may be any available media that may be accessed by the computing device 1800. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1804 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1800. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1806 may be configured to execute at least some of the computer-readable instructions to control one or more components of the computing device 1800 to perform one or more of the methods and/or processes described herein. The CPU(s) 1806 may each include one or more cores (e.g., one, two, four, eight, twenty-eight, seventy-two, etc.) that are capable of handling a multitude of software threads simultaneously. The CPU(s) 1806 may include any type of processor, and may include different types of processors depending on the type of computing device 1800 implemented (e.g., processors with fewer cores for mobile devices and processors with more cores for servers). For example, depending on the type of computing device 1800, the processor may be an Advanced RISC Machines (ARM) processor implemented using Reduced Instruction Set Computing (RISC) or an x86 processor implemented using Complex Instruction Set Computing (CISC). The computing device 1800 may include one or more CPUs 1806 in addition to one or more microprocessors or supplementary co-processors, such as math co-processors.

In addition to or alternatively from the CPU(s) 1806, the GPU(s) 1808 may be configured to execute at least some of the computer-readable instructions to control one or more components of the computing device 1800 to perform one or more of the methods and/or processes described herein. One or more of the GPU(s) 1808 may be an integrated GPU (e.g., with one or more of the CPU(s) 1806 and/or one or more of the GPU(s) 1808 may be a discrete GPU. In embodiments, one or more of the GPU(s) 1808 may be a coprocessor of one or more of the CPU(s) 1806. The GPU(s) 1808 may be used by the computing device 1800 to render graphics (e.g., 3D graphics) or perform general purpose computations. For example, the GPU(s) 1808 may be used for General-Purpose computing on GPUs (GPGPU). The GPU(s) 1808 may include hundreds or thousands of cores that are capable of handling hundreds or thousands of software threads simultaneously. The GPU(s) 1808 may generate pixel data for output images in response to rendering commands (e.g., rendering commands from the CPU(s) 1806 received via a host interface). The GPU(s) 1808 may include graphics memory, such as display memory, for storing pixel data or any other suitable data, such as GPGPU data. The display memory may be included as part of the memory 1804. The GPU(s) 1808 may include two or more GPUs operating in parallel (e.g., via a link). The link may directly connect the GPUs (e.g., using NVLINK) or may connect the GPUs through a switch (e.g., using NVSwitch). When combined together, each GPU 1808 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1806 and/or the GPU(s) 1808, the logic unit(s) 1820 may be configured to execute at least some of the computer-readable instructions to control one or more components of the computing device 1800 to perform one or more of the methods and/or processes described herein. In embodiments, the CPU(s) 1806, the GPU(s) 1808, and/or the logic unit(s) 1820 may discretely or jointly perform any combination of the methods, processes and/or portions thereof. One or more of the logic units 1820 may be part of and/or integrated in one or more of the CPU(s) 1806 and/or the GPU(s) 1808 and/or one or more of the logic units 1820 may be discrete components or otherwise external to the CPU(s) 1806 and/or the GPU(s) 1808. In embodiments, one or more of the logic units 1820 may be a coprocessor of one or more of the CPU(s) 1806 and/or one or more of the GPU(s) 1808.

Examples of the logic unit(s) 1820 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Deep Learning Accelerator Clusters (XNNs), Neural Processing Units (NPUs), Neural Network Accelerators (NNAs), Programmable Vision Accelerators (PVAs)—which may include one or more direct memory access (DMA) systems, one or more vision or vector processing units (VPUs), one or more pixel processing engines (PPEs)—e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1810 may include one or more receivers, transmitters, and/or transceivers that allow the computing device 1800 to communicate with other computing devices via an electronic communication network, included wired and/or wireless communications. The communication interface 1810 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1820 and/or communication interface 1810 may include one or more data processing units (DPUs) to transmit data received over a network and/or through interconnect system 1802 directly to (e.g., a memory of) one or more GPU(s) 1808.

The I/O ports 1812 may allow the computing device 1800 to be logically coupled to other devices including the I/O components 1814, the presentation component(s) 1818, and/or other components, some of which may be built in to (e.g., integrated in) the computing device 1800. Illustrative I/O components 1814 include a microphone, mouse, keyboard, joystick, game pad, game controller, satellite dish, scanner, printer, wireless device, etc. The I/O components 1814 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1800. The computing device 1800 may be include depth cameras, such as stereoscopic camera systems, infrared camera systems, RGB camera systems, touchscreen technology, and combinations of these, for gesture detection and recognition. Additionally, the computing device 1800 may include accelerometers or gyroscopes (e.g., as part of an inertia measurement unit (IMU)) that allow detection of motion. In some examples, the output of the accelerometers or gyroscopes may be used by the computing device 1800 to render immersive augmented reality or virtual reality.

The power supply 1816 may include a hard-wired power supply, a battery power supply, or a combination thereof. The power supply 1816 may provide power to the computing device 1800 to allow the components of the computing device 1800 to operate.

The presentation component(s) 1818 may include a display (e.g., a monitor, a touch screen, a television screen, a heads-up-display (HUD), other display types, or a combination thereof), speakers, and/or other presentation components. The presentation component(s) 1818 may receive data from other components (e.g., the GPU(s) 1808, the CPU(s) 1806, DPUs, etc.), and output the data (e.g., as an image, video, sound, etc.).

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1800 of FIG. 18—e.g., each device may include similar components, features, and/or functionality of the computing device(s) 1800. In addition, where backend devices (e.g., servers, NAS, etc.) are implemented, the backend devices may be included as part of a data center (such as, but not limited to, those described herein).

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1800 described herein with respect to FIG. 18. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a talking kiosk, a remote control, an appliance, a consumer electronic device, a workstation, an edge device, any combination of these delineated devices, or any other suitable device.

### EXAMPLE CLAUSES

A: One or more processors comprising processing circuitry to: cause a machine to perform one or more operations based at least on output data indicating an occupancy associated with an environment at least partially surrounding the machine, wherein the output data is generated using one or more neural networks and based at least on one or more first BEV features associated with image data obtained using one or more image sensors of the machine fused with one or more second BEV features associated with RADAR data obtained using one or more RADAR sensors of the machine.

B: The one or more processors of paragraph A, wherein the one or more processors are comprised in at least one of: a control system for an autonomous or semi-autonomous machine; a perception system for an autonomous or semi-autonomous machine; a system for performing one or more simulation operations; a system for performing one or more digital twin operations; a system for performing one or more light transport simulation; a system for performing collaborative content creation for 3D assets; a system for performing one or more wireless cellular transmissions using a wireless cellular network; a system that provides one or more cloud gaming applications; a system for performing one or more deep learning operations; a system implemented using an edge device; a system implemented using a robot; a system for performing one or more generative AI operations; a system for performing one or more conversational AI operations; a system for performing operations using one or more large language models (LLMs); a system for performing operations using one or more vision language models (VLMs); a system for performing operations using one or more multi-modal language models (MMLMs); a system for performing operations using one or more vision-language-action (VLA) models; a system for performing one or more conversational AI operations; a system for performing one or more synthetic data generation operations; a system for presenting at least one of virtual reality content, augmented reality content, or mixed reality content; systems using or deploying one or more inference microservices; systems that incorporate deploy one or more machine learning models in a service or microservice along with an OS-level virtualization package (e.g., a container); a system incorporating one or more virtual machines (VMs); a system implemented at least partially in a data center; or a system implemented at least partially using cloud computing resources.

C: A method comprising: generating, using one or more first encoders and based at least on image data obtained using one or more image sensors of a machine, one or more first Bird's Eye View (BEV) features associated with the image data; generating, using one or more second encoders and based at least on RADAR data obtained using one or more RADAR sensors of the machine, one or more second BEV features associated with the RADAR data; generating, using one or more neural networks and based at least on fusing the one or more first BEV features with the one or more second BEV features, output data indicating whether one or more voxels associated with an environment are occupied; and causing, based at least on the output data, the machine to perform one or more planning, control, or navigation operations.

D: The method of paragraph C, wherein the generating the output data comprises: generating, using one or more first layers of the one or more neural networks, one or more fused BEV features based at least on fusing the one or more first BEV features with the one or more second BEV features; and generating, using one or more second layers of the one or more neural networks and based at least on the one or more fused BEV features, the output data indicating whether the one or more voxels are occupied.

E: The method of paragraph D, wherein the one or more fused BEV features are associated with a first resolution and the output data is associated with a second resolution that is greater than the first resolution.

F: The method of any one of paragraphs C-E, wherein the generating the output data comprises: generating, using the one or more neural networks, a fused BEV feature based at least on fusing the one or more first BEV features with the one or more second BEV features; generating, using the one or more neural networks and based at least on the fused BEV feature, one or more features maps associated with one or more scales; and generating, using the one or more neural networks and based at least on the one or more feature maps, the output data indicating whether the one or more voxels are occupied.

G: The method of any one of paragraphs C-F, further comprising: generating one or more updated BEV features by aligning the one or more second BEV features with at least one of a resolution or a channel dimension of the one or more first BEV features, wherein the generating the output data uses the one or more neural networks and is based at least on fusing the one or more first features with the one or more updated features.

H: The method of any one of paragraphs C-G, wherein the generating the one or more first BEV features comprises: generating, using one or more image encoders of the one or more first encoders and based at least on the image data, one or more image features associated with one or more images represented by the image data; and generating, using one or more BEV encoders of the one or more first encoders and based at least on the one or more image features, the one or more first BEV features associated with the environment.

I: The method of any one of paragraphs C-H, wherein the output data further represents one or more object classifications associated with the one or more voxels.

J: The method of any one of paragraphs C-I, wherein the output data indicates at least one of: a first value associated with a first portion of the one or more voxels, the first value indicating occupied; and a second value associated with a second portion of the one or more voxels, the second value indicating unoccupied.

K: A system comprising: one or more processors to: generate one or more first features associated with image data obtained using one or more image sensors of a machine and one or more second features associated with RADAR data obtained using one or more RADAR sensors of the machine; generate, using one or more neural networks and based at least on the one or more first features and the one or more second features, output data indicating occupancy information associated with an environment at least partially surrounding the machine; and cause, based at least on the output data, the machine to perform one or more operations.

L: The system of paragraph K, wherein the generation of the output data comprises: generating one or more fused features based at least on fusing the one or more first features with the one or more second features; and generating, using the one or more neural networks and based at least on the one or more fused features, the output data indicating the occupancy information associated with the environment at least partially surrounding the machine.

M: The system of paragraph L, wherein the one or more fused features are associated with a first resolution and the output data is associated with a second resolution that is greater than the first resolution.

N: The system of any one of paragraphs K-M, wherein: the one or more first features are represented using one or more first Bird's Eye View (BEV) feature maps associated with the image data; the one or more second features are represented using one or more second BEV feature maps associated with the RADAR data; and the generation of the output data comprises: generating one or more fused BEV feature maps based at least on fusing the one or more first feature BEV maps with the one or more second feature BEV maps, the one or more fused BEV feature maps being associated with one or more scales; and generating, using the one or more neural networks and based at least on the one or more fused BEV feature maps, the output data indicating the occupancy information associated with the environment at least partially surrounding the machine.

O: The system of any one of paragraphs K-N, wherein: the one or more first features are generated using one or more first encoders of the one or more neural networks; and the one or more second features are generated using one or more second encoders of the one or more neural networks.

P: The system of paragraph O, wherein the generation of the one or more first features comprises: generating, using one or more image encoders of the one or more first encoders and based at least on the image data, one or more image features associated with one or more images represented by the image data; and generating, using one or more BEV encoders of the one or more first encoders and based at least on the one or more image features, the one or more first features associated with the environment.

Q: The system of any one of paragraphs K-P, wherein the one or more processors are further to: generate one or more updated features by aligning the one or more second features with at least one of a resolution or a channel dimension of the one or more first features, wherein the output data is generated based at least on the one or more first features and the one or more updated features.

R: The system of any one of paragraphs K-Q, wherein the output data indicating the occupancy associated with the environment at least partially surrounding the machine represents: one or more three-dimensional locations of one or more voxels associated with the environment at least partially surrounding the machine; and one or more indications of whether the one or more voxels are at least one of occupied or unoccupied.

S: The system of any one of paragraphs K-R, wherein the output data further indicates one or more classifications associated with one or more objects located within the environment at least partially surrounding the machine.

T: The system of any one of paragraphs K-S, wherein the system is comprised in at least one of: a control system for an autonomous or semi-autonomous machine; a perception system for an autonomous or semi-autonomous machine; a system for performing one or more simulation operations; a system for performing one or more digital twin operations; a system for performing one or more light transport simulation; a system for performing collaborative content creation for 3D assets; a system for performing one or more wireless cellular transmissions using a wireless cellular network; a system that provides one or more cloud gaming applications; a system for performing one or more deep learning operations; a system implemented using an edge device; a system implemented using a robot; a system for performing one or more generative AI operations; a system for performing one or more conversational AI operations; a system for performing operations using one or more large language models (LLMs); a system for performing operations using one or more vision language models (VLMs); a system for performing operations using one or more multi-modal language models (MMLMs); a system for performing operations using one or more vision-language-action (VLA) models; a system for performing one or more conversational AI operations; a system for performing one or more synthetic data generation operations; a system for presenting at least one of virtual reality content, augmented reality content, or mixed reality content; systems using or deploying one or more inference microservices; systems that incorporate deploy one or more machine learning models in a service or microservice along with an OS-level virtualization package (e.g., a container); a system incorporating one or more virtual machines (VMs); a system implemented at least partially in a data center; or a system implemented at least partially using cloud computing resources.

AA: One or more processors comprising processing circuitry to: determine, based at least on sensor data obtained using one or more sensors of a machine, one or more voxels within an environment that are occupied; generate, based at least on the one or more voxels, an occupancy map indicating one or more two-dimensional (2D) areas within the environment that are occupied; determine, based at least on performing ray tracing with regard to the occupancy map, one or more occluded areas of the environment; and cause a machine to perform one or more operations based at least on the one or more occluded areas.

AB: The one or more processors paragraph AA, wherein the determination of the one or more occluded area comprises: determining, based at least on the ray tracing, points along rays that are associated with the one or more 2D areas within the environment that are occupied; generating a polygon by connecting the points; and determining the one or more occluded areas based at least on the polygon.

AC: The one or more processors of either paragraph AA or paragraph AB, wherein the one or more processors are comprised in at least one of: a control system for an autonomous or semi-autonomous machine; a perception system for an autonomous or semi-autonomous machine; a system for performing one or more simulation operations; a system for performing one or more digital twin operations; a system for performing one or more light transport simulation; a system for performing collaborative content creation for 3D assets; a system for performing one or more wireless cellular transmissions using a wireless cellular network; a system that provides one or more cloud gaming applications; a system for performing one or more deep learning operations; a system implemented using an edge device; a system implemented using a robot; a system for performing one or more generative AI operations; a system for performing one or more conversational AI operations; a system for performing operations using one or more large language models (LLMs); a system for performing operations using one or more vision language models (VLMs); a system for performing operations using one or more multi-modal language models (MMLMs); a system for performing operations using one or more vision-language-action (VLA) models; a system for performing one or more conversational AI operations; a system for performing one or more synthetic data generation operations; a system for presenting at least one of virtual reality content, augmented reality content, or mixed reality content; systems using or deploying one or more inference microservices; systems that incorporate deploy one or more machine learning models in a service or microservice along with an OS-level virtualization package (e.g., a container); a system incorporating one or more virtual machines (VMs); a system implemented at least partially in a data center; or a system implemented at least partially using cloud computing resources.

AD: A method comprising: generating, based at least on a three-dimensional (3D) occupancy map associated with an environment, a two-dimensional (2D) occupancy map associated with the environment; determining, based at least on projecting rays with regard to the 2D occupancy map, points within the 2D occupancy map that are associated with occupied locations within the environment; generating a polygon based least on connecting the points within the 2D occupancy map; determining one or more occluded areas of the environment based at least on the polygon; and causing, based at least on the one or more occluded areas, a machine to perform one or more planning, control, or navigation operations.

AE: The method of paragraph AD, further comprising generating, using one or more neural networks and based at least on fusing one or more first features associated with image data with one or more second features associated with RADAR data, the 3D occupancy map associated with the environment.

AF: The method of either paragraph AD or paragraph AE, wherein: the 3D occupancy map indicates whether voxels associated with the environment are occupied; and the generating the 2D occupancy map comprises: determining, based at least on whether the voxels are occupied, whether 2D areas of the environment are occupied; and generating the 2D occupancy map to indicate whether the 2D areas are occupied.

AG: The method of paragraph AF, wherein the determining whether a 2D area of the 2D areas is occupied comprises: identifying a portion of the voxels that are associated with the 2D area; determining whether one or more voxels of the portion of the voxels are occupied; and determining whether the 2D area is occupied based at least on whether the one or more voxels are occupied.

AH: The method of paragraph AF, wherein the determining whether a 2D area of the 2D areas is occupied comprises: identifying a portion of the voxels that are associated with the 2D area and at least a threshold height above a navigation surface; determining whether one or more voxels of the portion of the voxels are occupied; and determining whether the 2D area is occupied based at least on whether the one or more voxels are occupied.

AI: The method of any one of paragraphs AD-AH, wherein the determining the points within the 2D occupancy map that are associated with the occupied locations within the environment comprises: projecting the rays starting at a first location within the 2D occupancy map that is associated with the machine; determining that the rays intersect with second locations within the 2D occupancy map that are indicated as being occluded, the second locations within the 2D occupancy map corresponding to the occupied locations within the environment; and determining the points as being associated with the second locations.

AJ: The method of any one of paragraphs AD-AI, wherein the rays are projected using an angle that is associated with one or more dimensions of the 2D occupancy map.

AK: The method of any one of paragraphs AD-AJ, further comprising: generating an occlusion map, a first region of the occlusion map that is within the polygon being associated an area of the environment that is not occluded and one or more second regions of the occlusion map that are outside of the polygon being associated with the one or more occluded areas of the environment, wherein the causing the machine to perform the one or more planning, control, or navigation operations is based at least on the occlusion map.

AL: A system comprising: one or more processors to: generate a two-dimensional (2D) occupancy map associated with an environment, the 2D occupancy map indicating one or more first areas of the environment that are occupied and one or more second areas of the environment that are unoccupied; determine, based at least on projecting one or more rays with regard to the 2D occupancy map, one or more points within the 2D occupancy map that are associated with the one or more first areas; generate, based at least on the one or more points within the 2D occupancy map, one or more occluded areas of the environment; and cause, based at least on the one or more occluded areas of the environment, a machine to perform one or more operations.

AM: The system of paragraph AL, wherein the one or more processors are further to: generate, using one or more neural networks and based at least on fusing one or more first features associated with image data with one or more second features associated with RADAR data, a three-dimensional (3D) occupancy map associated with the environment, wherein the 2D occupancy map is generated based at least on the 3D occupancy map.

AN: The system of either paragraph AL or paragraph AM, wherein the generation of the 2D occupancy map comprises: obtaining data indicating whether voxels associated with the environment are occupied; determining that a first portion of the voxels associated with the one or more first areas are occupied and a second portion of the voxels associated with the one or more second areas are unoccupied; and generating the 2D occupancy map to indicate the one or more first areas as being occupied and the one or more second areas as being unoccupied.

AO: The system of any one of paragraphs AL-AN, wherein: the one or more points include a plurality of points; and the one or more processors are further to: determine a polygon by connecting the plurality of points; and determine the one or more occluded area of the environment based at least on the polygon.

AP: The system of any one of paragraphs AL-AO, wherein the determination of the one or more points within the 2D occupancy map that are associated with the one or more first areas comprises: projecting the one or more rays starting at a first location within the 2D occupancy map that is associated with the machine; and determining that the one or more rays intersect with one or more second locations within the 2D occupancy map that are associated with the one or more first areas of the environment; and determining the one or more points as being associated with the one or more second locations.

AQ: The system of any one of paragraphs AL-AP, wherein the one or more rays include a plurality of rays, and wherein the plurality of rays are projected using an angle that is associated with one or more dimensions associated with the 2D occupancy map.

AR: The system of any one of paragraphs AL-AQ, wherein the one or more processors are further to: generate an occlusion map, a first region of the occlusion map that is within the one or more points being associated an area of the environment that is not occluded and one or more second regions of the occlusion map that are outside of the one or more points being associated with the one or more occluded areas of the environment, wherein the machine is caused to perform the one or more operations based at least on the occlusion map.

AS: The system of any one of paragraphs AL-AR, wherein the one or more processors are further to: update the 2D occupancy map to indicate one or more third areas that are occluded, the one or more third areas of the 2D occupancy map corresponding to the one or more occluded areas of the environment, wherein the machine is caused to perform the one or more operations based at least on the 2D occupancy map as updated.

AT: The system of any one of paragraphs AL-AS, wherein the system is comprised in at least one of: a control system for an autonomous or semi-autonomous machine; a perception system for an autonomous or semi-autonomous machine; a system for performing one or more simulation operations; a system for performing one or more digital twin operations; a system for performing one or more light transport simulation; a system for performing collaborative content creation for 3D assets; a system for performing one or more wireless cellular transmissions using a wireless cellular network; a system that provides one or more cloud gaming applications; a system for performing one or more deep learning operations; a system implemented using an edge device; a system implemented using a robot; a system for performing one or more generative AI operations; a system for performing one or more conversational AI operations; a system for performing operations using one or more large language models (LLMs); a system for performing operations using one or more vision language models (VLMs); a system for performing operations using one or more multi-modal language models (MMLMs); a system for performing operations using one or more vision-language-action (VLA) models; a system for performing one or more conversational AI operations; a system for performing one or more synthetic data generation operations; a system for presenting at least one of virtual reality content, augmented reality content, or mixed reality content; systems using or deploying one or more inference microservices; systems that incorporate deploy one or more machine learning models in a service or microservice along with an OS-level virtualization package (e.g., a container); a system incorporating one or more virtual machines (VMs); a system implemented at least partially in a data center; or a system implemented at least partially using cloud computing resources.

BA: One or more processors comprising processing circuitry to: cause a machine to perform one or more planning, control, or navigation operations within an environment based at least on determining that one or more first areas of the environment are occluded from one or more sensors of the machine, wherein the one or more first areas are determined to be occluded from the one or more sensors based at least on lengths of rays that are projected from a first point of an occupancy map associated with the environment to second points of the occupancy map that correspond to the one or more first areas of the environment and one or more second areas of the environment, the first point corresponding to a location of the machine within the environment.

BB: The one or more processors of paragraph BA, wherein the one or more first areas are determined to be occluded, at least, by: determining one or more first lengths associated with a first portion of the rays that are associated with the one or more one or more first areas; determining one or more second lengths associated with a second portion of the rays that are associated with the one or more second areas; and determining that the one or more first lengths are equal to or greater than the one or more second lengths.

BC: The one or more processors of either paragraph BA or paragraph BB, wherein the one or more processors are comprised in at least one of: a control system for an autonomous or semi-autonomous machine; a perception system for an autonomous or semi-autonomous machine; a system for performing one or more simulation operations; a system for performing one or more digital twin operations; a system for performing one or more light transport simulation; a system for performing collaborative content creation for 3D assets; a system for performing one or more wireless cellular transmissions using a wireless cellular network; a system that provides one or more cloud gaming applications; a system for performing one or more deep learning operations; a system implemented using an edge device; a system implemented using a robot; a system for performing one or more generative AI operations; a system for performing one or more conversational AI operations; a system for performing operations using one or more large language models (LLMs); a system for performing operations using one or more vision language models (VLMs); a system for performing operations using one or more multi-modal language models (MMLMs); a system for performing operations using one or more vision-language-action (VLA) models; a system for performing one or more conversational AI operations; a system for performing one or more synthetic data generation operations; a system for presenting at least one of virtual reality content, augmented reality content, or mixed reality content; systems using or deploying one or more inference microservices; systems that incorporate deploy one or more machine learning models in a service or microservice along with an OS-level virtualization package (e.g., a container); a system incorporating one or more virtual machines (VMs); a system implemented at least partially in a data center; or a system implemented at least partially using cloud computing resources.

BD: A method comprising: generating, based at least on sensor data obtained using one or more sensors of a machine located within an environment, an occupancy map associated with the environment; determining a first length of a first ray that is projected from a starting point of the occupancy map to a test point of a test area associated with the occupancy map, the starting point of the occupancy map corresponding to a location of the machine within the environment; determining one or more second lengths of one or more second rays that are projected from the starting point of the occupancy map to one or more occupied areas associated with the occupancy map; determining, based at least on the first length of the first ray and the one or more second lengths of the one or more second rays, whether the test area of the occupancy map is occluded; and causing, based at least on whether the test area of the occupancy map is occluded, the machine to perform one or more planning, control, or navigational operations.

BE: The method of paragraph BD, wherein the determining whether the test area is occluded comprises one of: determining that the test area is occluded based at least on the first length of the first ray being equal to or greater than the one or more second lengths of the one or more second rays; or determining that the test area is not occluded based at least on the first length of the first ray being less than the one or more second lengths of the one or more second rays.

BF: The method of either paragraph BD or paragraph BE, wherein the determining whether the test area is occluded comprises one of: determining that the test area is occluded based at least on the first length of the first ray being equal to or greater than a majority of the one or more second lengths of the one or more second rays; or determining that the test area is not occluded based at least on the first length of the first ray being less than the majority of the one or more second lengths of the one or more second rays.

BG: The method of any one of paragraphs BD-BF, further comprising: determining a first angle associated with the first ray; determining one or more second angles associated with the one or more second rays; and determining to use the one or more second rays for the determining whether the test area is occluded based at least on the first angle and the one or more second angles.

BH: The method of paragraph BG, wherein the determining to use the one or more second rays for the determining whether the test area is occluded comprises: determining that the one or more second angles are within a threshold angle to the first angle; and determining to use the one or more second rays for the determining whether the test area is occluded based at least the one or more second angles being within the threshold angle to the first angle.

BI: The method of any one of paragraphs BD-BH, further comprising: determining one or more first heights associated with the first ray; and determining one or more second heights associated with the one or more second rays, wherein the determining whether the test area is occluded is further based at least on the one or more first heights and the one or more second heights.

BJ: The method of any one of paragraphs BD-BI, further comprising: determining at least a trajectory associated with the machine within the environment; and determining the test area associated with the occupancy map based at least on the trajectory associated with the machine.

BK: The method of any one of paragraphs BD-BJ, wherein the generating the occupancy map associated with the environment comprises: generating, based at least on the sensor data, a three-dimensional (3D) occupancy map associated with the environment; and generating, based at least on the 3D occupancy map, a two-dimensional (2D) occupancy map associated with the environment, wherein the occupancy map includes the 2D occupancy map.

BL: The method of paragraph BK, wherein: the 3D occupancy map indicates whether voxels associated with the environment are occupied; and the generating the 2D occupancy map comprises: determining, based at least on whether the voxels are occupied, whether 2D areas of the environment are occupied; and generating the 2D occupancy map to indicate whether the 2D areas are occupied.

BM: A system comprising: one or more processors to: generate, based at least on sensor data obtained using one or more sensors of a machine located within an environment, an occupancy map associated with the environment; determine a first length of a first ray that is projected from a first point of the occupancy map to a second point of the occupancy map; determine one or more second lengths of one or more second rays that are projected from the first point of the occupancy map to one or more third points of the occupancy map; determine, based at least on the first length of the first ray and the one or more second lengths of the one or more second rays, whether the second point of the occupancy map is associated with an occluded area of the environment; and cause, based at least on whether the second point is associated with the occluded area, the machine to perform one or more planning, control, or navigational operations.

BN: The system of paragraph BM, wherein the determination of whether the second point is associated with the occluded area comprises one of: determining that the second point is associated with the occluded area based at least on the first length of the first ray being equal to or greater than the one or more second lengths of the one or more second rays; or determining that the second point is not associated with the occluded area based at least on the first length of the first ray being less than the one or more second lengths of the one or more second rays.

BO: The system of either paragraph BM or paragraph BN, wherein the determination of whether the second point is associated with the occluded area comprises one of: determining that the second point is associated with the occluded area based at least on the first length of the first ray being equal to or greater than a majority of the one or more second lengths of the one or more second rays; or determining that the second point is not associated with the occluded area based at least on the first length of the first ray being less than the majority of the one or more second lengths of the one or more second rays.

BP: The system of any one of paragraphs BM-BO, wherein the one or more processors are further to: determine a first angle associated with the first ray; determine one or more second angles associated with the one or more second rays; and determine to use the one or more second rays for the determination of whether the second point is associated with the occluded area based at least on the first angle and the one or more second angles.

BQ: The system of any one of paragraph BM-BP, wherein the one or more processors are further to: determine one or more first heights associated with the first ray; and determine one or more second heights associated with the one or more second rays, wherein the determination of whether the second point is associated with the occluded area is further based at least on the one or more first heights and the one or more second heights.

BR: The system of any one of paragraphs BM-BQ, wherein the one or more processors are further to: determine at least a trajectory associated with the machine within the environment; and determine the second point of the occupancy map based at least on the trajectory associated with the machine.

BS: The system of any one of paragraphs BM-BR, wherein the generation of the occupancy map associated with the environment comprises: generating, based at least on the sensor data, a three-dimensional (3D) occupancy map associated with the environment; and generating, based at least on the 3D occupancy map, a two-dimensional (2D) occupancy map associated with the environment, wherein the occupancy map includes the 2D occupancy map.

BT: The system of any one of paragraphs BM-BS, wherein the system is comprised in at least one of: a control system for an autonomous or semi-autonomous machine; a perception system for an autonomous or semi-autonomous machine; a system for performing one or more simulation operations; a system for performing one or more digital twin operations; a system for performing one or more light transport simulation; a system for performing collaborative content creation for 3D assets; a system for performing one or more wireless cellular transmissions using a wireless cellular network; a system that provides one or more cloud gaming applications; a system for performing one or more deep learning operations; a system implemented using an edge device; a system implemented using a robot; a system for performing one or more generative AI operations; a system for performing one or more conversational AI operations; a system for performing operations using one or more large language models (LLMs); a system for performing operations using one or more vision language models (VLMs); a system for performing operations using one or more multi-modal language models (MMLMs); a system for performing operations using one or more vision-language-action (VLA) models; a system for performing one or more conversational AI operations; a system for performing one or more synthetic data generation operations; a system for presenting at least one of virtual reality content, augmented reality content, or mixed reality content; systems using or deploying one or more inference microservices; systems that incorporate deploy one or more machine learning models in a service or microservice along with an OS-level virtualization package (e.g., a container); a system incorporating one or more virtual machines (VMs); a system implemented at least partially in a data center; or a system implemented at least partially using cloud computing resources.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A method comprising:
generating, based at least on a three-dimensional (3D) occupancy map associated with an environment, a two-dimensional (2D) occupancy map associated with the environment;
determining, based at least on projecting rays with regard to the 2D occupancy map, points within the 2D occupancy map that are associated with occupied locations within the environment;
generating a polygon based least on connecting the points within the 2D occupancy map;
determining one or more occluded areas of the environment based at least on the polygon; and
causing, based at least on the one or more occluded areas, a machine to perform one or more planning, control, or navigation operations.

2. The method of claim 1, further comprising generating, using one or more neural networks and based at least on fusing one or more first features associated with image data with one or more second features associated with RADAR data, the 3D occupancy map associated with the environment.

3. The method of claim 1, wherein:
the 3D occupancy map indicates whether voxels associated with the environment are occupied; and
the generating the 2D occupancy map comprises:
determining, based at least on whether the voxels are occupied, whether 2D areas of the environment are occupied; and
generating the 2D occupancy map to indicate whether the 2D areas are occupied.

4. The method of claim 3, wherein the determining whether a 2D area of the 2D areas is occupied comprises:
identifying a portion of the voxels that are associated with the 2D area;
determining whether one or more voxels of the portion of the voxels are occupied; and
determining whether the 2D area is occupied based at least on whether the one or more voxels are occupied.

5. The method of claim 3, wherein the determining whether a 2D area of the 2D areas is occupied comprises:
identifying a portion of the voxels that are associated with the 2D area and at least a threshold height above a navigation surface;
determining whether one or more voxels of the portion of the voxels are occupied; and
determining whether the 2D area is occupied based at least on whether the one or more voxels are occupied.

6. The method of claim 1, wherein the determining the points within the 2D occupancy map that are associated with the occupied locations within the environment comprises:
projecting the rays starting at a first location within the 2D occupancy map that is associated with the machine;
determining that the rays intersect with second locations within the 2D occupancy map that are indicated as being occluded, the second locations within the 2D occupancy map corresponding to the occupied locations within the environment; and
determining the points as being associated with the second locations.

7. The method of claim 1, wherein the rays are projected using an angle that is associated with one or more dimensions of the 2D occupancy map.

8. The method of claim 1, further comprising:
generating an occlusion map, a first region of the occlusion map that is within the polygon being associated an area of the environment that is not occluded and one or more second regions of the occlusion map that are outside of the polygon being associated with the one or more occluded areas of the environment,
wherein the causing the machine to perform the one or more planning, control, or navigation operations is based at least on the occlusion map.

9. A system comprising:
one or more processors to:
generate a two-dimensional (2D) occupancy map associated with an environment, the 2D occupancy map indicating one or more first areas of the environment that are occupied and one or more second areas of the environment that are unoccupied;
determine, based at least on projecting one or more rays with regard to the 2D occupancy map, one or more points within the 2D occupancy map that are associated with the one or more first areas;
generate, based at least on the one or more points within the 2D occupancy map, one or more occluded areas of the environment; and
cause, based at least on the one or more occluded areas of the environment, a machine to perform one or more operations.

10. The system of claim 9, wherein the one or more processors are further to:
generate, using one or more neural networks and based at least on fusing one or more first features associated with image data with one or more second features associated with RADAR data, a three-dimensional (3D) occupancy map associated with the environment,
wherein the 2D occupancy map is generated based at least on the 3D occupancy map.

11. The system of claim 9, wherein the generation of the 2D occupancy map comprises:
obtaining data indicating whether voxels associated with the environment are occupied;
determining that a first portion of the voxels associated with the one or more first areas are occupied and a second portion of the voxels associated with the one or more second areas are unoccupied; and
generating the 2D occupancy map to indicate the one or more first areas as being occupied and the one or more second areas as being unoccupied.

12. The system of claim 9, wherein:
the one or more points include a plurality of points; and
the one or more processors are further to:
determine a polygon by connecting the plurality of points; and
determine the one or more occluded area of the environment based at least on the polygon.

13. The system of claim 9, wherein the determination of the one or more points within the 2D occupancy map that are associated with the one or more first areas comprises:
projecting the one or more rays starting at a first location within the 2D occupancy map that is associated with the machine; and
determining that the one or more rays intersect with one or more second locations within the 2D occupancy map that are associated with the one or more first areas of the environment; and
determining the one or more points as being associated with the one or more second locations.

14. The system of claim 9, wherein the one or more rays include a plurality of rays, and wherein the plurality of rays are projected using an angle that is associated with one or more dimensions associated with the 2D occupancy map.

15. The system of claim 9, wherein the one or more processors are further to:
generate an occlusion map, a first region of the occlusion map that is within the one or more points being associated an area of the environment that is not occluded and one or more second regions of the occlusion map that are outside of the one or more points being associated with the one or more occluded areas of the environment,
wherein the machine is caused to perform the one or more operations based at least on the occlusion map.

16. The system of claim 9, wherein the one or more processors are further to:
update the 2D occupancy map to indicate one or more third areas that are occluded, the one or more third areas of the 2D occupancy map corresponding to the one or more occluded areas of the environment,
wherein the machine is caused to perform the one or more operations based at least on the 2D occupancy map as updated.

17. The system of claim 9, wherein the system is comprised in at least one of:
a control system for an autonomous or semi-autonomous machine;
a perception system for an autonomous or semi-autonomous machine;
a system for performing one or more simulation operations;
a system for performing one or more digital twin operations;
a system for performing one or more light transport simulation;
a system for performing collaborative content creation for 3D assets;
a system for performing one or more wireless cellular transmissions using a wireless cellular network;
a system that provides one or more cloud gaming applications;
a system for performing one or more deep learning operations;
a system implemented using an edge device;
a system implemented using a robot;
a system for performing one or more generative AI operations;
a system for performing one or more conversational AI operations;
a system for performing operations using one or more large language models (LLMs);
a system for performing operations using one or more vision language models (VLMs);
a system for performing operations using one or more multi-modal language models (MMLMs);
a system for performing operations using one or more vision-language-action (VLA) models;
a system for performing one or more conversational AI operations;
a system for performing one or more synthetic data generation operations;
a system for presenting at least one of virtual reality content, augmented reality content, or mixed reality content;
systems using or deploying one or more inference microservices;
systems that incorporate deploy one or more machine learning models in a service or microservice along with an OS-level virtualization package (e.g., a container);
a system incorporating one or more virtual machines (VMs);
a system implemented at least partially in a data center; or
a system implemented at least partially using cloud computing resources.

18. One or more processors comprising processing circuitry to:
determine, based at least on sensor data obtained using one or more sensors of a machine, one or more voxels within an environment that are occupied;
generate, based at least on the one or more voxels, an occupancy map indicating one or more two-dimensional (2D) areas within the environment that are occupied;
determine, based at least on performing ray tracing with regard to the occupancy map, one or more occluded areas of the environment; and
cause a machine to perform one or more operations based at least on the one or more occluded areas.

19. The one or more processors of claim 18, wherein the determination of the one or more occluded area comprises:
determining, based at least on the ray tracing, points along rays that are associated with the one or more 2D areas within the environment that are occupied;
generating a polygon by connecting the points; and
determining the one or more occluded areas based at least on the polygon.

20. The one or more processors of claim 18, wherein the one or more processors are comprised in at least one of:
a control system for an autonomous or semi-autonomous machine;
a perception system for an autonomous or semi-autonomous machine;
a system for performing one or more simulation operations;
a system for performing one or more digital twin operations;
a system for performing one or more light transport simulation;
a system for performing collaborative content creation for 3D assets;
a system for performing one or more wireless cellular transmissions using a wireless cellular network;
a system that provides one or more cloud gaming applications;
a system for performing one or more deep learning operations;
a system implemented using an edge device;
a system implemented using a robot;
a system for performing one or more generative AI operations;
a system for performing one or more conversational AI operations;
a system for performing operations using one or more large language models (LLMs);
a system for performing operations using one or more vision language models (VLMs);
a system for performing operations using one or more multi-modal language models (MMLMs);
a system for performing operations using one or more vision-language-action (VLA) models;
a system for performing one or more conversational AI operations;
a system for performing one or more synthetic data generation operations;
a system for presenting at least one of virtual reality content, augmented reality content, or mixed reality content;
systems using or deploying one or more inference microservices;
systems that incorporate deploy one or more machine learning models in a service or microservice along with an OS-level virtualization package (e.g., a container);
a system incorporating one or more virtual machines (VMs);
a system implemented at least partially in a data center; or
a system implemented at least partially using cloud computing resources.
